(19) United States
(12) Patent Application Publication
(10) Pub. No.: US 2023/0278037 A1
(43) Pub. Date: Sep. 7, 2023

(54) DEVICES, SYSTEMS, AND METHODS FOR HIGH THROUGHPUT DROPLET FORMATION

(71) Applicant: 10x Genomics, Inc., Pleasanton, CA (US)

(72) Inventors: Rajiv Bharadwaj, Pleasanton, CA (US); Lynna Chen, Oakland, CA (US); Francis Cui, Oakland, CA (US); Daniel Freitas, Oakland, CA (US); Mohammad Rahimi Lenji, Livermore, CA (US); Martin Sauzade, Pleasanton, CA (US); Augusto Manuel Tentori, Dublin, CA (US); Tobias Daniel Wheeler, Pleasanton, CA (US)

(21) Appl. No.: 18/177,504

(22) Filed: Mar. 2, 2023

Related U.S. Application Data
(63) Continuation of application No. PCT/US21/48906, filed on Sep. 2, 2021.
(60) Provisional application No. 63/073,808, filed on Sep. 2, 2020.

(51) Int. Cl. B01L 3/00

(52) U.S. Cl. CPC B01L 3/502784; B01L 2200/0673; B01L 2200/16; B01L 2300/0851; B01L 2300/0858; B01L 2300/0864; B01L 2300/0867

(57) ABSTRACT

Devices, systems, and their methods of use, for generating and collecting droplets are provided. The invention provides multiplex devices that increase droplet formation in a limited area.

### FIELD OF THE INVENTION

The invention provides devices, systems, and methods for droplet formation. For example, devices, systems, and methods of the invention may be used for forming droplets (e.g., emulsions) containing particles (e.g., droplets containing single particles) or for mixing liquids, e.g., prior to droplet formation.

### BACKGROUND OF THE INVENTION

Many biomedical applications rely on high-throughput assays of samples combined with one or more reagents in droplets. For example, in both research and clinical applications, high-throughput genetic tests using target-specific reagents are able to provide information about samples in drug discovery, biomarker discovery, and clinical diagnostics, among others.

Improved devices, systems, and methods for producing and collecting droplets would be beneficial.

### SUMMARY OF THE INVENTION

In one aspect, the invention provides a microfluidic device including a) a sample inlet; b) one or more collection reservoirs; c) first and second reagent inlets; d) first and second sample channels in fluid communication with the sample inlet; e) a first reagent channel in fluid communication with the first reagent inlet and a second reagent channel in fluid communication with the second reagent inlet; and f) first and second droplet source regions. The first sample channel intersects with the first reagent channel at a first intersection; the second sample channel intersects with the second reagent channel at a second intersection; the first droplet source region is fluidically disposed between the first intersection and the one or more collection reservoirs, and the second droplet source region is fluidically disposed between the second intersection and the one or more collection reservoirs; and the first sample channel and/or the second sample channel is disposed between the first and second reagent inlets.

In certain embodiments, the device further includes g) a third reagent channel in fluid communication with the first reagent inlet; h) a fourth reagent channel in fluid communication with the second reagent inlet; i) third and fourth sample channels in fluid communication with the sample inlet; and j) third and fourth droplet source regions. The third sample channel intersects with the third reagent channel at a third intersection, the fourth sample channel intersects with the fourth reagent channel at a fourth intersection, the third droplet source region is fluidically disposed between the third intersection and the one or more collection reservoirs and the fourth droplet source region is fluidically disposed between the fourth intersection and the one or more collection reservoirs.

In certain embodiments, the third reagent channel may be fluidically connected to the first reagent channel and the fourth reagent channel is fluidically connected to the second reagent channel. In some embodiments, the first reagent channel includes a first reagent funnel fluidically connected to the first reagent inlet and the second reagent channel includes a second reagent funnel fluidically connected to the second reagent inlet.

In particular embodiments, the first reagent channel includes a first reagent funnel fluidically connected to the first reagent inlet and the second reagent channel includes a second reagent funnel fluidically connected to the second reagent inlet, the third reagent channel includes a third reagent funnel fluidically connected to the first reagent inlet, and the fourth reagent channel includes a fourth reagent funnel fluidically connected to the second reagent inlet. In some embodiments, one or more of the first, second, third, and/or fourth sample and/or reagent channels include two or more rectifiers fluidically disposed between the sample inlet and/or the first and/or second reagent inlets and the one or more collection reservoirs. In certain embodiments, the device further includes a reagent reservoir in fluid communication with the first and second reagent inlets. In some embodiments, the first, second, third, and fourth reagent channels each include one of a first, second, third, or fourth rectifier fluidically disposed between the first and second reagent inlets and the one or more collection reservoirs. In some embodiments, the first through fourth rectifiers are each adjacent one of the first through fourth intersections, e.g., fluidically connected to one of the first through fourth intersections.

In some embodiments, the device further includes a) third and fourth reagent inlets; b) a fifth reagent channel in fluid communication with the third reagent inlet and a sixth reagent channel in fluid communication with the fourth reagent inlet; c) fifth and sixth sample channels in fluid communication with the sample inlet; and d) fifth and sixth droplet source regions. The fifth sample channel intersects with the fifth reagent channel at a fifth intersection, the sixth sample channel intersects with the sixth reagent channel at a sixth intersection, the fifth droplet source region is fluidically disposed between the fifth intersection and the one or more collection reservoirs and the sixth droplet source region is fluidically disposed between the sixth intersection and the one or more collection reservoirs. The fifth sample channel and/or the sixth sample channel is disposed between the second and third reagent inlets.

The device may further include a) a seventh reagent channel in fluid communication with the third reagent inlet; b) an eighth reagent channel in fluid communication with the fourth reagent inlet; c) seventh and eighth sample channels in fluid communication with the sample inlet; and d) seventh and eighth droplet source regions. The seventh sample channel intersects with the seventh reagent channel at a seventh intersection, the eighth sample channel intersects with the eighth reagent channel at an eighth intersection, the seventh droplet source region is fluidically disposed between the seventh intersection and the one or more collection reservoirs and the eighth droplet source region is fluidically disposed between the eighth intersection and the one or more collection reservoirs. The seventh sample channel and/or the eighth sample channel is disposed between the second and third reagent inlets.

In certain embodiments, any one of the first or second reagent inlets may have a cross-sectional dimension of at least about 0.5 mm and/or any one of the third or fourth reagent inlets may have a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm). In some embodiments, the first reagent channel includes a first reagent funnel, the second reagent channel includes a second reagent funnel, the third reagent channel includes a third reagent funnel, the fourth reagent channel includes a fourth reagent funnel, the fifth reagent channel includes a fifth reagent funnel, and the sixth reagent channel includes a sixth reagent funnel and/or the first sample channel includes a first sample funnel, the second sample channel includes a second sample funnel, the third sample channel includes a third sample funnel, the fourth sample channel includes a fourth sample funnel, the fifth sample channel includes a fifth sample funnel, and the sixth sample channel includes a sixth sample funnel. In particular embodiments, one or more of the first, second, third, fourth, fifth, sixth, seventh, and/or eighth sample and/or reagent channels may include two or more rectifiers fluidically disposed between the sample inlet and/or the first, second, third, and/or fourth reagent inlets and the one or more collection reservoirs.

In certain embodiments, the device may further include a) a third reagent inlet; b) a third reagent channel in fluid communication with the third reagent inlet; c) a third sample channel in fluid communication with the sample inlet; and d) a third droplet source region. The third sample channel intersects with the third sample channel at a third intersection, the third droplet source region is fluidically disposed between the third intersection and the one or more collection reservoirs, and the third sample channel is disposed between the first and second reagent inlets and/or between the second and third reagent inlets.

The device may further include e) a fourth reagent channel in fluid communication with the first reagent inlet; f) a fifth reagent channel in fluid communication with the second reagent inlet; g) a sixth reagent channel in fluid communication with the third reagent inlet; h) fourth, fifth, and sixth sample channels in fluid communication with the sample inlet; and i) fourth, fifth, and sixth droplet source regions. The fourth sample channel intersects with the fourth reagent channel at a fourth intersection, the fifth sample channel intersects with the fifth reagent channel at a fifth intersection, and the sixth sample channel intersects with the sixth reagent channel at a sixth intersection. The fourth droplet source region is fluidically disposed between the fourth intersection and the one or more collection reservoirs, the fifth droplet source region is fluidically disposed between the fifth intersection and the one or more collection reservoirs, and the sixth droplet source region is fluidically disposed between the sixth intersection and the one or more collection reservoirs. One or more of the fourth, fifth, or sixth sample channels are disposed between the first and second inlets or between the second and third reagent inlets.

In some embodiments, device may further include a) fourth, fifth, and sixth reagent inlets; b) a seventh reagent channel in fluid communication with the fourth reagent inlet, an eighth reagent channel in fluid communication with the fifth reagent inlet, and a ninth reagent channel in fluid communication with the sixth reagent inlet; c) seventh, eighth, and ninth sample channels in fluid communication with the sample inlet; and d) fourth, fifth, and sixth droplet source regions. The seventh sample channel intersects with the seventh reagent channel at a seventh intersection, the eighth sample channel intersects with the eighth reagent channel at an eighth intersection, and the ninth sample channel intersects with the ninth reagent channel at a ninth intersection. The seventh droplet source region is fluidically disposed between the seventh intersection and the one or more collection reservoirs, the eighth droplet source region is fluidically disposed between the eighth intersection and the one or more collection reservoirs, and the ninth droplet source region is fluidically disposed between the ninth intersection and the one or more collection reservoirs. One or more of the seventh, eighth, or ninth sample channels are disposed between the second and third reagent inlets or between the second and third reagent inlets. In certain embodiments, the device may further include e) a tenth reagent channel in fluid communication with the fourth reagent inlet; f) an eleventh reagent channel in fluid communication with the fifth reagent inlet; g) a twelfth reagent channel in fluid communication with the sixth reagent inlet; h) tenth, eleventh, and twelfth sample channels in fluid communication with the sample inlet; and i) tenth, eleventh, and twelfth droplet source regions. The tenth sample channel intersects with the tenth reagent channel at a tenth intersection, the eleventh sample channel intersects with the eleventh reagent channel at an eleventh intersection, and the ninth sample channel intersects with the twelfth reagent channel at and twelfth intersection. The tenth droplet source region is fluidically disposed between the tenth intersection and the one or more collection reservoirs, the eleventh droplet source region is fluidically disposed between the eleventh intersection and the one or more collection reservoirs, and the twelfth droplet source region is fluidically disposed between the twelfth intersection and the one or more collection reservoirs. One or more of the tenth, eleventh, or twelfth sample channels are disposed between the second and third reagent inlets or between the second and third reagent inlets.

In certain embodiments, where the second reagent inlet is disposed between the first and third reagent inlets and/or the fifth reagent inlets is disposed between the fourth and sixth reagent inlets, the second and/or fifth reagent inlets may have a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm). In some embodiments one or more of the first through twelfth sample channels may include a sample funnel and/or one or more of the first through twelfth reagent channels may include a reagent funnel.

In particular embodiments, the fourth sample channel may be fluidically connected to the first sample channel, the fifth sample channel may be fluidically connected to the second sample channel, the sixth sample may be fluidically connected to the third sample channel, the tenth sample channel may be fluidically connected to the seventh sample channel, the eleventh sample channel may be fluidically connected to the eighth sample channel, and the twelfth sample channel may be fluidically connected to the ninth sample channel and/or the fourth reagent channel may be fluidically connected to the first reagent channel, the fifth reagent channel may be fluidically connected to the second reagent channel, the sixth reagent may be fluidically connected to the third reagent channel, the tenth reagent channel may be fluidically connected to the seventh reagent channel, the eleventh reagent channel may be fluidically connected to the eighth reagent channel, and the twelfth reagent channel may be fluidically connected to the ninth reagent channel.

In some embodiments, one or more of the first, second, third, fourth, fifth, sixth, seventh, eighth, ninth, tenth, eleventh, and/or twelfth sample and/or reagent channels may include two or more rectifiers fluidically disposed between the sample inlet and/or the first, second, third, fourth, fifth, and/or sixth reagent inlets and the one or more collection reservoirs. In some embodiments, at least one of the droplet source regions includes a shelf that allows a liquid to expand in one dimension and a step that allows the liquid to expand in an orthogonal dimension.

Another aspect of the invention provides a method of producing droplets by a) providing a device including a flow path including i) a sample inlet; ii) one or more collection reservoirs; iii) first and second reagent inlets;

iv) first and second sample channels in fluid communication with the sample inlet; v) a first reagent channel in fluid communication with the first reagent inlet and a second reagent channel in fluid communication with the second reagent inlet; and vi) first and second droplet source regions including a second liquid; where the first sample channel intersects with the first reagent channel at a first intersection, and the second sample channel intersects with the second reagent channel at a second intersection. The first droplet source region is fluidically disposed between the first intersection and the one or more collection reservoirs, and the second droplet source region is fluidically disposed between the second intersection and the one or more collection reservoirs. The first sample channel and/or the second sample channel is disposed between the first and second reagent inlets. Step b) includes allowing a first liquid to flow from the sample inlet via the first and second sample channels to the first and second intersections, and allowing one or more third liquids to flow from the first and second reagent inlets via the first and second reagent channels to the one or more intersections; where the first liquid and one of the one or more third liquids combine at the one or more intersections and produce droplets in the second liquid at the first and second droplet source regions.

In certain embodiments of the method, the device may further include i) a third reagent channel in fluid communication with the first reagent inlet; ii) a fourth reagent channel in fluid communication with the second reagent inlet; iii) third and fourth sample channels in fluid communication with the sample inlet; and iv) third and fourth droplet source regions including the second liquid. The third sample channel intersects with the third reagent channel at a third intersection, the fourth sample channel intersects with the fourth reagent channel at a fourth intersection, the third droplet source region is fluidically disposed between the third intersection and the one or more collection reservoirs and the fourth droplet source region is fluidically disposed between the fourth intersection and the one or more collection reservoirs. Step b) may further includes allowing the first liquid to flow from the sample inlet via the third and fourth sample channels to the third and fourth intersections, and allowing the one or more third liquids to flow from the first and second reagent inlets via the third and fourth reagent channels to the third and fourth intersections, where the first liquid and one of the one or more third liquids combine at the third and fourth intersections and produce droplets in the second liquid at the third and fourth droplet source regions.

In some embodiments of the method, the third reagent channel is fluidically connected to the first reagent channel and the fourth reagent channel is fluidically connected to the second reagent channel. In certain embodiments, the first reagent channel may include a first reagent funnel fluidically connected to the first reagent inlet and the second reagent channel may include a second reagent funnel fluidically connected to the second reagent inlet. In particular embodiments, the first reagent channel may include a first reagent funnel fluidically connected to the first reagent inlet and the second reagent channel may include a second reagent funnel fluidically connected to the second reagent inlet, the third reagent channel may include a third reagent funnel fluidically connected to the first reagent inlet, and the fourth reagent channel may include a fourth reagent funnel fluidically connected to the second reagent inlet.

In some embodiments, one or more of the first, second, third, and/or fourth sample and/or reagent channels can include two or more rectifiers fluidically disposed between the sample inlet and/or first and/or second reagent inlets and the one or more collection reservoirs. In some embodiments, the first, second, third, and fourth reagent channels each include one of a first, second, third, or fourth rectifier fluidically disposed between the first and second reagent inlets and the one or more collection reservoirs. In some embodiments, the first through fourth rectifiers are each adjacent one of the first through fourth intersections, e.g., fluidically connected to one of the first through fourth intersections. In certain embodiments, the device of the method may include a reagent reservoir in fluid communication with the first and second reagent inlets.

In some embodiments of the method, the device may further include i) third and fourth reagent inlets; ii) a fifth reagent channel in fluid communication with the third reagent inlet and a sixth reagent channel in fluid communication with the fourth reagent inlet; iii) fifth and sixth sample channels in fluid communication with the sample inlet; and iv) fifth and sixth droplet source regions including the second liquid. The fifth sample channel intersects with the fifth reagent channel at a fifth intersection, the sixth sample channel intersects with the sixth reagent channel at a sixth intersection. The fifth droplet source region is fluidically disposed between the fifth intersection and the one or more collection reservoirs and the sixth droplet source region is fluidically disposed between the sixth intersection and the one or more collection reservoirs. The fifth sample channel and/or the sixth sample channel is disposed between the second and third reagent inlets. Step b) may further include allowing the first liquid to flow from the sample inlet via the fifth and sixth sample channels to the fifth and sixth intersections, and allowing the one or more third liquids to flow from the third and fourth reagent inlets via the fifth and sixth reagent channels to the fifth and sixth intersections, where the first liquid and one of the one or more third liquids combine at the fifth and sixth intersections and produce droplets in the second liquid at the fifth and sixth droplet source regions.

In certain embodiments of the method, the device may further include i) a seventh reagent channel in fluid communication with the third reagent inlet; ii) an eighth reagent channel in fluid communication with the fourth reagent inlet; iii) seventh and eighth sample channels in fluid communication with the sample inlet; and iv) seventh and eighth droplet source regions including the second liquid. The seventh sample channel intersects with the seventh reagent channel at a seventh intersection, the eighth sample channel intersects with the eighth reagent channel at an eighth intersection, the seventh droplet source region is fluidically disposed between the seventh intersection and the one or more collection reservoirs, and the eighth droplet source region is fluidically disposed between the eighth intersection and the one or more collection reservoirs. The seventh sample channel and/or the eighth sample channel is disposed between the second and third reagent inlets. Step b) may further include allowing the first liquid to flow from the sample inlet via the seventh and eighth sample channels to the seventh and eighth intersections, and allowing the one or more third liquids to flow from the third and fourth reagent inlets via the seventh and eighth reagent channels to the seventh and eighth intersections, where the first liquid and one of the one or more third liquids combine at the seventh and eighth intersections and produce droplets in the second liquid at the seventh and eighth droplet source regions.

In some embodiments of the method, any one of the first or second reagent inlets has a cross-sectional dimension of at least 0.5 mm and/or any one of the third or fourth reagent inlets has a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm.

In some embodiments, the first reagent channel may include a first reagent funnel, the second reagent channel includes a second reagent funnel, the third reagent channel includes a third reagent funnel, the fourth reagent channel includes a fourth reagent funnel, the fifth reagent channel includes a fifth reagent funnel, and the sixth reagent channel includes a sixth reagent funnel and/or the first sample channel includes a first sample funnel, the second sample channel includes a second sample funnel, the third sample channel includes a third sample funnel, the fourth sample channel includes a fourth sample funnel, the fifth sample channel includes a fifth sample funnel, and the sixth sample channel includes a sixth sample funnel.

In some embodiments, one or more of the first, second, third, fourth, fifth, sixth, seventh, and/or eighth sample and/or reagent channels include two or more rectifiers fluidically disposed between the sample and/or first, second, third, and/or fourth reagent inlets and the one or more collection reservoirs.

In some embodiments of the method, the device may further include i) a third reagent inlet; ii) a third reagent channel in fluid communication with the third reagent inlet; iii) a third sample channel in fluid communication with the sample inlet; and iv) a third droplet source region including the second liquid. The third sample channel intersects with the third sample channel at a third intersection, and the third droplet source region is fluidically disposed between the third intersection and the one or more collection reservoirs. The third sample channel is disposed between the first and second reagent inlets and/or between the second and third reagent inlets. Step b) may further include allowing the first liquid to flow from the sample inlet via the third sample channel to the third intersection, and allowing the one or more third liquids to flow from the third reagent inlet via the third reagent channel to the third intersection, where the first liquid and one of the one or more third liquids combine at the third intersection and produce droplets in the second liquid at the third droplet source region.

In certain embodiments, the device may further include i) a fourth reagent channel in fluid communication with the first reagent inlet; ii) a fifth reagent channel in fluid communication with the second reagent inlet; iii) a sixth reagent channel in fluid communication with the third reagent inlet; iv) fourth, fifth, and sixth sample channels in fluid communication with the sample inlet; and v) fourth, fifth, and sixth droplet source regions including the second liquid. The fourth sample channel intersects with the fourth reagent channel at a fourth intersection, the fifth sample channel intersects with the fifth reagent channel at a fifth intersection, the sixth sample channel intersects with the sixth reagent channel at a sixth intersection, the fourth droplet source region is fluidically disposed between the fourth intersection and the one or more collection reservoirs, the fifth droplet source region is fluidically disposed between the fifth intersection and the one or more collection reservoirs, and the sixth droplet source region is fluidically disposed between the sixth intersection and the one or more collection reservoirs. One or more of the fourth, fifth, or sixth sample channels are disposed between the first and second inlets or between the second and third reagent inlets. Step b) may further include allowing the first liquid to flow from the sample inlet via the fourth, fifth, and sixth sample channels to the fourth, fifth, and sixth intersections, and allowing the one or more third liquids to flow from the first, second, and third reagent inlets via the fourth, fifth, and sixth reagent channels to the fourth, fifth, and sixth intersections, where the first liquid and one of the one or more third liquids combine at the fourth, fifth, and sixth intersections and produce droplets in the second liquid at the fourth, fifth, and sixth droplet source regions.

In certain embodiments, the device may further include i) fourth, fifth, and sixth reagent inlets; ii) a seventh reagent channel in fluid communication with the fourth reagent inlet, an eighth reagent channel in fluid communication with the fifth reagent inlet, and a ninth reagent channel in fluid communication with the sixth reagent inlet; iii) seventh, eighth, and ninth sample channels in fluid communication with the sample inlet; and iv) fourth, fifth, and sixth droplet source regions including the second liquid. The seventh sample channel intersects with the seventh reagent channel at a seventh intersection, the eighth sample channel intersects with the eighth reagent channel at an eighth intersection, the ninth sample channel intersects with the ninth reagent channel at a ninth intersection, the seventh droplet source region is fluidically disposed between the seventh intersection and the one or more collection reservoirs, the eighth droplet source region is fluidically disposed between the eighth intersection and the one or more collection reservoirs, and the ninth droplet source region is fluidically disposed between the ninth intersection and the one or more collection reservoirs. One or more of the seventh, eighth, or ninth sample channels are disposed between the second and third reagent inlets or between the second and third reagent inlets. Step b) may further include allowing the first liquid to flow from the sample inlet via the seventh, eighth, and ninth sample channels to the seventh, eighth, and ninth intersections, and allowing the one or more third liquids to flow from the fourth, fifth, and sixth reagent inlets via the seventh, eighth, and ninth reagent channels to the seventh, eighth, and ninth intersections, where the first liquid and one of the one or more third liquids combine at the seventh, eighth, and ninth intersections and produce droplets in the second liquid at the seventh, eighth, and ninth droplet source regions.

In certain embodiments of the method, the device may further include i) a tenth reagent channel in fluid communication with the fourth reagent inlet; ii) an eleventh reagent channel in fluid communication with the fifth reagent inlet; iii) a twelfth reagent channel in fluid communication with the sixth reagent inlet; iv) tenth, eleventh, and twelfth sample channels in fluid communication with the sample inlet; and v) tenth, eleventh, and twelfth droplet source regions including the second liquid. The tenth sample channel intersects with the tenth reagent channel at a tenth intersection, the eleventh sample channel intersects with the eleventh reagent channel at an eleventh intersection, the ninth sample channel intersects with the twelfth reagent channel at an twelfth intersection, the tenth droplet source region is fluidically disposed between the tenth intersection and the one or more collection reservoirs, the eleventh droplet source region is fluidically disposed between the eleventh intersection and the one or more collection reservoirs, and the twelfth droplet source region is fluidically disposed between the twelfth intersection and the one or more collection reservoirs. One or more of the tenth, eleventh, or twelfth sample channels are disposed between the second and third reagent inlets or between the second and third reagent inlets. Step b) may further include allowing the first liquid to flow from the sample inlet via the tenth, eleventh, and twelfth sample channels to the tenth, eleventh, and twelfth intersections, and allowing the one or more third liquids to flow from the fourth, fifth, and sixth reagent inlets via the tenth, eleventh, and twelfth reagent channels to the tenth, eleventh, and twelfth intersections, where the first liquid and one of the one or more third liquids combine at the tenth, eleventh, and twelfth intersections and produce droplets in the second liquid at the tenth, eleventh, and twelfth droplet source regions.

In some embodiments, the second reagent inlet is disposed between the first and third reagent inlets and/or the fifth reagent inlets is disposed between the fourth and sixth reagent inlets, and the second and/or fifth reagent inlets have a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm). In some embodiments, one or more of the first through twelfth sample channels includes a sample funnel and/or one or more of the first through twelfth reagent channels include a reagent funnel. In some embodiments, the fourth sample channel is fluidically connected to the first sample channel, the fifth sample channel is fluidically connected to the second sample channel, and the sixth sample is fluidically connected to the third sample channel, the tenth sample channel is fluidically connected to the seventh sample channel, the eleventh sample channel is fluidically connected to the eighth sample channel, and the twelfth sample channel is fluidically connected to the ninth sample channel and/or the fourth reagent channel is fluidically connected to the first reagent channel, the fifth reagent channel is fluidically connected to the second reagent channel, and the sixth reagent is fluidically connected to the third reagent channel, the tenth reagent channel is fluidically connected to the seventh reagent channel, the eleventh reagent channel is fluidically connected to the eighth reagent channel, and the twelfth reagent channel is fluidically connected to the ninth reagent channel. In some embodiments, one or more of the first, second, third, fourth, fifth, sixth, seventh, eighth, ninth, tenth, eleventh, and/or twelfth sample and/or reagent channels include two or more rectifiers fluidically disposed between the sample inlet and/or the first, second, third, fourth, fifth, and/or sixth reagent inlets and the one or more collection reservoirs. In certain embodiments, at least one of the droplet source regions includes a shelf that allows a liquid to expand in one dimension and a step that allows the liquid to expand in an orthogonal dimension.

Another aspect of the invention provides a system for producing droplets. The system includes a) a device including a flow path including i) a sample inlet; ii) one or more collection reservoirs; iii) first and second reagent inlets; iv) first and second sample channels in fluid communication with the sample inlet; v) a first reagent channel in fluid communication with the first reagent inlet and a second reagent channel in fluid communication with the second reagent inlet; and vi) first and second droplet source regions. The first sample channel intersects with the first reagent channel at a first intersection, the second sample channel intersects with the second reagent channel at a second intersection, the first droplet source region is fluidically disposed between the first intersection and the one or more collection reservoirs, and the second droplet source region is fluidically disposed between the second intersection and the one or more collection reservoirs; and where the first sample channel and/or the second sample channel is disposed between the first and second reagent inlets. The system further includes b) particles in the sample inlet, first and/or second reagent inlet, and/or droplets in the one or more collection reservoirs.

In some embodiments of the system, the device may further include v) a third reagent channel in fluid communication with the first reagent inlet; vi) a fourth reagent channel in fluid communication with the second reagent inlet; vii) third and fourth sample channels in fluid communication with the sample inlet; and viii) third and fourth droplet source regions. The third sample channel intersects with the third reagent channel at a third intersection, the fourth sample channel intersects with the fourth reagent channel at a fourth intersection, the third droplet source region is fluidically disposed between the third intersection and the one or more collection reservoirs and the fourth droplet source region is fluidically disposed between the fourth intersection and the one or more collection reservoirs.

In certain embodiments of the system, the third reagent channel is fluidically connected to the first reagent channel and the fourth reagent channel is fluidically connected to the second reagent channel. In some embodiments of the system, the first reagent channel may include a first reagent funnel fluidically connected to the first reagent inlet and the second reagent channel includes a second reagent funnel fluidically connected to the second reagent inlet.

In some embodiments of the system, the first reagent channel includes a first reagent funnel fluidically connected to the first reagent inlet and the second reagent channel includes a second reagent funnel fluidically connected to the second reagent inlet, the third reagent channel includes a third reagent funnel fluidically connected to the first reagent inlet, and the fourth reagent channel includes a fourth reagent funnel fluidically connected to the second reagent inlet. In certain embodiments, one or more of the first, second, third, and/or fourth sample and/or reagent channels may include two or more rectifiers fluidically disposed between the sample inlet and/or the first and/or second reagent inlets and the one or more collection reservoirs. In particular embodiments, the system may further include a reagent reservoir in fluid communication with the first and second reagent inlets.

In some embodiments of the system, the device may further include i) third and fourth reagent inlets; ii) a fifth reagent channel in fluid communication with the third reagent inlet and a sixth reagent channel in fluid communication with the fourth reagent inlet; iii) fifth and sixth sample channels in fluid communication with the sample inlet; and iv) fifth and sixth droplet source regions. The fifth sample channel intersects with the fifth reagent channel at a fifth intersection, the sixth sample channel intersects with the sixth reagent channel at a sixth intersection, the fifth droplet source region is fluidically disposed between the fifth intersection and the one or more collection reservoirs, and the sixth droplet source region is fluidically disposed between the sixth intersection and the one or more collection reservoirs. The fifth sample channel and/or the sixth sample channel is disposed between the second and third reagent inlets. In some embodiments, the device may further include v) a seventh reagent channel in fluid communication with the third reagent inlet; vi) an eighth reagent channel in fluid communication with the fourth reagent inlet; vii) seventh and eighth sample channels in fluid communication with the sample inlet; and viii) seventh and eighth droplet source regions. The seventh sample channel intersects with the seventh reagent channel at a seventh intersection, the eighth sample channel intersects with the eighth reagent channel at an eighth intersection, the seventh droplet source region is fluidically disposed between the seventh intersection and the one or more collection reservoirs and the eighth droplet source region is fluidically disposed between the eighth intersection and the one or more collection reservoirs. The seventh sample channel and/or the eighth sample channel is disposed between the second and third reagent inlets.

In some embodiments of the system, any one of the first or second reagent inlets has a cross-sectional dimension of at least 0.5 mm and/or any one of the third or fourth reagent inlets has a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm). In some embodiments, the first reagent channel includes a first reagent funnel, the second reagent channel includes a second reagent funnel, the third reagent channel includes a third reagent funnel, the fourth reagent channel includes a fourth reagent funnel, the fifth reagent channel includes a fifth reagent funnel, and the sixth reagent channel includes a sixth reagent funnel and/or the first sample channel includes a first sample funnel, the second sample channel includes a second sample funnel, the third sample channel includes a third sample funnel, the fourth sample channel includes a fourth sample funnel, the fifth sample channel includes a fifth sample funnel, and the sixth sample channel includes a sixth sample funnel. In certain embodiments, one or more of the first, second, third, fourth, fifth, sixth, seventh, and/or eighth sample and/or reagent channels may include two or more rectifiers fluidically disposed between the sample inlet and/or the first, second, third, and/or fourth reagent inlets and the one or more collection reservoirs.

In some embodiments of the system, the device may further include i) a third reagent inlet; ii) a third reagent channel in fluid communication with the third reagent inlet; iii) a third sample channel in fluid communication with the sample inlet; and iv) a third droplet source region. The third sample channel intersects with the third sample channel at a third intersection, and the third droplet source region is fluidically disposed between the third intersection and the one or more collection reservoirs. The third sample channel is disposed between the first and second reagent inlets and/or between the second and third reagent inlets. In certain embodiments, the device may further include vi) a fourth reagent channel in fluid communication with the first reagent inlet; vii) a fifth reagent channel in fluid communication with the second reagent inlet; viii) a sixth reagent channel in fluid communication with the third reagent inlet; ix) fourth, fifth, and sixth sample channels in fluid communication with the sample inlet; and x) fourth, fifth, and sixth droplet source regions. The fourth sample channel intersects with the fourth reagent channel at a fourth intersection, the fifth sample channel intersects with the fifth reagent channel at a fifth intersection, the sixth sample channel intersects with the sixth reagent channel at a sixth intersection, the fourth droplet source region is fluidically disposed between the fourth intersection and the one or more collection reservoirs, the fifth droplet source region is fluidically disposed between the fifth intersection and the one or more collection reservoirs, and the sixth droplet source region is fluidically disposed between the sixth intersection and the one or more collection reservoirs. One or more of the fourth, fifth, or sixth sample channels are disposed between the first and second inlets or between the second and third reagent inlets.

In some embodiments of the system, the device may further include i) fourth, fifth, and sixth reagent inlets; ii) a seventh reagent channel in fluid communication with the fourth reagent inlet, an eighth reagent channel in fluid communication with the fifth reagent inlet, and a ninth reagent channel in fluid communication with the sixth reagent inlet; iii) seventh, eighth, and ninth sample channels in fluid communication with the sample inlet; and iv) fourth, fifth, and sixth droplet source regions. The seventh sample channel intersects with the seventh reagent channel at a seventh intersection, the eighth sample channel intersects with the eighth reagent channel at an eighth intersection, the ninth sample channel intersects with the ninth reagent channel at a ninth intersection, the seventh droplet source region is fluidically disposed between the seventh intersection and the one or more collection reservoirs, the eighth droplet source region is fluidically disposed between the eighth intersection and the one or more collection reservoirs, and the ninth droplet source region is fluidically disposed between the ninth intersection and the one or more collection reservoirs. One or more of the seventh, eighth, or ninth sample channels are disposed between the second and third reagent inlets or between the second and third reagent inlets.

In some embodiments of the system, the device may further include i) a tenth reagent channel in fluid communication with the fourth reagent inlet ii) an eleventh reagent channel in fluid communication with the fifth reagent inlet; iii) a twelfth reagent channel in fluid communication with the sixth reagent inlet; iv) tenth, eleventh, and twelfth sample channels in fluid communication with the sample inlet; and v) tenth, eleventh, and twelfth droplet source regions. The tenth sample channel intersects with the tenth reagent channel at a tenth intersection, the eleventh sample channel intersects with the eleventh reagent channel at an eleventh intersection, the ninth sample channel intersects with the twelfth reagent channel at an twelfth intersection, the tenth droplet source region is fluidically disposed between the tenth intersection and the one or more collection reservoirs, the eleventh droplet source region is fluidically disposed between the eleventh intersection and the one or more collection reservoirs, and the twelfth droplet source region is fluidically disposed between the twelfth intersection and the one or more collection reservoirs. One or more of the tenth, eleventh, or twelfth sample channels are disposed between the second and third reagent inlets or between the second and third reagent inlets.

In some embodiments of the system, the second reagent inlet is disposed between the first and third reagent inlets and/or the fifth reagent inlet is disposed between the fourth and sixth reagent inlets, and the second and/or fifth reagent inlets have a cross-sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm). In some embodiments, one or more of the first through twelfth sample channels may include a sample funnel and/or where one or more of the first through twelfth reagent channels include a reagent funnel. In some embodiments, the fourth sample channel is fluidically connected to the first sample channel, the fifth sample channel is fluidically connected to the second sample channel, and the sixth sample is fluidically connected to the third sample channel, the tenth sample channel is fluidically connected to the seventh sample channel, the eleventh sample channel is fluidically connected to the eighth sample channel, and the twelfth sample channel is fluidically connected to the ninth sample channel and/or the fourth reagent channel is fluidically connected to the first reagent channel, the fifth reagent channel is fluidically connected to the second reagent channel, and the sixth reagent is fluidically connected to the third reagent channel, the tenth reagent channel is fluidically connected to the seventh reagent channel, the eleventh reagent channel is fluidically connected to the eighth reagent channel, and the twelfth reagent channel is fluidically connected to the ninth reagent channel. In some embodiments, one or more of the first, second, third, fourth, fifth, sixth, seventh, eighth, ninth, tenth, eleventh, and/or twelfth sample and/or reagent channels include two or more rectifiers fluidically disposed between the sample inlet and/or the first, second, third, fourth, fifth, and/or sixth reagent inlets and the one or more collection reservoirs. In certain embodiments, at least one of the droplet source regions includes a shelf that allows a liquid to expand in one dimension and a step that allows the liquid to expand in an orthogonal dimension.

Another aspect of the invention provides a device for producing droplets, the device including a flow path including a) one or more sample inlets b) one or more reagent inlets; c) a collection reservoir including a first partitioning wall; d) first and second sample channels, each in fluid communication with the one or more sample inlets; e) first and second reagent channels, each in fluid communication with the one or more reagent inlets; and f) first and second droplet source regions. The first sample channel intersects with the first reagent channel at a first intersection, the second sample channel intersects with the second reagent channel at a second intersection, the first droplet source region is fluidically disposed between the first intersection and the collection reservoir, the second droplet source region is fluidically disposed between the second intersection and the collection reservoir, and the first partitioning wall fluidically separates droplets formed at the first and second droplet source regions.

In some embodiments, an insert disposed in the collection reservoir includes the first partitioning wall.

In some embodiments, the flow path further includes a) a third sample channel, in fluid communication with the one or more sample inlets; b) a third reagent channel, in fluid communication with the one or more reagent inlets; and c) a third droplet source region. The collection reservoir further includes a second partitioning wall. The third sample channel intersects with the third reagent channel at a third intersection, the third droplet source region is fluidically disposed between the third intersection and the collection reservoir, and the first and second partitioning walls fluidically separate droplets formed at the third droplet source region from droplets formed at the first and second droplet source regions. In some embodiments, an insert disposed in the collection reservoir includes the first and second partitioning walls. In some embodiments, the device may further include a plurality of flow paths. In certain embodiments, the device may include a plurality of flow paths and the insert includes the first partitioning wall of each flow path.

Another aspect of the invention provides a method of producing droplets. The method includes a) providing a device including a flow path including i) one or more sample inlets; ii) one or more reagent inlets; iii) a collection reservoir including a first partitioning wall; iv) first and second sample channels, each in fluid communication with the one or more sample inlets; v) first and second reagent channels, each in fluid communication with the one or more reagent inlets; and vi) first and second droplet source regions including a second liquid. The first sample channel intersects with the first reagent channel at a first intersection, the second sample channel intersects with the second reagent channel at a second intersection, the first droplet source region is fluidically disposed between the first intersection and the collection reservoir, the second droplet source region is fluidically disposed between the second intersection and the collection reservoir, and the first partitioning wall fluidically separates droplets formed at the first and second droplet source regions. The method further includes b) allowing a first liquid to flow from the one or more sample inlets via the first and second sample channels to the first and second intersections, and allowing one or more third liquids to flow from one or more reagent inlets via the first and second reagent channels to the first and second intersections, where the first liquid and one of the one or more third liquids combine at the first and second intersections and produce droplets in the second liquid at the first and second droplet source regions. In certain embodiments, an insert disposed in the collection reservoir includes the first partitioning wall.

In some embodiments of the method, the flow path further includes i) a third sample channel, in fluid communication with the one or more sample inlets; ii) a third reagent channel, in fluid communication with the one or more reagent inlets; and iii) a third droplet source region. The collection reservoir further includes a second partitioning wall. The third sample channel intersects with the third reagent channel at a third intersection, the third droplet source region is fluidically disposed between the third intersection and the collection reservoir, and the first and second partitioning walls fluidically separate droplets formed at the third droplet source region from droplets formed at the first and second droplet source regions. Step b) then further includes allowing a first liquid to flow from the one or more sample inlets via the third sample channel to the third intersection, and allowing one or more third liquids to flow from one or more reagent inlets via third reagent channel to the third intersection, where the first liquid and one of the one or more third liquids combine at the third intersection and produce droplets in the second liquid at the third droplet source region. In certain embodiments, an insert disposed in the collection reservoir includes the first and second partitioning walls. In particular embodiments, the device may further include a plurality of flow paths. In certain embodiments, the device further includes a plurality of flow paths and the insert includes the first partitioning wall of each flow path.

Another aspect of the invention provides a kit for producing droplets. The kit includes a) providing a device including a flow path including i) one or more sample inlets; ii) one or more reagent inlets; iii) a collection reservoir; iv) first and second sample channels, each in fluid communication with the one or more sample inlets; v) first and second reagent channels, each in fluid communication with the one or more reagent inlets; and vi) first and second droplet source regions. The first sample channel intersects with the first reagent channel at a first intersection, the second sample channel intersects with the second reagent channel at a second intersection, the first droplet source region is fluidically disposed between the first intersection and the collection reservoir, the second droplet source region is fluidically disposed between the second intersection and the collection reservoir. The kit further includes b) an insert configured to fit in the collection reservoir and including a first partitioning wall, where the first partitioning wall fluidically separates droplets formed at the first and second droplet source regions when the insert is disposed in the collection reservoir.

In some embodiments, the flow path of the device of the kit further includes i) a third sample channel, in fluid communication with the one or more sample inlets; ii) a third reagent channel, in fluid communication with the one or more reagent inlets; and iii) a third droplet source region. The third sample channel intersects with the third reagent channel at a third intersection, the third droplet source region is fluidically disposed between the third intersection and the collection reservoir. The insert of b) further includes a second partitioning wall, where the first and second partitioning walls fluidically separate droplets formed at the third droplet source region from droplets formed at the first and second droplet source regions when the insert is disposed in the collection reservoir. In some embodiments, the device further includes a plurality of flow paths. In certain embodiments, the insert includes the first partitioning wall of each flow path.

In another aspect, the invention provides a system for producing droplets. The system includes a) a device including a flow path including: i) one or more sample inlets; ii) one or more reagent inlets; iii) one or more collection reservoirs; iv) one or more sample channels in fluid communication with the one or more sample inlets; v) one or more reagent channels in fluid communication with the one or more reagent inlets; and vi) one or more droplet source regions. Each of the one or more sample channels intersects with one of the one or more reagent channels at an intersection, each of the one or more droplet source regions is fluidically disposed between each intersection and one of the one or more collection reservoirs. The system further includes b) a removable insert in one of the one or more reagent inlets and/or sample inlets, where the insert includes a lumen sized to guide a pipette tip into the one of the one or more reagent inlets and/or sample inlets.

In some embodiments, the insert includes an upper portion that rests on a surface of the device. In some embodiments, the insert includes a vent in a wall of the lumen. In some embodiments, the lumen is positioned to guide the pipette tip to a central portion of the one of the one or more reagent inlets and/or sample inlets. In some embodiments, the device includes a plurality of flow paths. In particular embodiments, the insert includes a plurality of lumens, wherein adjacent lumens of the insert are disposed in sample and/or reagent inlets of adjacent flow paths.

In another aspect, the invention provides a method for priming a device. The method includes a) providing a system including the device, where the device includes a flow path including i) one or more sample inlets; ii) one or more reagent inlets; iii) one or more collection reservoirs; iv) one or more sample channels in fluid communication with the one or more sample inlets; v) one or more reagent channels in fluid communication with the one or more reagent inlets; and vi) one or more droplet source regions. Each of the one or more sample channels intersects with one of the one or more reagent channels at an intersection, each of the one or more droplet source regions is fluidically disposed between each intersection and one of the one or more collection reservoirs. The system includes a removable insert in one of the one or more reagent inlets and/or sample inlets, where the insert includes a lumen sized to guide a pipette tip into the one of the one or more reagent inlets and/or sample inlets. The method further includes step b) adding one or more first liquids to the one or more reagent inlets and/or one or more second liquids to the one or more sample inlets; and step c) removing the insert, thereby priming the device.

In some embodiments of the method, the insert may include an upper portion that rests on a surface of the device. In particular embodiments, the insert may include a vent in a wall of the lumen. In certain embodiment, the lumen is positioned to guide the pipette tip to a central portion of the one of the one or more reagent inlets and/or sample inlets. In some embodiments, the device may include a plurality of flow paths. In some embodiments, the insert includes a plurality of lumens, where adjacent lumens of the insert are disposed in sample and/or reagent inlets of adjacent flow paths.

In another aspect, the invention provides a kit for producing droplets. The kit includes a) a device including a flow path including i) one or more sample inlets; ii) one or more reagent inlets; iii) one or more collection reservoirs; iv) one or more sample channels in fluid communication with the one or more sample inlets; v) one or more reagent channels in fluid communication with the one or more reagent inlets; and vi) one or more droplet source regions. Each of the one or more sample channels intersects with one of the one or more reagent channels at an intersection, each of the one or more droplet source regions is fluidically disposed between each intersection and one of the one or more collection reservoirs. The kit also includes b) a removable insert configured to fit in one of the one or more reagent inlets and/or sample inlets, where the insert includes a lumen sized to guide a pipette tip into the one of the one or more reagent inlets and/or sample inlets.

In some embodiments, the insert may include an upper portion that rests on a surface of the device. In certain embodiments, the insert may include a vent in a wall of the lumen. In some embodiments, the lumen is positioned to guide the pipette tip to a central portion of the one of the one or more reagent inlets and/or sample inlets. In some embodiments, the device may include a plurality of flow paths. In particular embodiments, the insert may include a plurality of lumens, where adjacent lumens of the insert are disposed in sample and/or reagent inlets of adjacent flow paths.

In another aspect, the invention provides a system for producing droplets. The system includes a device including a flow path including a) first and second sample inlets; b) first and second reagent inlets, each including a uniquely tagged population of particles; c) a collection reservoir; d) a first sample channel in fluid communication with the first sample inlet and a second sample channel in fluid communication with the second sample inlet; e) a first reagent channel in fluid communication with the first reagent inlet and a second reagent channel in fluid communication with the second reagent inlet; and f) first and second droplet source regions. The first sample channel intersects with the first reagent channel at a first intersection, the second sample channel intersects with the second reagent channel at a second intersection, the first droplet source region is fluidically disposed between the first intersection and the collection reservoir, and the second droplet source region is fluidically disposed between the second intersection and the collection reservoir.

In some embodiments, the flow path further includes a) a third reagent inlet including a uniquely tagged population of particles; b) a third sample inlet; c) a third sample channel in fluid communication with the third sample inlet; d) a third reagent channel in fluid communication with the third reagent inlet; and e) a third droplet source region. The third sample channel intersects with the third reagent channel at a third intersection and the third droplet source region is fluidically disposed between the third intersection and the collection reservoir. In certain embodiments, the first, second, and/or third sample inlets and/or the first, second, and/or third reagent inlets are arranged substantially linearly, e.g., according to the spacing in a microtiter plate. In particular embodiments, the system may further include a plurality of flow paths, e.g., arranged according to rows or columns of a microtiter plate.

In another aspect, the invention provides a system for producing droplets. The system includes a device including a flow path including a) first and second sample inlets; b) a reagent inlet including a uniquely tagged population of particles; c) first and second collection reservoirs; d) a first sample channel in fluid communication with the first sample inlet and a second sample channel in fluid communication with the second sample inlet; e) first and second reagent channels in fluid communication with the reagent inlet; and f) first and second droplet source regions. The first sample channel intersects with the first reagent channel at a first intersection, the second sample channel intersects with the second reagent channel at a second intersection, the first droplet source region is fluidically disposed between the first intersection and the first collection reservoir, and the second droplet source region is fluidically disposed between the second intersection and the second collection reservoir.

In some embodiments, the flow path further includes a) a second reagent inlet including a uniquely tagged population of particles; b) third and fourth sample inlets; c) a third sample channel in fluid communication with the third sample inlet and a fourth sample channel in fluid communication with the fourth sample inlet; d) third and fourth reagent channels in fluid communication with the second reagent inlet; and e) third and fourth droplet source regions. The third sample channel intersects with the third reagent channel at a third intersection, the fourth sample channel intersects with the fourth reagent channel at a fourth intersection, the third droplet source region is fluidically disposed between the third intersection and the first collection reservoir, and the fourth droplet source region is fluidically disposed between the fourth intersection and the second collection reservoir.

In some embodiments, the flow path further includes a) a third reagent inlet including a uniquely tagged population of particles; b) fifth and sixth sample inlets; c) a fifth sample channel in fluid communication with the fifth sample inlet and a sixth sample channel in fluid communication with the sixth sample inlet; d) fifth and sixth reagent channels in fluid communication with the third reagent inlet; and e) fifth and sixth droplet source regions. The fifth sample channel intersects with the fifth reagent channel at a fifth intersection, the sixth sample channel intersects with the sixth reagent channel at a sixth intersection, the fifth droplet source region is fluidically disposed between the fifth intersection and the first collection reservoir, and the sixth droplet source region is fluidically disposed between the sixth intersection and the second collection reservoir.

In some embodiments, the flow path further includes a) a fourth reagent inlet including a uniquely tagged population of particles; b) seventh and eighth sample inlets; c) a seventh sample channel in fluid communication with the seventh sample inlet and an eighth sample channel in fluid communication with the eighth sample inlet; d) seventh and eighth reagent channels in fluid communication with the fourth reagent inlet; and e) seventh and eighth droplet source regions. The seventh sample channel intersects with the seventh reagent channel at a seventh intersection, the eighth sample channel intersects with the eighth reagent channel at an eighth intersection, the seventh droplet source region is fluidically disposed between the seventh intersection and the first collection reservoir, and the eighth droplet source region is fluidically disposed between the eighth intersection and the second collection reservoir.

In certain embodiments, the first, second, third, fourth, fifth sixth, seventh, and/or eighth sample inlets and/or the first, second, third, and/or fourth reagent inlets are arranged substantially linearly, e.g., according to the spacing in a microtiter plate. In some embodiments, the first and second reagent channels intersect and/or the third and fourth reagent channels intersect and/or the fifth and sixth reagent channels intersect and/or the seventh and eighth reagent channels intersect. In particular embodiments, the system may further include a plurality of flow paths, e.g., arranged according to rows or columns of a microtiter plate.

In another as aspect, the invention provides a method for producing droplets. The method includes a) providing a device including a flow path including i) first and second sample inlets; ii) a first reagent inlet including a first uniquely tagged population of particles in a first reagent liquid and a second reagent inlet including a second uniquely tagged population of particles in a second reagent liquid; iii) a collection reservoir; iv) a first sample channel in fluid communication with the first sample inlet and a second sample channel in fluid communication with the second sample inlet; v) a first reagent channel in fluid communication with the first reagent inlet and a second reagent channel in fluid communication with the second reagent inlet; and vi) first and second droplet source regions including a first continuous phase. The first sample channel intersects with the first reagent channel at a first intersection, the second sample channel intersects with the second reagent channel at a second intersection, the first droplet source region is fluidically disposed between the first intersection and the collection reservoir, and the second droplet source region is fluidically disposed between the second intersection and the collection reservoir. The method further includes b) allowing a first sample liquid to flow from the first sample inlet and a second sample liquid to flow from the second sample inlet via the first and second sample channels to the first and second intersections, and allowing the first reagent liquid to flow from first reagent inlet and the second reagent liquid to flow from the second reagent inlet via the first and second reagent channels to the first and second intersections. The first sample liquid and the first reagent liquid combine at the first intersection and the second sample liquid and the second reagent liquid combine at the second intersection and produce droplets in the first continuous phase at the first and second droplet source regions. Droplets from the first droplet source region include one or more particles from the first uniquely tagged population of particles and droplets from the second droplet source region include one or more particles from the second uniquely tagged population of particles.

In some embodiments of the method, the flow path further includes i) a third reagent inlet including a third uniquely tagged population of particles in a third reagent liquid; ii) a third sample inlet; iii) a third sample channel in fluid communication with the third sample inlet; iv) a third reagent channel in fluid communication with the third reagent inlet; and iv) a third droplet source region including the second liquid. The third sample channel intersects with the third reagent channel at a third intersection, the third droplet source region is fluidically disposed between the third intersection and the collection reservoir. Step b) may then further include allowing a third sample liquid to flow from the third sample inlet via the third sample channel to the third intersection, and allowing the third reagent liquid to flow from the third reagent inlet via the third reagent channel to the third intersection. The third sample liquid and the third reagent liquid combine at the third intersection and produce droplets in the first continuous phase at the third droplet source region. Droplets from the third droplet source region include one or more particles from the third uniquely tagged population of particles.

In certain embodiments of the method, the first, second, and/or third sample inlets and/or the first, second, and/or third reagent inlets are arranged substantially linearly, e.g., according to the spacing in a microtiter plate. In particular embodiments, the device may include a plurality of flow paths, e.g., arranged according to rows or columns of a microtiter plate.

Another aspect of the invention provides a method for producing droplets. The method includes a) providing a device including a flow path including i) first and second sample inlets; ii) a first reagent inlet including a first uniquely tagged population of particles in a first reagent liquid; iii) first and second collection reservoirs; iv) a first sample channel in fluid communication with the first sample inlet and a second sample channel in fluid communication with the second sample inlet; v) first and second reagent channels in fluid communication with the first reagent inlet; and vi) first source regions including a first continuous phase and a second droplet source region including a second continuous phase. The first sample channel intersects with the first reagent channel at a first intersection, the second sample channel intersects with the second reagent channel at a second intersection, the first droplet source region is fluidically disposed between the first intersection and the first collection reservoir, and the second droplet source region is fluidically disposed between the second intersection and the second collection reservoir. The method further includes b) allowing a first sample liquid to flow from the first sample inlet and a second sample liquid to flow from the second sample inlet via the first and second sample channels to the first and second intersections, and allowing the first reagent liquid to flow from the first reagent inlet via the first and second reagent channels to the first and second intersections. The first sample liquid and the first reagent liquid combine at the first intersection and produce droplets in the first continuous phase at the first droplet source region, and the second sample liquid and the first reagent liquid combine at the second intersection and produce droplets in the second continuous phase at the second droplet source region. Droplets from the first droplet source region include one or more particles from the first uniquely tagged population of particles and droplets from the second droplet source region include one or more particles from the first uniquely tagged population of particles.

In some embodiments of the method, the flow path further includes i) a second reagent inlet including a second uniquely tagged population of particles in a second reagent liquid; ii) third and fourth sample inlets; iii) a third sample channel in fluid communication with the third sample inlet and a fourth sample channel in fluid communication with the fourth sample inlet; iv) third and fourth reagent channels in fluid communication with the second reagent inlet; and v) a third droplet source region including the first continuous phase and a fourth droplet source region including the second continuous phase. The third sample channel intersects with the third reagent channel at a third intersection, the fourth sample channel intersects with the fourth reagent channel at a fourth intersection, the third droplet source region is fluidically disposed between the third intersection and the first collection reservoir, and the fourth droplet source region is fluidically disposed between the fourth intersection and the second collection reservoir. Step b) may then further include allowing a third sample liquid to flow from the third sample inlet and a fourth sample liquid to flow from the fourth sample inlet via the third and fourth sample channels to the third and fourth intersections, and allowing the second reagent liquid to flow from the second reagent inlet via the third and fourth reagent channels to the third and fourth intersections. The third sample liquid and the second reagent liquid combine at the third intersection and produce droplets in the first continuous phase at the third droplet source region, and the fourth sample liquid and the second reagent liquid combine at the fourth intersection and produce droplets in the second continuous phase at the fourth droplet source region. Droplets from the third droplet source region include one or more particles from the second uniquely tagged population of particles and droplets from the fourth droplet source region include one or more particles from the second uniquely tagged population of particles.

In some embodiments of the method, the flow path further includes i) a third reagent inlet including a third uniquely tagged population of particles in a third reagent liquid; ii) fifth and sixth sample inlets; iii) a fifth sample channel in fluid communication with the fifth sample inlet and a sixth sample channel in fluid communication with the sixth sample inlet; iv) fifth and sixth reagent channels in fluid communication with the third reagent inlet; and v) a fifth droplet source region including the first continuous phase and a sixth droplet source region including the second continuous phase. The fifth sample channel intersects with the fifth reagent channel at a fifth intersection, the sixth sample channel intersects with the sixth reagent channel at a sixth intersection, the fifth droplet source region is fluidically disposed between the fifth intersection and the first collection reservoir, and the sixth droplet source region is fluidically disposed between the sixth intersection and the second collection reservoir. Step b) may then further include allowing a fifth sample liquid to flow from the fifth sample inlet and a sixth sample liquid to flow from the sixth sample inlet via the fifth and sixth sample channels to the fifth and sixth intersections, and allowing the third reagent liquid to flow from the third reagent inlet via the fifth and sixth reagent channels to the fifth and sixth intersections. The fifth sample liquid and the third reagent liquid combine at the fifth intersection and produce droplets in the first continuous phase at the fifth droplet source region, and the sixth sample liquid and the third reagent liquid combine at the sixth intersection and produce droplets in the second continuous phase at the sixth droplet source region. Droplets from the fifth droplet source region include one or more particles from the third uniquely tagged population of particles and droplets from the sixth droplet source region include one or more particles from the third uniquely tagged population of particles.

In some embodiments, the flow path further includes i) a fourth reagent inlet including a fourth uniquely tagged population of particles in a fourth reagent liquid; ii) seventh and eighth sample inlets; iii) a seventh sample channel in fluid communication with the seventh sample inlet and an eighth sample channel in fluid communication with the eighth sample inlet; iv) seventh and eighth reagent channels in fluid communication with the fourth reagent inlet; and v) a seventh droplet source region including the first continuous phase and an eighth droplet source region including the second continuous phase. The seventh sample channel intersects with the seventh reagent channel at a seventh intersection, the eighth sample channel intersects with the eighth reagent channel at an eighth intersection, the seventh droplet source region is fluidically disposed between the seventh intersection and the first collection reservoir, and the eighth droplet source region is fluidically disposed between the eighth intersection and the second collection reservoir. Step b) may then further include allowing a seventh sample liquid to flow from the seventh sample inlet and an eighth sample liquid to flow from the eighth sample inlet via the seventh and eighth sample channels to the seventh and eighth intersections, and allowing the fourth reagent liquid to flow from the fourth reagent inlet via the seventh and eighth reagent channels to the seventh and eighth intersections. The seventh sample liquid and the fourth reagent liquid combine at the seventh intersection and produce droplets in the first continuous phase at the seventh droplet source region, and the eighth sample liquid and the fourth reagent liquid combine at the eighth intersection and produce droplets in the second continuous phase at the eighth droplet source region. Droplets from the seventh droplet source region include one or more particles from the fourth uniquely tagged population of particles and droplets from the eighth droplet source region include one or more particles from the fourth uniquely tagged population of particles.

In certain embodiments of the method, the first, second, third, fourth, fifth sixth, seventh, and/or eighth sample inlets and/or the first, second, third, and/or fourth reagent inlets are arranged substantially linearly, e.g., according to the spacing in a microtiter plate. In some embodiments, the first and second reagent channels intersect and/or the third and fourth reagent channels intersect and/or the fifth and sixth reagent channels intersect and/or the seventh and eighth reagent channels intersect. In particular embodiments, the device may include a plurality of flow paths, e.g., arranged according to rows or columns of a microtiter plate.

Another aspect of the invention provides a kit for producing droplets. The kit includes a) a device including a flow path including i) first and second sample inlets; ii) first and second reagent inlets; iii) a collection reservoir; iv) a first sample channel in fluid communication with the first sample inlet and a second sample channel in fluid communication with the second sample inlet; v) a first reagent channel in fluid communication with the first reagent inlet and a second reagent channel in fluid communication with the second reagent inlet; and vi) first and second droplet source regions. The first sample channel intersects with the first reagent channel at a first intersection, the second sample channel intersects with the second reagent channel at a second intersection, the first droplet source region is fluidically disposed between the first intersection and the collection reservoir, the second droplet source region is fluidically disposed between the second intersection and the collection reservoir. The kit further includes b) at least two uniquely tagged populations of particles, where each uniquely tagged population is configured to be placed in one reagent inlet.

In some embodiments, the flow path further includes i) a third reagent inlet; ii) a third sample inlet; iii) a third sample channel in fluid communication with the third sample inlet; iv) a third reagent channel in fluid communication with the third reagent inlet; and iv) a third droplet source region. The third sample channel intersects with the third reagent channel at a third intersection, the third droplet source region is fluidically disposed between the third intersection and the collection reservoir.

In certain embodiments of the kit, the first, second, and/or third sample inlets and/or the first, second, and/or third reagent inlets are arranged substantially linearly, e.g., according to the spacing in a microtiter plate. In particular embodiments, the device may include a plurality of flow paths, e.g., arranged according to rows or columns of a microtiter plate.

In another aspect, the invention provides a kit for producing droplets. The kit includes a) a device including a flow path including: i) first and second sample inlets; ii) a first reagent inlet; iii) first and second collection reservoirs; iv) a first sample channel in fluid communication with the first sample inlet and a second sample channel in fluid communication with the second sample inlet; v) first and second reagent channels in fluid communication with the first reagent inlet; and vi) first and second droplet source regions. The first sample channel intersects with the first reagent channel at a first intersection, the second sample channel intersects with the second reagent channel at a second intersection, the first droplet source region is fluidically disposed between the first intersection and the first collection reservoir, the second droplet source region is fluidically disposed between the second intersection and the second collection reservoir. The kit further includes b) a first uniquely tagged population of particles, where the first uniquely tagged population of particles is configured to be placed in the first reagent inlet.

In some embodiments, the flow path further includes i) a second reagent inlet; ii) third and fourth sample inlets; iii) a third sample channel in fluid communication with the third sample inlet and a fourth sample channel in fluid communication with the fourth sample inlet; iv) third and fourth reagent channels in fluid communication with the second reagent inlet; and v) third and fourth droplet source regions. The third sample channel intersects with the third reagent channel at a third intersection, the fourth sample channel intersects with the fourth reagent channel at a fourth intersection, the third droplet source region is fluidically disposed between the third intersection and the first collection reservoir, and the fourth droplet source region is fluidically disposed between the fourth intersection and the second collection reservoir. The kit may further include a second uniquely tagged population of particles, where the second uniquely tagged population of particles is configured to be placed in the second reagent inlet.

In some embodiments, the flow path further includes i) a third reagent inlet; ii) fifth and sixth sample inlets; iii) a fifth sample channel in fluid communication with the fifth sample inlet and a sixth sample channel in fluid communication with the sixth sample inlet; iv) fifth and sixth reagent channels in fluid communication with the third reagent inlet; and v) fifth and sixth droplet source regions. The fifth sample channel intersects with the fifth reagent channel at a fifth intersection, the sixth sample channel intersects with the sixth reagent channel at a sixth intersection, the fifth droplet source region is fluidically disposed between the fifth intersection and the first collection reservoir, and the sixth droplet source region is fluidically disposed between the sixth intersection and the second collection reservoir. The kit may further include a third uniquely tagged population of particles, where the third uniquely tagged population of particles is configured to be placed in the third reagent inlet.

In some embodiments, the flow path further includes i) a fourth reagent inlet; ii) seventh and eighth sample inlets; iii) a seventh sample channel in fluid communication with the seventh sample inlet and an eighth sample channel in fluid communication with the eighth sample inlet; iv) seventh and eighth reagent channels in fluid communication with the fourth reagent inlet; and v) seventh and eighth droplet source region. The seventh sample channel intersects with the seventh reagent channel at a seventh intersection, the eighth sample channel intersects with the eighth reagent channel at an eighth intersection, the seventh droplet source region is fluidically disposed between the seventh intersection and the first collection reservoir, and the eighth droplet source region is fluidically disposed between the eighth intersection and the second collection reservoir. The kit may further include a fourth uniquely tagged population of particles, where the fourth uniquely tagged population of particles is configured to be placed in the fourth reagent inlet.

In certain embodiments of the kit, the first, second, third, fourth, fifth sixth, seventh, and/or eighth sample inlets and/or the first, second, third, and/or fourth reagent inlets are arranged substantially linearly, e.g., according to the spacing in a microtiter plate. In some embodiments, the first and second reagent channels intersect and/or the third and fourth reagent channels intersect and/or the fifth and sixth reagent channels intersect and/or the seventh and eighth reagent channels intersect. In particular embodiments, the device may include a plurality of flow paths, e.g., arranged according to rows or columns of a microtiter plate.

In certain embodiments of any aspect described herein, sample channels and reagent channels do not intersect any other channel except as specifically described.

Devices may be multiplexed by including multiples of flow paths and/or various inlets and channels, e.g., arranged side by side, and as exemplified in the disclosure.

In any aspect described herein, adjacent inlets and channels may be in fluid communication with each other in certain embodiments. In particular, adjacent inlets or collection reservoirs may be connected by a trough (e.g., a single well) or by a connecting channel. Adjacent inlets that are otherwise not in fluidic communication may also be controllable by the same pressure outlet, as described herein.

The invention also provides methods of producing droplets using any of the devices or systems described herein.

It will be understood, that although channels, reservoirs, and inlets are labeled as “sample” and “reagent” herein, each channel, reservoir, and inlet may be for either a sample or a reagent during use. In certain embodiments, sample channels, sample reservoirs, and sample inlets may be used as reagent channels, reagent reservoirs, and reagent inlets. In certain embodiments, reagent channels, reagent reservoirs, and reagent inlets may be used as sample channels, sample reservoirs, and sample inlets.

In embodiments of any aspect described herein, two or more sample channels or reagent channels in fluid communication with the same sample or reagent inlet may have substantially equal lengths, e.g., to maintain substantially equal fluidic resistance. For example, one sample or reagent channel may be at least 85% of the length of another sample or reagent channel in fluid communication with the same sample or reagent inlet, e.g., at least 90, 95, or 99% or 100% of the length of the other channel, and no greater than 150% of the length of the other channel, e.g., at most 115, 110, 105, or 101%. Alternatively, two or more sample channels or reagent channels in fluid communication with the same sample or reagent inlet may have, substantially equal fluidic resistance. For example, one sample or reagent channel may have at least 85% of the fluidic resistance of another sample or reagent channel in fluid communication with the same sample or reagent inlet, e.g., at least 90, 95, or 99% or 100% of the fluidic resistance of the other channel, and no greater than 115% of the fluidic resistance of another sample or reagent channel in fluid communication with the same sample or reagent inlet, e.g., at most 110, 105, or 101% or 100% of the fluidic resistance of the other channel

It will be understood, that all devices, methods, and systems described herein may be adapted to be compatible with a multi well plate layout, by making the inlets and reservoirs appropriately sized and spaced to be in a linear sequence according to a row or column of a multi-well plate, and that a plurality of any one of, or a combination of, the flow paths described herein can be arranged according to the multi well plate layout.

It will be understood that all methods described herein may produce droplets including supports, e.g., particles, such as bead (e.g., gel beads) and/or biological particles, (e.g., cells, nuclei, or particulate components thereof). In any aspect of the invention the first and/or third liquids can be aqueous, and the second liquid can be an oil. In any aspect of the invention, the first and/or third liquids can include a sample (e.g., cells or nuclei) or particles. For example, either the first or third liquid can include cells or nuclei, and the other liquid can include particles (e.g., beads). Biological particles (e.g., cells or nuclei) and supports (e.g., particles) can be combined in a droplet at the droplet source regions in any fashion, e.g., 1:1, 1:2, 1:3, or in non-integer ratios as an average for a distribution of droplets. In some embodiments, the droplets include particles and cells (or nuclei) in a 1:1 ratio.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s),” “adapter(s),” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include: polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “support,” as used herein, generally refers to a particle that is not a biological particle. The support may be a solid or semi-solid particle. The support may be a bead, such as a gel bead. The gel bead may include a polymer matrix (e.g., matrix formed by polymerization or cross-linking). The polymer matrix may include one or more polymers (e.g., polymers having different functional groups or repeat units). Polymers in the polymer matrix may be randomly arranged, such as in random copolymers, and/or have ordered structures, such as in block copolymers. Cross-linking can be via covalent, ionic, or inductive, interactions, or physical entanglement. The bead may be a macromolecule. The bead may be formed of nucleic acid molecules bound together. The bead may be formed via covalent or non-covalent assembly of molecules (e.g., macromolecules), such as monomers or polymers. Such polymers or monomers may be natural or synthetic. Such polymers or monomers may be or include, for example, nucleic acid molecules (e.g., DNA or RNA). The bead may be formed of a polymeric material. The bead may be magnetic or non-magnetic. The bead may be rigid. The bead may be flexible and/or compressible. The bead may be disruptable or dissolvable. The bead may be a solid particle (e.g., a metal-based particle including but not limited to iron oxide, gold or silver) covered with a coating comprising one or more polymers. Such coating may be disruptable or dissolvable.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) comprising a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or another organelle of a cell. A cell may be a live cell. The live cell may be capable of being cultured, for example, being cultured when enclosed in a gel or polymer matrix or cultured when comprising a gel or polymer matrix.

The term “canted,” as used herein, refers to a surface that is at an angle of less than 90° in relation to the horizontal plane.

The term “disposed radially about,” as used herein, refers to the location of two elements in relation to each other with a third element as a reference, such that the angle between the two elements is at least 5.0° (e.g., at least 8°, at least 10°, at least 15°, at least 20°, at least 30°, at least 40°, at least 50°, at least 60°, at least 70°, at least 80°, at least 90°, at least 100°, at least 110°, at least 120°, at least 130°, at least 140°, at least 150°, at least 160°, at least 170°, or 180°). In some instances, an angle between the two or more elements is between about 5° and about 180° (e.g., between about 10° and about 40°, between about 30° and about 70°, between about 50° and about 90°, between about 70° and about 110°, between about 90° and about 130°, between about 110° and about 150°, between about 130° and about 170°, or between about 135° and about 180°). In some instance, the two or more elements are substantially in line, i.e., within 5° radially.

The term “flow path,” as used herein, refers to a path of channels and other structures for liquid flow from at least one inlet to at least one outlet. A flow path may include branches and may connect to adjacent flow paths, e.g., by a common inlet or a connecting channel.

The term “fluidically connected,” as used herein, refers to a direct connection between at least two device elements, e.g., a channel, reservoir, etc., that allows for fluid to move between such device elements without passing through an intervening element.

The term “fluidically disposed between,” as used herein, refers to the location of one element between two other elements so that fluid can flow through the three elements in one direction of flow.

The term “funnel,” as used herein, refers to a channel portion having an inlet and an outlet in fluid communication with the inlet, and at least one cross-sectional dimension (e.g., width) between the inlet and outlet that is greater than the corresponding cross-sectional dimension (e.g., width) of the outlet. Funnels of the invention may be conical or pear-shaped (e.g., having an in-plane longitudinal cross-section of an isosceles trapezoid or hexagon). Funnels of the invention may have, e.g., an in-plane longitudinal cross-section of a trapezoid (e.g., an isosceles trapezoid), in which the smaller of the two bases corresponds to the funnel outlet. Alternatively, funnels of the invention may have, e.g., an in-plane longitudinal cross-section of a hexagon (e.g., a hexagon corresponding to two trapezoids fused at the greater of their bases, where the smaller of their bases correspond to the funnel inlet and outlet). For example, the leg of one trapezoid may be longer (e.g., at least 50% longer, at least 100% longer, at least 200% longer, at least 300% longer, at least 400% longer, or at least 500% longer; e.g., 1000% longer or less) than the leg of the other trapezoid in a funnel having an in-plane longitudinal cross-section of a hexagon. The sides in the trapezoid(s) may be straight or curved. The vertices of the trapezoid(s) may be sharp or rounded. Preferably, a funnel has two cross-sectional dimensions (e.g., width and depth) between the inlet and outlet that are greater than each of the corresponding cross-sectional dimensions (e.g., width and depth) of the outlet. Preferably, within a funnel, the maximum funnel width and the maximum funnel depth are located at the same distance from the inlet. Preferably, the depth and/or width maxima are closer to the funnel inlet than to the funnel outlet. A funnel may be a rectifier or mini-rectifier. Rectifiers are funnels having a length (i.e., the distance from the inlet to the outlet) of at least 10 times (e.g., at least 20 times, or at least 25 times) the smaller of the funnel outlet width, funnel outlet depth, funnel inlet width, and funnel inlet depth. Typically, a rectifier has a length that is 1,500% to 4,000% (e.g., 1,500% to 3,000%, 2,000% to 3,000%, or 2,500% to 3,000%) of the smaller of the funnel outlet width, funnel outlet depth, funnel inlet width, and funnel inlet depth. Mini-rectifiers are funnels having a length (i.e., the distance from the inlet to the outlet) of 10 times or less of the smaller of the funnel outlet width, funnel outlet depth, funnel inlet width, and funnel inlet depth. Typically, a mini-rectifier has a length that is 500% to 1,000% of the smaller of the funnel outlet width, funnel outlet depth, funnel inlet width, and funnel inlet depth.

The term “genome,” as used herein, generally refers to genomic information from a subject, which may be, for example, at least a portion or an entirety of a subject's hereditary information. A genome can be encoded either in DNA or in RNA. A genome can comprise coding regions that code for proteins as well as non-coding regions. A genome can include the sequence of all chromosomes together in an organism. For example, the human genome has a total of 46 chromosomes. The sequence of all of these together may constitute a human genome.

The term “hurdle,” as used herein, refers to a partial blockage of a channel or funnel that maintains the fluid communication between sides of the channel or funnel surrounding the blockage. Non-limiting examples of hurdles are pegs, barriers, and their combinations. A peg, or a row of pegs, is a hurdle having a height, width, and length, where the height is the greatest of the dimensions. A peg may be, for example, cylindrical. A barrier is a hurdle having a height, width, and length, where the width or length is the greatest of the dimensions. A barrier may be, for example, trapezoidal. In some embodiments, a peg has the same height as the channel or funnel, in which the peg is disposed. In certain embodiments, a barrier has the same width as the channel or funnel, in which the barrier is disposed. In particular embodiments, a barrier has the same length as the funnel, in which the barrier is disposed.

The term “in fluid communication with,” as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may comprise a nucleic acid. In some cases, the biological particle may be a macromolecule. The macromolecular constituent may comprise DNA or a DNA molecule. The macromolecular constituent may comprise RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may comprise a protein. The macromolecular constituent may comprise a peptide. The macromolecular constituent may comprise a polypeptide or a protein. The polypeptide or protein may be an extracellular or an intracellular polypeptide or protein. The macromolecular constituent may also comprise a metabolite. These and other suitable macromolecular constituents (also referred to as analytes) will be appreciated by those skilled in the art (see U.S. Pat. Nos. 10,011,872 and 10,323,278, and PCT Publication No. WO/2019/157529, each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may comprise a nucleotide sequence. The molecular tag may comprise an oligonucleotide or polypeptide sequence. The molecular tag may comprise a DNA aptamer. The molecular tag may be or comprise a primer. The molecular tag may be or comprise a protein. The molecular tag may comprise a polypeptide. The molecular tag may be a barcode.

The term “oil,” as used herein, generally refers to a liquid that is not miscible with water. An oil may have a density higher or lower than water and/or a viscosity higher or lower than water.

The term “particulate component of a cell,” as used herein, refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exome, a liposome, an endoplasmic reticulum (e.g., rough or smooth), a ribosome, a Golgi apparatus, a chloroplast, an endocytic vesicle, an exocytic vesicle, a vacuole, a lysosome or a mitochondrion.

The term “pitch,” as used herein, refers to a linear dimension in the plane of channels in a device from the center of the shortest dimension of one flow path to the center of the shortest dimension of an adjacent flow path.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. The sample may be a liquid sample, such as a blood sample, urine sample, or saliva sample. The sample may be a skin sample. The sample may be a cheek swap. The sample may be a plasma or serum sample. The sample may include a biological particle, e.g., a cell, a nucleus, or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). As an alternative, sequencing may be performed using nucleic acid amplification, polymerase chain reaction (PCR) (e.g., digital PCR, quantitative PCR) or real time PCR), or isothermal amplification. Such systems may provide a plurality of raw genetic data corresponding to the genetic information of a subject (e.g., human), as generated by the system from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “side-channel,” as used herein, refers to a channel in fluid communication with, but not fluidically connected to, a droplet source region.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “substantially linearly” means that a single, straight line can be drawn through the elements. The term does not require that the elements are centered with respect to the line that can be drawn.

The term “substantially stationary,” as used herein with respect to droplet or particle formation, generally refers to a state when motion of formed droplets or particles in the continuous phase is passive, e.g., resulting from the difference in density between the dispersed phase and the continuous phase.

By a “trough connecting” or similar language refers to a single fluidic chamber, i.e., the trough, that is in fluidic communication with the elements being connected. Thus, a single volume of liquid in a trough is divided, not necessarily equally, among the elements the trough connects. Furthermore, a trough may be disposed to be controllable by one or more pressure sources.

The term “uniquely tagged population of particles” refers to a population of particles having a measurable identifier sufficient to distinguish that population from other populations of particles. For example, the uniquely tagged population of particles may include a barcode or label (such as a nucleotide sequence or a fluorescent dye) that is unique to the particles compared to other populations.

### BRIEF DESCRIPTION OF THE DRAWINGS

FIGS. 1A-1B show cross-section (FIG. 1A) and perspective (FIG. 1B) views an embodiment according to the invention of a microfluidic device with a geometric feature for droplet formation.

FIGS. 2A-2B show a cross-section view and a top view, respectively, of another example of a microfluidic device with a geometric feature for droplet formation.

FIGS. 3A-3B show a cross-section view and a top view, respectively, of another example of a microfluidic device with a geometric feature for droplet formation.

FIGS. 4A-4B show a cross-section view and a top view, respectively, of another example of a microfluidic device with a geometric feature for droplet formation.

FIGS. 5A-5B are views of another device of the invention. FIG. 5A is top view of a device of the invention with reservoirs. FIG. 5B is a micrograph of a first channel intersected by a second channel adjacent a droplet source region.

FIGS. 6A-6E are views of droplet source regions including shelf regions.

FIGS. 7A-7D are views of droplet source regions including shelf regions including additional channels to deliver continuous phase.

FIG. 8 is another device according to the invention having a pair of intersecting channels that lead to a droplet source region and collection reservoir.

FIG. 9 is a zoomed in view of an exemplary droplet source region.

FIGS. 10A-10B are views of an embodiment according to the invention. FIG. 10A is a top view of a device having two liquid channels that meet adjacent to a droplet source region. FIG. 10B is a zoomed in view of the droplet source region showing the individual droplet sources regions.

FIG. 11 illustrates the function of a combination of first channel 1100, first side-channel 1110, and second side-channel 1120. In this figure, particles 2330 propagate through channel 1100 in the direction of an arrow labeled “Mixed flow.” Prior to proximal intersections 1111 and 1121, spacing between consecutive particles is non-uniform. At the proximal intersections, excess first liquid L1 escapes into side-channels 1110 and 1120. The inlets of side-channels 1110 and 1120 are sized to substantially prevent ingress of particles from first channel 1100. The liquid that escapes into side-channels 1110 and 1120 rejoins first channel 1100 at distal intersections 1112 and 1122.

FIG. 12A illustrates the direction of the excess liquid flow from first channel 1200 into the side-channels at proximal intersections 1211 and 1221. In this figure, the side-channels have a depth sized to substantially prevent particle ingress from first channel 1200.

FIG. 12B illustrates the direction of the excess liquid flow from first channel 1200 into the side-channel at proximal intersection 1211. In this figure, the side-channel includes filter 1213 to substantially prevent particle ingress from first channel 1200.

FIG. 13A is an image showing the top view of an exemplary device of the invention. The device includes first channel 1300 having two funnels 1301, first reservoir 1302, first side-channel 1310 including first side-channel reservoir 1314, two second channels 1340 fluidically connected to second reservoir 1342, droplet source region 1350, and droplet collection region 1360. This device is adapted to control pressure in first channel 1300 through the use of first side-channel 1310. The inset shows an isometric view of the distal intersection 1312 with first-side channel 1310 having a first side-channel depth that is smaller than the first depth and a first side-channel width that is greater than the first width. Droplet collection region 1360 is in fluid communication with first reservoir 1302, first side-channel reservoir 1314, and second reservoir 1342. First channel 1300 has a depth of 60 μm, and first side-channel 1310 has a depth of 14 μm. This configuration may be used, e.g., with beads having a mean diameter of about 54 μm. In operation, beads flow with the first liquid L1 along first channel 1300, and excess first liquid L1 is removed through first side-channel 1310, and beads are sized to reduce or even substantially eliminate their ingress into first side-channel 1310.

FIG. 13B is an image showing a top view of an intersection between a first channel and a first side-channel in use. In this figure, the first liquid and beads flow along a first channel at a pressure of 0.8 psi, the first liquid pressure applied in the first side-channel is 0.5 psi. Accordingly, excess first liquid is removed from the space between consecutive beads, and these beads are then tightly packed in the first channel.

FIG. 13C is an image showing a top view of an intersection between a first channel and a first side-channel in use in a device having only one intersection between channel 1300 and side-channel 1310. In this figure, the first liquid and beads flow along a first channel. The pressure applied to reservoir 1302 is 0.8 psi, and the pressure applied to reservoir 1314 is 0.6 psi. The beads are tightly packed in the first channel upstream of the channel intersection. The first liquid added to the first channel from the first side-channel is evenly distributed between consecutive beads, thereby providing a stream of evenly spaced beads.

FIG. 13D is a chart showing the frequency at which beads flow through a fixed region in the chip (Bead Injection Frequency, or BIF) as a function of time, during normal chip operation. The measurement was carried out by video analysis of a fixed region of the first channel, after the intersection between the first channel and first side-channel.

FIG. 14A is an image showing the top view of an exemplary device of the invention. The device includes first channel 1400 having two funnels 1401 and two mini-rectifiers 1404, first reservoir 1402, second channel 1440 fluidically connected to second reservoir 1442, droplet source region 1450, and droplet collection region 1460. The proximal funnel width is substantially equal to the width of first reservoir 1402. Funnels 1401 and mini-rectifiers 1404 include pegs 1403 as hurdles. There are two rows of pegs 1403 in proximal funnel 1401 as hurdles. Droplet collection region 1460 is in fluid communication with first reservoir 1402 and second reservoir 1442. The spacing between pegs 1403 is 100 μm.

FIG. 14B is an image focused on the combination of proximal funnel 1401 and first reservoir 1402 in the device of FIG. 14A. Proximal funnel 1401 is fluidically connected to first reservoir 1402 and includes two rows of pegs 1403 as hurdles.

FIG. 14C is an image illustrating the depth changes in distal funnel 1401. Distal funnel 1401 has a depth and width increasing until a maximum width and depth are reached (i.e., the maximum depth is at the same location as the maximum width). In this drawing, the depth and width maxima are closer to the funnel inlet than to the funnel outlet.

FIG. 15A is an image showing the top view of an exemplary device of the invention. The device includes two first channels 1500, each first channel having two funnels 1501 and two mini-rectifiers 1504; first reservoir 1502; two second channels 1540 fluidically connected to the same second reservoir 1542; two droplet source regions 1550; and one droplet collection region 1560. The proximal funnel 1501 on the left includes one barrier 1505 as a hurdle. The proximal funnel 1501 on the right includes three rows of pegs 1503 as hurdles. Droplet collection region 1560 is in fluid communication with first reservoir 1502 and second reservoir 1542. Barrier 1505 has a height of 30 μm, and pegs 1503 are spaced at 100 μm intervals.

FIG. 15B is an image focused on the combination of two proximal funnels 1501 and first reservoir 1502. Proximal funnel 1501 on the left is fluidically connected to first reservoir 1502 and includes one barrier 1505 as a hurdle. Proximal funnel 1501 on the right is fluidically connected to first reservoir 1502 includes three rows of pegs 1503 as hurdles.

FIG. 16A is an image showing the top view of an exemplary device of the invention. The device includes two first channels 1600, each first channel having two funnels 1601 and two mini-rectifiers 1604; first reservoir 1602; two second channels 1640 fluidically connected to the same second reservoir 1642; two droplet source regions 1650; and one droplet collection region 1660. Proximal funnel 1601 on the left includes two rows of pegs 1603 as hurdles. Proximal funnel 1601 on the right includes three rows of pegs 1603 as hurdles. Droplet collection region 1660 is in fluid communication with first reservoir 1602 and second reservoir 1642. The spacing between pegs 1603 is 65 μm.

FIG. 16B is an image focused on the combination of proximal funnels 1601 and first reservoir 1602. Proximal funnel 1601 on the left is fluidically connected to first reservoir 1602 and includes two rows of pegs 1603 as hurdles. Proximal funnel 1601 on the right is fluidically connected to first reservoir 1602 and includes three rows of pegs 1603 as hurdles.

FIG. 17A is an image showing the top view of an exemplary device of the invention. The device includes two first channels 1700, each first channel having two funnels 1701 and two mini-rectifiers 1704; first reservoir 1702; two second channels 1740 fluidically connected to the same second reservoir 1742; two droplet source regions 1750; and one droplet collection region 1760. Proximal funnel 1701 on the left includes a barrier with two rows of pegs disposed on top of the barrier as hurdle 1706. Proximal funnel 1701 on the right includes a barrier with three rows of pegs disposed on top of the barrier as hurdle 1706. Droplet collection region 1760 is in fluid communication with first reservoir 1702 and second reservoir 1742. Each hurdle 1706 is a 30 μm-tall barrier with pegs spaced at 100 μm.

FIG. 17B is an image focused on the combination of proximal funnels 1701 and first reservoir 1702. Proximal funnel 1701 on the left is fluidically connected to first reservoir 1702 and includes a barrier with two rows of pegs disposed on top of the barrier as hurdle 1706. Proximal funnel 1701 on the right is fluidically connected to first reservoir 1702 includes a barrier with three rows of pegs disposed on top of the barrier as hurdle 1706.

FIG. 18A is an image showing the top view of an exemplary device of the invention. The device includes two first channels 1800, each first channel having two funnels 1801; first reservoir 1802; two second channels 1840 fluidically connected to the same second reservoir 1842; two droplet source regions 1850; and one droplet collection region 1860. Proximal funnel 1801 on the left includes two rows of pegs 1803 as hurdles. Pegs 1803 are spaced at 100 μm. Proximal funnel 1801 on the right includes a barrier with two rows of pegs disposed on top of the barrier as hurdle 1806. Hurdle 1806 is a 60 μm-tall barrier with pegs spaced at 65 μm. Distal funnel 1801 on the left is elongated having the length of 2 mm and an inlet sized 60 μm×60 μm. Droplet collection region 1860 is in fluid communication with first reservoir 1802 and second reservoir 1842.

FIG. 18B is an image focused on the combination of proximal funnels 1801 and first reservoir 1802. Proximal funnel 1801 on the left is fluidically connected to first reservoir 1802 and includes two rows of pegs 1803 as hurdles. Proximal funnel 1801 on the right is fluidically connected to first reservoir 1802 includes a barrier with two rows of pegs disposed on top of the barrier as hurdle 1806.

FIG. 19A is an image showing the top view of an exemplary device of the invention. The device includes two first channels 1900, each first channel having two funnels 1901, where first channel 1900 on the left includes two mini-rectifiers 1904, and first channel 1900 on the right does not; first reservoir 1902; two second channels 1940 fluidically connected to the same second reservoir 1942; two droplet source regions 1950; and one droplet collection region 1960. First channel 1900 on the left has dimensions of 65×60 μm, and first channel 1900 on the right has dimensions of 70×65 μm. Each proximal funnel 1901 includes a barrier with two rows of pegs 1903 as hurdles. Droplet collection region 1960 is in fluid communication with first reservoir 1902 and second reservoir 1942.

FIG. 19B is an image focused on the combination of proximal funnels 1901 and first reservoir 1902. Each proximal funnel 1901 on the left is fluidically connected to first reservoir 1902 and includes two rows of pegs 1903 as hurdles.

FIG. 20 illustrates an exemplary device of the invention. The device includes two first channels 2000, each first channel having two funnels 2001; first reservoir 2002; two second channels 2040 fluidically connected to the same second reservoir 2042; two droplet source regions 2050; and one droplet collection region 2060. First channel 2000 on the left has dimensions of 65×110 μm, and first channel 2000 on the right has dimensions of 60×55 μm. Each proximal funnel 2001 includes two rows of pegs 2003 as hurdles. Droplet collection region 2060 is in fluid communication with first reservoir 2002 and second reservoir 2042.

FIG. 21A is an image showing the top view of an exemplary device of the invention. The device includes first channel 3300 having two funnels 3301, first reservoir 3302, second channel 3340 fluidically connected to second reservoir 3342, droplet source region 3350, and droplet collection region 3360. First channel 3300 on the left has dimensions of 55×50 μm, and first channel 3300 on the right has dimensions of 50×50 μm.

Proximal funnel 3301 includes two rows of pegs 3303 as hurdles. Droplet collection region 3360 is in fluid communication with first reservoir 3302 and second reservoir 3342.

FIG. 21B, FIG. 21C, and FIG. 21D focus on droplet source region 2150 and intersection between first channel 2100 and second channel 2140. In these figures, first channel 2100 includes channel portion 2107 where first depth is reduced in proximal-to-distal direction, second channel 2140 includes a channel portion 2147 where second depth is reduced in proximal-to-distal direction.

FIG. 22A is a brightfield image showing droplet generation in a device lacking a mixer. The brightfield image shows a portion of the device in use, the device including an intersection between first channel 2200 and second channel 2240; droplet source region 2250; first, second, and third liquids; beads 2230; and forming droplet 2251 including bead 2230 and a combination of the first and third liquids. Interface 2209 is between the first and third liquids, and interface 2252 is between the second liquid and the combination of first and third liquids. In this device, first and third liquids are combined at an intersection of first channel 2200 and second channel 2240. The first liquid carries beads 2230. Forming droplet 2251 is surrounded by the second liquid. The first and third liquids are miscible, and the second liquid is not miscible with the first and third liquids.

FIG. 22B is a fluorescent image showing droplet generation in the same device as that which is shown in FIG. 22A. The fluorescent image shows a portion of the device in use with a focus on the combination of first and third liquid at an intersection between first channel 2200 and second channel 2240. Interface 2209 between the first liquid (dark) and second liquid (light) extends from the channel intersection through droplet source region 2250 into forming droplet 2251. The presence of interface 2209 in forming droplet 2251 indicates that the first liquid (dark) and the third liquid (light) are not homogeneously mixed at the channel intersection.

FIG. 23 is an image showing the top view of an exemplary device of the invention. The device includes first channel 2300 fluidically connected to first reservoir 2302, second channel 2340 including mixer 2380 and fluidically connected to second reservoir 2342, third channel 2370 fluidically connected to third reservoir 2372, droplet source region 2350, and droplet collection region 2360. Third channel 2370 intersects second channel 2340, the distal end of which is fluidically connected to first channel 2300. Droplet collection region 2360 is in fluid communication with first reservoir 2302, second reservoir 2342, and third reservoir 2372.

FIG. 24A is an image showing the top view of an exemplary device of the invention. The device includes first channel 2400 fluidically connected to first reservoir 2402, first side channel 2410 including mixer 2480, second channel 2440 fluidically connected to second reservoir 2442 and to first side-channel 2410, droplet source region 2450, and droplet collection region 2460. Droplet collection region 2460 is in fluid communication with first reservoir 2402 and second reservoir 2442.

FIG. 24B focuses on a portion of the device of FIG. 24A in use. A mixture of first liquid L1 and beads 2430 is carried through first channel 2400 in the proximal-to-distal direction. Excess first liquid L1 is diverted from first channel 2400 at intersection 2411 into first side-channel 2410. Excess L1 is then combined with L3 at the intersection of first side-channel 2410 and second channel 2440. The combination of first liquid L1 and third liquid L3 then enters mixer 2480 and, after mixing, is combined with beads 2430/first liquid L1 at intersection 2412. As shown in FIG. 24B, beads 2430 are unevenly spaced in the proximal portion of first channel 2400 before intersection 2411. Between intersections 2411 and 2412 beads 2430 are tightly packed in first channel 2400. After intersection 2412, beads 2430 are substantially evenly spaced.

FIG. 25 is an image showing a top view of an exemplary device of the invention. The device includes first channel 2500 fluidically connected to first reservoir 2502. First channel 2500 includes funnel 2501 disposed at its proximal end. Funnel 2501 at the proximal end of first channel 2500 includes pegs 2503. The device includes droplet collection region 2560 fluidically connected to droplet source region 2550. The device also includes second reservoir 2542 fluidically connected to second channel 2540 that includes funnel 2543 at its proximal end. Second channel 2540 intersect channel 2500 between the first distal end and funnel 2508.

FIG. 26A is a top view of an exemplary funnel that may be included, e.g., at the proximal end of a first channel. The funnel includes two rows of pegs as hurdles closer to the funnel inlet and a single row of pegs (in this instance, a single peg) closer to the funnel outlet.

FIG. 26B is a perspective view of an exemplary funnel shown in FIG. 26A.

FIG. 26C is a top view of an exemplary funnel that may be included, e.g., at the proximal end of a first channel. The funnel includes a barrier with one row of pegs disposed on top of the barrier as hurdle.

FIG. 26D is a perspective view of an exemplary funnel shown in FIG. 26C.

FIG. 27A is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 27B is a perspective view of an exemplary funnel shown in FIG. 27A.

FIG. 27C is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 27D is a perspective view of an exemplary funnel shown in FIG. 27C.

FIG. 28A is a top view of an exemplary funnel that may be included, e.g., at the proximal end of a second channel. The funnel includes a barrier with one row of pegs disposed along a curve on top of the barrier as hurdle.

FIG. 28B is a perspective view of an exemplary funnel shown in FIG. 28A.

FIG. 28C is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 28D is a perspective view of an exemplary funnel shown in FIG. 28C.

FIG. 28E is a top view of an exemplary funnel that may be included, e.g., at the proximal end of a first channel. The funnel includes a barrier with one row of pegs disposed along a curve. The pegs have a peg length that is greater than the peg width. The funnel also includes a ramp.

FIG. 28F is a perspective view of an exemplary funnel shown in FIG. 28E

FIG. 29A is a top view of an exemplary series of traps. In this figure, channel 2900 includes two traps 2907. The solid-fill arrow indicates the liquid flow direction through the channel including a series of traps.

FIG. 29B is a side view cross section of a channel including a trap. The trap has a length (L) and depth (h). In operation, air bubbles that might be carried with a liquid can be lifted by the air buoyancy and thus removed from the liquid flow.

FIG. 29C is a side view cross section of a channel including a trap. The trap has a length (L) and depth (h+50). In operation, air bubbles that might be carried with a liquid can be lifted by the air buoyancy and thus removed from the liquid flow.

FIG. 30A is a top view of an exemplary herringbone mixer. This herringbone mixer may be used to provide a single mix cycle in a channel. The herringbone mixer includes and grooves extending transversely across the channel. In this drawing, um stands for microns.

FIG. 30B is a side view cross section of an exemplary herringbone mixer portion shown in FIG. 30A. In this drawing, um stands for microns.

FIG. 30C is a top view of an exemplary herringbone mixer including twenty mix cycles assembled from herringbone mixers shown in FIG. 30A.

FIG. 31A is a side view cross section of a collection reservoir.

FIG. 31B is a side view cross section of a collection reservoir including a canted sidewall.

FIGS. 32A-32C are side view cross sections of exemplary collection reservoir including canted sidewalls.

FIG. 33 is a schematic drawing showing droplets produced at a generation point and moving into a single channel.

FIGS. 34A-34D are schematic drawings of an embodiment of a device of the disclosure for reentrainment of buoyant droplets or particles. FIG. 34A shows an emulsion layer (6101) at the top of a partitioning oil (6102) within a droplet collection reservoir. FIG. 34B shows a drawing of a spacing liquid (e.g., mineral oil) added to the top of the collection reservoir. FIG. 34C shows the emulsion layer reentrainment into a reentrainment channel. FIG. 34D is a close-up view of droplets in a reentrainment channel including an oil flow to meter droplets and dilute concentrated droplets prior to detection.

FIG. 35 is a depiction of side view cross sections of exemplary collection reservoirs including canted sidewalls, an oblique circular cone shape, and a circular cone that tapers to a slot.

FIG. 36 is a depiction of side view cross sections of exemplary collection reservoir including canted sidewalls and slots, and slots with protrusions.

FIG. 37 is a depiction of side view cross sections of exemplary collection reservoirs or sample inlets.

FIG. 38 is a depiction of side view cross sections of exemplary collection reservoirs or sample inlets.

FIGS. 39A-39C are schematic drawings showing multiplexed flow paths with different inlet/reservoir designs. The flow paths in FIG. 39A have two rectifiers per reagent channel. The flow paths in FIGS. 39B-39C have one rectifier per reagent channel, e.g., adjacent the intersections. FIG. 39B also shows an example of a reservoir with a saddle and an exemplary droplet source region, e.g., for use with the flow path of FIG. 39B.

FIGS. 40A-40B are schematic drawings showing three multiplexed flow paths with different inlet/reservoir designs.

FIG. 41 is a schematic drawing showing a multiplexed flow path with eight droplet source regions.

FIG. 42 is a schematic drawing showing a multiplexed flow path with twelve droplet source regions.

FIGS. 43A-43D are schematic drawings showing different sample and/or reagent inlets layouts.

FIG. 44 is a schematic drawing showing a saddle between two inlets under which two channels run.

FIG. 45 is a schematic drawing showing core pins that can be used to produce inlets and the inlet shapes formed.

FIG. 46 is a graph of bead fill ratio in droplets and bead flow rate variability for low quality beads in single and double rectifier channel designs.

FIG. 47 is a schematic drawing showing a multiplexed device featuring a partitioning wall in the collection reservoirs.

FIGS. 48A and 48B are schematic drawings showing top and side views of inserts for partitioning a reservoir.

FIG. 49 is a schematic drawing showing core pins for making a collection reservoir with a partitioning wall.

FIG. 50 is a schematic drawing showing side and top views of a partitioning wall.

FIG. 51 is a schematic drawing showing inserts for priming.

FIG. 52 is a schematic drawing showing inserts for priming.

FIG. 53 is a schematic drawing showing a multiplexed flow path for high sample throughput.

FIG. 54 is a schematic drawing showing a multiplexed flow path for high sample throughput.

FIG. 55 is a schematic drawing showing the layout of collection reservoirs, sample inlets, and reagent inlets for a plurality of multiplexed flow paths for high sample throughput.

FIG. 56 is a schematic drawing showing the layout of collection reservoirs, sample inlets, and reagent inlets for a plurality of multiplexed flow paths for high sample throughput.

### DETAILED DESCRIPTION

The invention provides devices, systems, and methods for efficiently producing and collecting droplets. For example, devices and methods of the invention may be beneficial for production and collection of large numbers of droplets in a confined area or space.

In multiplex droplet formation in a single plane microfluidic device, it is a challenge to maximize the number of droplet source regions where space is limited and channels cannot cross, except where liquids are to be combined. Allowing one or more channels to run between closely spaced inlets, that optionally share a fluid source (such as a well or reservoir), allows more channels to be used in the device, and thus more droplet source regions to be present. Channels may be sample, reagent channels, or side channels, or may serve another purpose. Sample channels may correspond to first, second, and/or third, etc., channels as described herein. Reagent channels may correspond to first, second, and/or third, etc., channels as described herein. Side channels may correspond to first, second, and/or third, etc., channels as described herein. In some embodiments, one or more inlets of the invention may have a cross sectional dimension of at least about 0.5 mm, e.g., about 0.5-5 mm, such as about 1-2 mm (e.g., about 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.8 mm, 1.9 mm, 2.0 mm, 2.5 mm, 3.0 mm, 3.5 mm, 4.0 mm, 4.5 mm, or 5.0 mm. In some embodiments, the adjacent inlets may be connected by a trough, e.g., a reservoir shared by two or more inlets. Multiplex devices of the invention may reduce sedimentation of biological particles (e.g., cells or nuclei), e.g., by allowing volumetric flow rates that disfavor sedimentation.

The invention also provides a method for producing combined populations of droplets from different samples in a common volume, e.g., an outlet or reservoir. Such an arrangement can simplify microfluidic workflows by allowing the simultaneous analysis of multiple samples, where the results are traceable to the sample. The method includes creating droplets from two or more uniquely tagged populations of particles and then combining the droplets formed in the volume. For a given combination, each uniquely tagged population of particles is used to form droplets with a single sample, e.g., droplets may include a single cell, a nucleus, or a cell bead (or other component) from the sample and a single particle from the population. A reaction occurs in the droplet, a product of which is traceable to the source uniquely tagged population. Thus, droplets from multiple samples may be combined for analysis, where the analysis includes identifying a unique tag, e.g., barcode or fluorescent label, from the particles. The method may employ multiple volumes, e.g., outlets or reservoirs. In such embodiments, each uniquely tagged population of particles may be used to form droplets with the same number of samples as the number of volumes for combination, e.g., reservoirs. In this embodiment, the identity of the sample can be determined based on the unique tag and the volume in which the droplets were formed. In some embodiments, the number of samples is between 2 and 384, e.g., 10-96 samples, with the number of uniquely tagged populations of particles dependent on the number volumes for combination.

In certain commercial devices, efficient droplet collection requires that the device be tilted at an angle, e.g., a 45° angle, to increase recovery by a collection device, limiting throughput. Collection reservoirs including canted sidewalls, e.g., sidewalls canted at an angle between 89.5° and 4°, e.g., between 85° and 5°, may be beneficial for increasing throughput by removing the necessity of tilting the device for droplet recovery and increasing droplet recovery by a collection device, e.g., a pipette tip. Collection reservoirs may also include dividing walls, i.e., partitioning walls. In some instances, the dividing wall is molded in the reservoirs. In some instances, the dividing wall forms part of an insert that is placed in the reservoir, either reversibly or irreversibly. Collection reservoir dividing walls can fluidically separate droplet source regions which share a collection reservoir, thereby preventing failures from one droplet source region from impacting droplets formed in functional droplet source regions.

In addition, devices having multiplexed formats, e.g., those having multiple flow paths and/or multiple droplet source regions, may be used to increase the rate of droplet production. The use of troughs to connect multiple inlets or collection reservoirs also provides advantages in terms of ease of loading or unloading, ease of controlling flow in parallel flow paths, e.g., by ensuring that all sample is consumed prior to ending use of the device, and the ability to process in multiple flow paths when one path becomes clogged or inoperative. A trough may connect at least two adjacent inlets or collection reservoirs, e.g., 3, 4, 5, 6, 7, 8, 9, 10, 11, 12, 13, 14, 15, or 16 inlets or collection reservoirs.

The devices, kits, systems, and methods of the invention may provide droplets with reduced droplet-to-droplet content variation and/or with improved droplet content uniformity. For example, the devices, systems, and methods of the invention may provide droplets having a single particle per droplet. This effect may be achieved through the use of one or more side-channels. Without wishing to be bound by theory, a side-channel may be used to take away excess liquid separating consecutive particles, thereby reducing the number of droplets lacking particles. Alternatively, a side-channel may be used to add liquid between consecutive particles to reduce the “bunching” effect, thereby reducing the number of droplets containing multiple particles of the same kind per droplet. The devices, kits, systems, and methods of the invention may provide a plurality of droplets, in which majority of droplets are occupied by no more than one particle of the same type. In some cases, fewer than 25% of the occupied droplets contain more than one particle of the same type, and in many cases, fewer than 20% of the occupied droplets have more than one particle of the same type. In some cases, fewer than 10% or even fewer than 5% of the occupied droplets include more than one particle of the same type. In some cases, the devices, kits, systems, and methods of the invention may provide a plurality of droplets, in which majority of droplets are occupied by no more than one particle of one type (e.g., a bead) and one particle of another type (e.g., a biological particle).

It may also be desirable to avoid the creation of excessive numbers of empty droplets, for example, from a cost perspective and/or efficiency perspective. However, while this may be accomplished by providing sufficient numbers of beads into the droplet source region, the Poissonian distribution may expectedly increase the number of droplets that may include multiple particles of the same type. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles and/or liquids directed into the droplet source region can be conducted such that, in many cases, no more than about 50% of the generated droplets, no more than about 25% of the generated droplets, or no more than about 10% of the generated droplets are unoccupied. These flows can be controlled, as described herein, so as to present non-Poissonian distribution of singly occupied droplets while providing lower levels of unoccupied droplets. The above noted ranges of unoccupied droplets can be achieved while still providing any of the single occupancy rates described above. For example, in many cases, the devices, kits, systems, and methods of the invention produce droplets that have multiple occupancy rates of the same type of less than about 25%, less than about 20%, less than about 15%, less than about 10%, and, in many cases, less than about 5%, while having unoccupied droplets of less than about 50%, less than about 40%, less than about 30%, less than about 20%, less than about 10%, less than about 5%, or less.

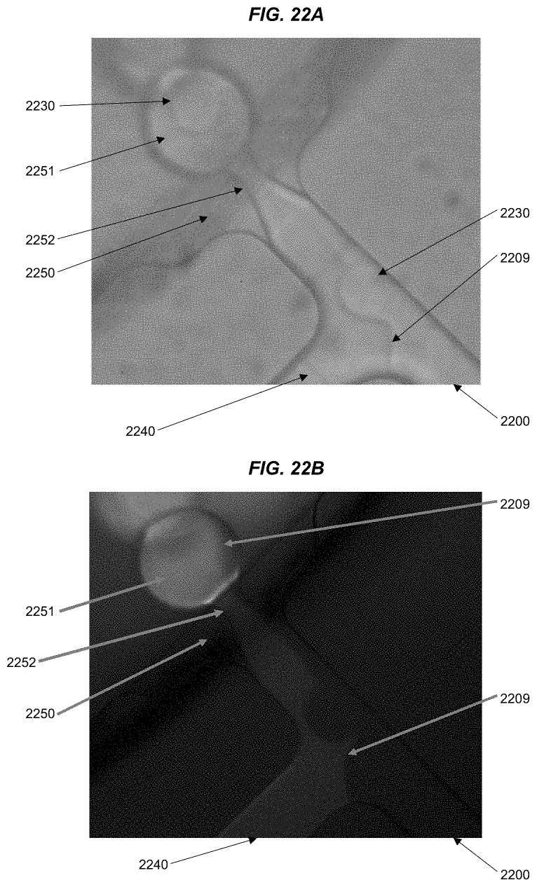

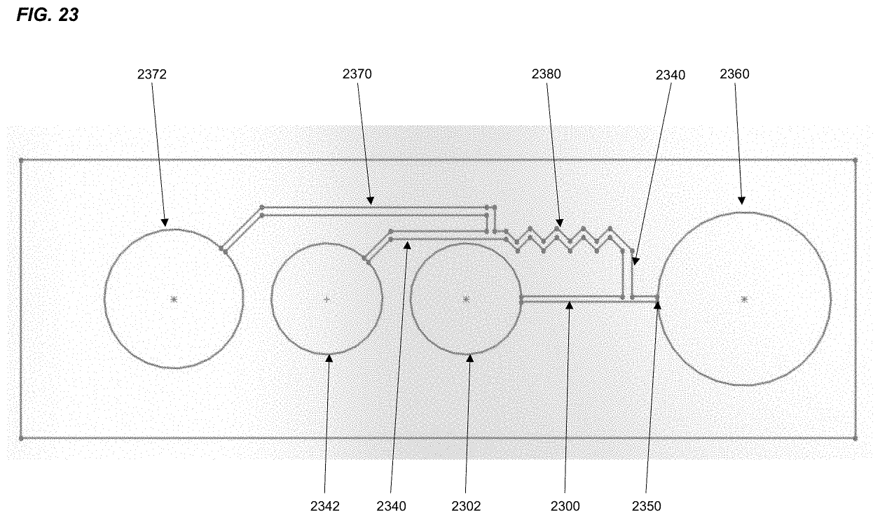

The devices, kits, systems, and methods of the invention may provide droplets having substantially uniform distribution of dissolved ingredients (e.g., lysing reagents). In applications requiring controlled cell lysis, the devices, systems, and methods of the invention may also be used to reduce premature cell lysis (e.g., to reduce the extent of cell lysis in channels). For example, non-uniform distribution of dissolved ingredients is illustrated in FIGS. 22A and 22B. In these figures, a combined stream of two partially unmixed liquids is formed by combining two liquids at a channel intersection. Without wishing to be bound by theory, the devices, kits, systems, and methods of the invention that include a mixer (e.g., a passive mixer) may pre-mix liquids (e.g., a third liquid and a fourth liquid or a third liquid and a first liquid) prior to the droplet source, thereby reducing localized high concentrations of dissolved ingredients (e.g., lysing reagents), which may cause premature cell lysis.

Additionally or alternatively, inclusion of funnels in sample channels (e.g., second channels) may improve distribution uniformity by reducing the amount of debris entering the sample channel from the sample. In particular, this reduction in the amount of debris may reduce pressure fluctuations at a channel intersection, thereby improving the consistency in the mix ratio between liquids at the channel intersection. Thus, inclusion of funnels in sample channels may reduce the droplet-to-droplet content variation.

Additionally or alternatively, inclusion of traps in channels (e.g., reagent channel, sample channel, etc.) may improve uniformity by reducing the pressure fluctuations at a channel intersection by removing air bubbles from the liquid flow. Further, particle spacing uniformity may also be improved by removing air bubbles from the liquid flow. Thus, inclusion of traps in channels may reduce the droplet-to-droplet content variation.

The devices, kits, systems, and methods of the invention may be used to form droplets of a size suitable for utilization as microscale chemical reactors, e.g., for genetic sequencing. In general, droplets are formed in a device by flowing a first liquid through a channel and into a droplet source region including a second liquid, i.e., the continuous phase, which may or may not be externally driven. Thus, droplets can be formed without the need for externally driving the second liquid. Exemplary fluidic configurations for generating droplets are described herein and shown in the devices of Examples 1-10.

Additionally, devices, kits, systems, and methods of the invention may allow for control over the size of the droplets with lower sensitivity to changes in liquid properties. For example, the size of the generated droplets is less sensitive to the dispersed phase flow rate. Adding multiple source regions is also significantly easier from a layout and manufacturing standpoint. The addition of further source regions allows for formation of droplets even in the event that one droplet source region becomes blocked. Droplet formation can be controlled by adjusting one or more geometric features of fluidic channel architecture, such as a width, depth, and/or expansion angle of one or more fluidic channels. For example, droplet size and speed of droplet formation may be controlled. In some instances, the number of droplet sources at a driven pressure can be increased to increase the throughput of droplet formation.

Devices and Systems

A device or system of the invention include channels having a depth, a width, a proximal end, and a distal end. The proximal end is or is configured to be in fluid communication with a source of liquid, e.g., a reservoir integral to the device or coupled to the device, e.g., by tubing. The distal end is in fluid communication with, e.g., fluidically connected to, a droplet source region.

In general, the components of a device or system, e.g., channels, may have certain geometric features that at least partly determine the sizes and/or content of the droplets. For example, any of the channels described herein have a depth (a height), h₀, and width, w. The droplet source region may have an expansion angle, α. Droplet size may decrease with increasing expansion angle. The resulting droplet radius, R_{d}, may be predicted by the following equation for the aforementioned geometric parameters of h₀, w, and α:

$${R}_{d} \approx 0.44 ( 1 + 2.2 \sqrt{tan α} \frac{w}{{h}_{0}} ) \frac{{h}_{0}}{\sqrt{tan α}}$$

As a non-limiting example, for a channel with w=21 μm, h=21 μm, and α=3°, the predicted droplet size is 121 μm. In another example, for a channel with w=25 μm, h=25 μm, and α=5°, the predicted droplet size is 123 μm. In yet another example, for a channel with w=28 μm, h=28 μm, and α=7°, the predicted droplet size is 124 μm. In some instances, the expansion angle may be between a range of from about 0.5° to about 4°, from about 0.1° to about 10°, or from about 0° to about 90°. For example, the expansion angle can be at least about 0.01°, 0.1°, 0.2°, 0.3°, 0.4°, 0.5°, 0.6°, 0.7°, 0.8°, 0.9°, 1, 2°, 3°, 4°, 5°, 6°, 7°, 8°, 9°, 10°, 15°, 20°, 25°, 30°, 35°, 40°, 45°, 50°, 55°, 60°, 65°, 70°, 75°, 80°, 85°, or higher. In some instances, the expansion angle can be at most about 89°, 88°, 87°, 86°, 85°, 84°, 83°, 82°, 81°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, 0.1°, 0.01°, or less.

The depth and width of the channel may be the same, or one may be larger than the other, e.g., the width is larger than the depth, or depth is larger than the width. In some embodiments, the depth and/or width is between about 0.1 μm and 1000 μm. In some embodiments, the depth and/or width of the channel is from 1 to 750 μm, 1 to 500 μm, 1 to 250 μm, 1 to 100 μm, 1 to 50 μm, or 3 to 40 μm. In certain embodiments, the depth and/or width of the channel is 10 μm to 100 μm. In some cases, when the width and length differ, the ratio of the width to depth is, e.g., from 0.1 to 10, e.g., 0.5 to 2 or greater than 3, such as 3 to 10, 3 to 7, or 3 to 5. The width and depths of the first channel may or may not be constant over its length. In particular, the width may increase or decrease adjacent the distal end. In general, channels may be of any suitable cross section, such as a rectangular, triangular, or circular, or a combination thereof. In particular embodiments, a channel may include a groove along the bottom surface. The width or depth of the channel may also increase or decrease, e.g., in discrete portions, to alter the rate of flow of liquid or particles or the alignment of particles.

Devices and systems of the invention may include additional channels that intersect the first channel between its proximal and distal ends, e.g., one or more side-channels (e.g., a first side-channel and optionally a second side-channel) and/or one or more additional channel (e.g., a second channel).

Funnels and/or side-channels may be used to control particle (e.g., bead) flow, e.g., to provide evenly spaced particles (e.g., beads).

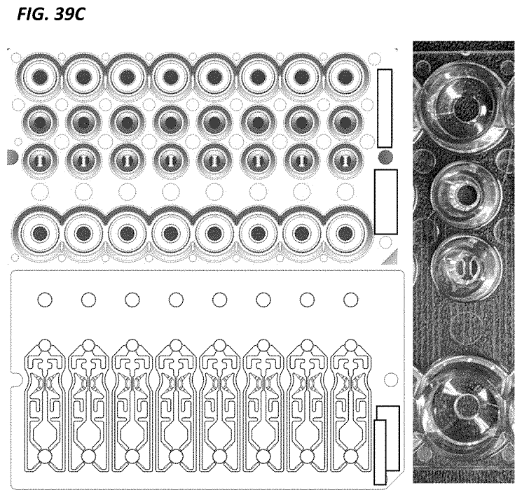

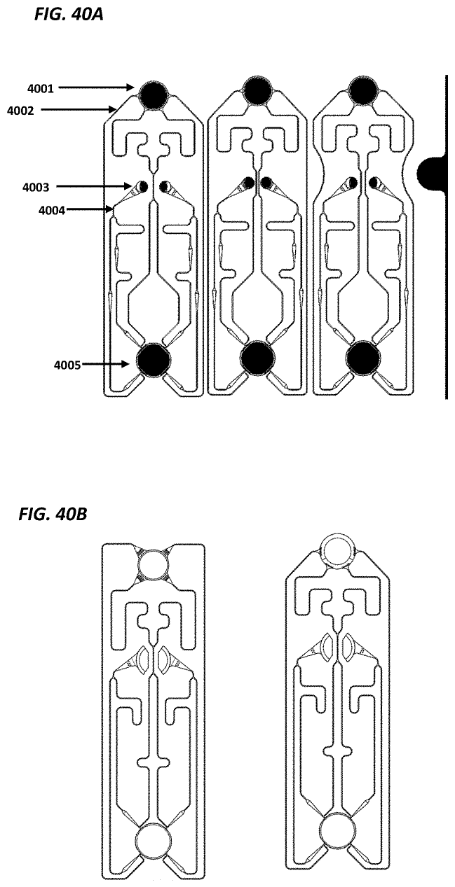

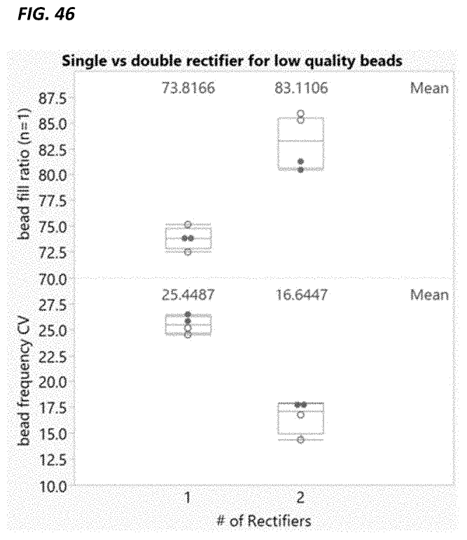

In some cases, a particle channel (e.g., a reagent channel) may include one or more funnels, each funnel having a funnel proximal end, a funnel distal end, a funnel width, and a funnel depth, and each funnel proximal end has a funnel inlet, and each funnel distal end has a funnel outlet. In some cases, the particle channel (e.g., a reagent channel) includes 1 to 5 (e.g., 1 to 4, 1 to 3, 1 to 2, or 1) funnel(s). For example, the particle channel (e.g., a reagent channel) may include 1, 2, 3, 4, or 5 funnel(s). In some cases, at least one funnel is a mini-rectifier. In some cases, at least one funnel is a rectifier. For example, the particle channel (e.g., a reagent channel) may include 1, 2, or 3 rectifiers and 1, 2, or 3 mini-rectifiers. In some cases, a reagent channel may include a funnel (e.g., a rectifier) between a reagent reservoir or inlet and the proximal channel intersection (e.g., a proximal intersection of a reagent channel and a side-channel, or an intersection of a sample channel and a reagent channel). In some cases, a reagent channel may include a funnel (e.g., a rectifier) in its proximal portion, e.g., the funnel (e.g., the rectifier) inlet may be fluidically connected to a reagent inlet. In some cases, reagent channel may include a funnel (e.g., a rectifier) in its distal portion, e.g., the funnel (e.g., the rectifier) outlet may be fluidically connected to the distal channel intersection (e.g., a distal intersection of the reagent channel and the side-channel, or an intersection of a sample channel and a reagent channel). In some cases, a funnel (e.g., a rectifier) in a reagent channel may be towards the distal end of the channel, e.g., adjacent the intersection. In some cases, the first channel may include one or more (e.g., 1, 2, or 3) funnels (e.g., mini-rectifiers) in its middle portion, e.g., between a distal funnel inlet and a proximal funnel outlet or a proximal intersection of the first channel and the first side-channel. Rectifiers may allow for more even spacing of supports, e.g., gel beads, during droplet formation. Rectifiers may include an expansion in width relative to the inlet and a subsequent narrowing towards the outlet. Advantageously, a reagent channel may include two rectifiers, a first rectifier at the distal end of the reagent channel, e.g., fluidically connected to an intersection with a sample channel, and the second between the proximal end of the reagent channel and the first rectifier. In some embodiments, the second rectifier may be positioned equidistantly between the proximal and distal ends of the reagent channel. The use of two rectifiers in a reagent channel can reduce errors caused by tethered particles in the reagent flow and increase the fill ratio of beads in droplets (see, e.g., FIG. 46). In other embodiments, a single rectifier is employed in each reagent channel (see, e.g., FIG. 39B).

In some cases, a sample channel may include one or more funnels, each funnel having a funnel proximal end, a funnel distal end, a funnel width, and a funnel depth, and each funnel proximal end has a funnel inlet, and each funnel distal end has a funnel outlet. In some cases, the sample channel includes 1 to 5 (e.g., 1 to 4, 1 to 3, 1 to 2, or 1) funnel(s). For example, the sample channel may include 1, 2, 3, 4, or 5 funnel(s). In some cases, at least one funnel is a mini-rectifier. In some cases, at least one funnel is a rectifier. For example, the sample channel may include 1, 2, or 3 rectifiers and 1, 2, or 3 mini-rectifiers. In some cases, the sample channel may include a funnel (e.g., a rectifier) between the sample inlet and a channel intersection (e.g., an intersection of a reagent channel and a sample channel or an intersection of a sample channel and a side-channel). In some cases, the sample channel may include a funnel (e.g., a rectifier) in its proximal portion, e.g., the funnel (e.g., the rectifier) inlet may be fluidically connected to a sample inlet. In some cases, the sample channel may include a funnel (e.g., a rectifier) in its distal portion, e.g., the funnel (e.g., the rectifier) outlet may be fluidically connected to the channel intersection (e.g., an intersection of a reagent channel and the sample channel or an intersection of the sample channel and a side-channel). In some cases, the sample channel may include one or more (e.g., 1, 2, or 3) funnels (e.g., mini-rectifiers) in its middle portion, e.g., between a distal funnel inlet and a proximal funnel outlet or a channel intersection (e.g., an intersection of a reagent channel and a sample channel or an intersection of a sample channel and a side-channel). Advantageously, a sample channel may include two rectifiers, a first rectifier at the distal end of the sample channel, e.g., fluidically connected to an intersection with a reagent channel, and the second between the proximal end of the sample channel and the first rectifier. In some embodiments, the second rectifier may be positioned equidistantly between the proximal and distal ends of the sample channel.

One or more funnels may include hurdle(s) (e.g., 1, 2, or 3 hurdles in one funnel). The hurdle may be a row of pegs, a barrier, or a combination thereof. The hurdles may be disposed anywhere within the funnel, e.g., closer to the funnel inlet, closer to the funnel outlet, or in the middle. Typically, when rows of pegs are included in the funnel, at least two rows of pegs are included. Pegs may have a diameter of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a width of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a peg length and a peg width, and the peg length may be greater than the peg width (e.g., the peg length may be at least 10%, 25%, 50%, 75%, 100%, 150%, 200%, or 300% greater than the peg width; e.g., the peg length may be 10% to 1000%, 10% to 900%, 10% to 800%, 10% to 700%, 10% to 600%, 50% to 1000%, 50% to 900%, 50% to 800%, 50% to 700%, 50% to 600%, 100% to 1000%, 100% to 900%, 100% to 800%, 100% to 700%, 100% to 600%, 200% to 1000%, 200% to 900%, 200% to 800%, 200% to 700%, or 200% to 600% greater than the peg width). Individual pegs may be spaced at a distance sized to allow at least one particle through the row of pegs (e.g., the distance between individual pegs may be 100% to 500% of the particle diameter). For example, the distance between individual pegs may be at least same as the diameter of a particle (e.g., 100% to 1000% of the particle diameter, 100% to 900% of the particle diameter, 100% to 800% of the particle diameter, 100% to 700% of the particle diameter, 100% to 600% of the particle diameter, or 100% to 500% of the particle diameter), for which the funnel is configured. For example, individual pegs may be spaced at 50 μm to 100 μm (e.g., 60 μm to 100 μm, 70 μm to 100 μm, 80 μm to 100 μm, 90 μm to 100 μm, 50 μm to 90 μm, 60 μm to 90 μm, 70 μm to 90 μm, 80 μm to 90 μm, 50 μm to 80 μm, 60 μm to 80 μm, 70 μm to 80 μm, 50 μm to 70 μm, 60 μm to 70 μm, or 50 μm to 60 μm) from each other. A barrier may have a height that leaves space between the barrier and the opposite funnel wall sized to permit a particle through the space (e.g., the height between the barrier and the funnel wall may be 50% to 400% of the particle diameter). For example, the height between the barrier and the funnel wall may be at least 50% of the particle diameter, for which the funnel is configured (e.g., at least 60%, at least 70%, at least 80%, at least 90%, at least 100% of the particle diameter; e.g., 400% or less, 300% or less, 200% or less of the particle diameter). The barrier may have a height that is at least 100% of the particle diameter, for which the funnel is configured (e.g., at least 200%, at least 300%, at least 400%, at least 500%, at least 600%, or at least 700% of the particle diameter; 800% or less, 700% or less, 600% or less, 500% or less, 400% or less, 300% or less, 200% or less of the particle diameter). A barrier may have a height of at least 20 μm (e.g., at least 30 μm, at least 40 μm, at least 50 μm, or at least 60 μm). For example, a barrier may have a height of 20 μm to 70 μm (e.g., 30 μm to 70 μm, 40 μm to 70 μm, 50 μm to 70 μm, 60 μm to 70 μm, 20 μm to 60 μm, 30 μm to 60 μm, 40 μm to 60 μm, 50 μm to 60 μm, 20 μm to 50 μm, 30 μm to 50 μm, 40 μm to 50 μm, 20 μm to 40 μm, 30 μm to 40 μm, or 20 μm to 30 μm).

In some cases, a reagent channel (e.g., the first channel) may intersect one or more side-channels (e.g., a first side-channel and optionally a second side-channel). In the devices and systems of the invention including a first side-channel, the first side-channel has a first side-channel depth, a first side-channel width, a first side-channel proximal end, and a first side-channel distal end. The first side-channel proximal end is fluidically connected to the first channel at a first proximal intersection between the first proximal end and the first distal end, and the first side-channel distal end is fluidically connected to the first channel at a first distal intersection between the first proximal intersection and the first distal end. The first side-channel includes a proximal end including one or more first side-channel inlets, and the first side-channel distal end includes one or more first side-channel outlets. The first side-channel may further include a first side-channel reservoir configured for holding a liquid. The first side-channel may be sized at its inlet to substantially prevent ingress of particles from the first channel. Accordingly, each of the one or more first side-channel inlets may have at least one dimension smaller than the smaller of the first depth and the first width. Each of the one or more first side-channel outlets may have at least one dimension smaller than the smaller of the first depth and the first width. For example, the first side-channel depth may be at least 25% (e.g., at least 50%) smaller than the first depth. Alternatively, the first side-channel may include a filter at its inlet and optionally at its outlet. The filter may be a row of spaced pegs disposed across the first side-channel inlet.

Additionally, in the devices and systems of the invention including a second side-channel, the second side-channel has a second side-channel depth, a second side-channel width, a second side-channel proximal end, and a second side-channel distal end. When the device or system of the invention includes the second side-channel, the second side-channel proximal end is fluidically connected to the first channel at a second proximal intersection between the first proximal end and the first distal end, and the second side-channel distal end is fluidically connected to the first channel at a second distal intersection between the second proximal intersection and the first distal end. The second side-channel optionally includes a reservoir configured for holding a liquid. Preferably, the first proximal intersection is substantially opposite the second proximal intersection. Also preferably, the first distal intersection is substantially opposite the second distal intersection. The arrangement of first and second (e.g., proximal and/or distal) intersections being substantially opposite each other may be particularly advantageous for reducing the amount of excess liquid between consecutive particles or for reducing the bunching of consecutive particles. The second side-channel at its inlet may further include a second side-channel reservoir configured for holding a liquid. The second side-channel may be sized to substantially prevent ingress of particles from the first channel.

Accordingly, each of the one or more second side-channel inlets may have at least one dimension smaller than the smaller of the first depth and the first width. Each of the one or more second side-channel outlets may have at least one dimension smaller than the smaller of the first depth and the first width. For example, the second side-channel depth may be at least 25% (e.g., at least 50%) smaller than the first depth. Alternatively, the second side-channel may include a filter at its inlet and optionally at its outlet. The filter may be a row of spaced pegs disposed across the second side-channel inlet.

The side-channel reservoirs (e.g., the first side-channel reservoir and/or the second side-channel reservoir), when present, may be configured for controlling pressure in the side-channels to improve control over spacing between particles, thereby further enhancing droplet-to-droplet content uniformity (e.g., uniformity in the number of particles from the same source (e.g., of the same kind)). For example, a third liquid may be included in the side-channel reservoir, and the amount of the third liquid may control the pressure in the side-channels. Alternatively, the pressure control in the side-channel may be active or passive. Pressure control may be achieved using channel reservoirs. For example, the channel pressure may be passively controlled by controlling the amount of liquid in a reservoir, as the height level of the liquid may control the hydrostatic pressure exerted on the channel. Alternatively, the channel pressure may be actively controlled using a pump connected to the reservoir such that the pump applies a predetermined pressure to the liquid in the reservoir.

The inclusion of one or more intersection channels allows for splitting liquid from a channel or introduction of liquids into the channel, e.g., that combine with the liquid in the channel or do not combine with the liquid in the channel, e.g., to form a sheath flow. Channels can intersect at any suitable angle, e.g., between 5° and 135° relative to the centerline of one of the channels, such as between 75° and 115° or 85° and 95°. Additional channels may similarly be present to allow introduction of further liquids or additional flows of the same liquid. Multiple channels can intersect the channel on the same side or different sides of the channel. When multiple channels intersect on different sides, the channels may intersect along the length of the channel to allow liquid introduction at the same point. Alternatively, channels may intersect at different points along the length of the channel. In some instances, a channel configured to direct a liquid comprising a plurality of particles may include one or more grooves in one or more surface of the channel to direct the plurality of particles towards the droplet source region. For example, such guidance may increase single occupancy rates of the generated droplets. These additional channels may have any of the structural features discussed above.

Devices may include multiple flow paths, e.g., to increase the rate of droplet formation. In general, throughput may significantly increase by increasing the number of droplet source regions of a device. For example, a device having five droplet source regions may generate five times as many droplets than a device having one droplet source region, provided that the liquid flow rate is substantially the same. A device may have as many droplet source regions as is practical and allowed for the size of the source of liquid, e.g., reservoir. For example, the device may have at least about 2, 3, 4, 5, 6, 7, 8, 9, 10, 20, 30, 40, 50, 60, 70, 80, 90, 100, 150, 200, 250, 300, 350, 400, 450, 500, 600, 700, 800, 900, 1000, 1500, 2000 or more droplet source regions. Inclusion of multiple droplet source regions may require the inclusion of channels that traverse but do not intersect, e.g., the flow path is in a different plane. Multiple flow paths may be in fluid communication with, e.g., fluidically connected to, a separate source reservoir and/or a separate droplet source region. In other embodiments, two or more channels are in fluid communication with, e.g., fluidically connected to, the same fluid source, e.g., where the multiple channels branch from a single, upstream channel. The droplet source region may include a plurality of inlets in fluid communication with the first proximal end and a plurality of outlets (e.g., plurality of outlets in fluid communication with a collection region) (e.g., fluidically connected to the first proximal end and in fluid communication with a plurality of outlets). The number of inlets and the number of outlets in the droplet source region may be the same (e.g., there may be 3-10 inlets and/or 3-10 outlets). Alternatively or in addition, the throughput of droplet formation can be increased by increasing the flow rate of the first liquid, third liquid (when present), and/or fourth liquid (when present). In some cases, the throughput of droplet formation can be increased by having a plurality of single droplet forming devices, e.g., devices with a channel and a droplet source region, in a single device, e.g., parallel droplet formation.

The devices, kits, systems, and methods of the invention may include a mixer, e.g., a passive mixer (e.g., a chaotic advection mixer), in any channel. The mixer may be included downstream of an intersection where two different liquids from two intersecting channels are combined.

Mixers that may be included in the devices and systems of the invention are known in the art. Non-limiting examples of mixers include a herringbone mixer, connected-groove mixer, modified staggered herringbone mixer, wavy-wall channel mixer, chessboard mixer, alternate-injection mixer with an increased cross-section chamber, serpentine laminating micromixer, two-layer microchannel mixer, connected-groove micromixer, and SAR mixer. Non-limiting examples of mixers are described in Suh and Kang, Micromachines, 1:82-111, 2010; Lee et al., Int. J. Mol. Sci., 12:3263-3287, 2011; and Lee et al., Chem. Eng. J., 288:146-160, 2016.

Typically, the mixer may be sized to accommodate particles passing through (e.g., biological particles, such as cells, nuclei, or particulate components thereof). The mixer may have a length of 2-15 mm (e.g., 2, 3, 4, 5, 6, 7, 8, 9, 10, 11, 12, 13, 14, or 15 mm).

Alternatively or additionally, the device may include one or more traps in channels. The traps may be included in channels in a configuration that permits air buoyancy to raise any bubbles away from the liquid flow. Thus, a trap typically has a trap depth that is greater than the depth of the channel, in which the trap is disposed. One of skill in the art will recognize that the terms depth and height may be used interchangeably to indicate the same dimension.

Droplets may be formed in a device by flowing a first liquid through a channel and into a droplet source region including a second liquid, i.e., the continuous phase, which may or may not be externally driven. Thus, droplets can be formed without the need for externally driving the second liquid. The size of the generated droplets is significantly less sensitive to changes in liquid properties. For example, the size of the generated droplets is less sensitive to the dispersed phase flow rate. Adding multiple source regions is also significantly easier from a layout and manufacturing standpoint. The addition of further source regions allows for formation of droplets even in the event that one droplet source region becomes blocked. Droplet formation can be controlled by adjusting one or more geometric features of fluidic channel architecture, such as a width, depth, and/or expansion angle of one or more fluidic channels. For example, droplet size and speed of droplet formation may be controlled. In some instances, the number of source regions at a driven pressure can be increased to increase the throughput of droplet formation.

Droplets may be formed by any suitable method known in the art. In general, droplet formation includes two liquid phases. The two phases may be, for example, an aqueous phase and an oil phase. During droplet formation, a plurality of discrete volume droplets is formed.

The droplets may be formed by shaking or stirring a liquid to form individual droplets, creating a suspension or an emulsion containing individual droplets, or forming the droplets through pipetting techniques, e.g., with needles, or the like. The droplets may be formed made using a milli-, micro-, or nanofluidic droplet maker. Examples of such droplet makers include, e.g., a T-junction droplet maker, a Y-junction droplet maker, a channel-within-a-channel junction droplet maker, a cross (or “X”) junction droplet maker, a flow-focusing junction droplet maker, a micro-capillary droplet maker (e.g., co-flow or flow-focus), and a three-dimensional droplet maker. The droplets may be produced using a flow-focusing device, or with emulsification systems, such as homogenization, membrane emulsification, shear cell emulsification, and fluidic emulsification.

Discrete liquid droplets may be encapsulated by a carrier fluid that wets the microchannel. These droplets, sometimes known as plugs, form the dispersed phase in which the reactions occur. Systems that use plugs differ from segmented-flow injection analysis in that reagents in plugs do not come into contact with the microchannel. In T junctions, the disperse phase and the continuous phase are injected from two branches of the “T”. Droplets of the disperse phase are produced as a result of the shear force and interfacial tension at the fluid-fluid interface. The phase that has lower interfacial tension with the channel wall is the continuous phase. To generate droplets in a flow-focusing configuration, the continuous phase is injected through two outside channels and the disperse phase is injected through a central channel into a narrow orifice. Other geometric designs to create droplets would be known to one of skill in the art. Methods of producing droplets are disclosed in Song et al. Angew. Chem. 45: 7336-7356, 2006, Mazutis et al. Nat. Protoc. 8(5):870-891, 2013, U.S. Pat. No. 9,839,911; U.S. Pub. Nos. 2005/0172476, 2006/0163385, and 2007/0003442, PCT Pub. Nos. WO 2009/005680 and WO 2018/009766. In some cases, electric fields or acoustic waves may be used to produce droplets, e.g., as described in PCT Pub. No. WO 2018/009766.

In some cases, a droplet source region may allow liquid from the first channel to expand in at least one dimension, leading to droplet formation under appropriate conditions as described herein. A droplet source region can be of any suitable geometry. In one embodiment, the droplet source region includes a shelf region that allows liquid to expand substantially in one dimension, e.g., perpendicular to the direction of flow. The width of the shelf region is greater than the width of the first channel at its distal end. In certain embodiments, the first channel is a channel distinct from a shelf region, e.g., the shelf region widens or widens at a steeper slope or curvature than the distal end of the first channel. In other embodiments, the first channel and shelf region are merged into a continuous flow path, e.g., one that widens linearly or non-linearly from its proximal end to its distal end; in these embodiments, the distal end of the first channel can be considered to be an arbitrary point along the merged first channel and shelf region. In another embodiment, the droplet source region includes a step region, which provides a spatial displacement and allows the liquid to expand in more than one dimension. The spatial displacement may be upward or downward or both relative to the channel. The choice of direction may be made based on the relative density of the dispersed and continuous phases, with an upward step employed when the dispersed phase is less dense than the continuous phase and a downward step employed when the dispersed phase is denser than the continuous phase. Droplet source regions may also include combinations of a shelf and a step region, e.g., with the shelf region disposed between the channel and the step region. Exemplary devices of this embodiment are described in WO 2019/040637, the droplet forming devices of which are hereby incorporated by reference.

Without wishing to be bound by theory, droplets of a first liquid can be formed in a second liquid in the devices of the invention by flow of the first liquid from the distal end of the channel into the droplet source region. In embodiments with a shelf region and a step region, the stream of first liquid expands laterally into a disk-like shape in the shelf region. As the stream of first liquid continues to flow across the shelf region, the stream passes into the step region where the droplet assumes a more spherical shape and eventually detaches from the liquid stream. As the droplet is forming, passive flow of the continuous phase around the nascent droplet occurs, e.g., into the shelf region, where it reforms the continuous phase as the droplet separates from its liquid stream. Droplet formation by this mechanism can occur without externally driving the continuous phase, unlike in other systems. It will be understood that the continuous phase may be externally driven during droplet formation, e.g., by gently stirring or vibration but such motion is not necessary for droplet formation.

Passive flow of the continuous phase may occur around the nascent droplet. The droplet source region may also include one or more channels that allow for flow of the continuous phase to a location between the distal end of the first channel and the bulk of the nascent droplet. These channels allow for the continuous phase to flow behind a nascent droplet, which modifies (e.g., increase or decreases) the rate of droplet formation. Such channels may be fluidically connected to a reservoir of the droplet source region or to different reservoirs of the continuous phase. Although externally driving the continuous phase is not necessary, external driving may be employed, e.g., to pump continuous phase into the droplet source region via additional channels. Such additional channels may be to one or both lateral sides of the nascent droplet or above or below the plane of the nascent droplet.

The width of a shelf region may be from 0.1 μm to 1000 μm. In particular embodiments, the width of the shelf is from 1 to 750 μm, 10 to 500 μm, 10 to 250 μm, or 10 to 150 μm. The width of the shelf region may be constant along its length, e.g., forming a rectangular shape. Alternatively, the width of the shelf region may increase along its length away from the distal end of the first channel. This increase may be linear, nonlinear, or a combination thereof. In certain embodiments, the shelf widens 5% to 10,000%, e.g., at least 300%, (e.g., 10% to 500%, 100% to 750%, 300% to 1000%, or 500% to 1000%) relative to the width of the distal end of the first channel. The depth of the shelf can be the same as or different from the first channel. For example, the bottom of the first channel at its distal end and the bottom of the shelf region may be co-planar. Alternatively, a step or ramp may be present where the distal end meets the shelf region. The depth of the distal end may also be greater than the shelf region, such that the first channel forms a notch in the shelf region. The depth of the shelf may be from 0.1 to 1000 μm, e.g., 1 to 750 μm, 1 to 500 μm, 1 to 250 μm, 1 to 100 μm, 1 to 50 μm, or 3 to 40 μm. In some embodiments, the depth is substantially constant along the length of the shelf. Alternatively, the depth of the shelf slopes, e.g., downward or upward, from the distal end of the liquid channel to the step region. The final depth of the sloped shelf may be, for example, from 5% to 1000% greater than the shortest depth, e.g., 10 to 750%, 10 to 500%, 50 to 500%, 60 to 250%, 70 to 200%, or 100 to 150%. The overall length of the shelf region may be from at least about 0.1 μm to about 1000 μm, e.g., 0.1 to 750 μm, 0.1 to 500 μm, 0.1 to 250 μm, 0.1 to 150 μm, 1 to 150 μm, 10 to 150 μm, 50 to 150 μm, 100 to 150 μm, 10 to 80 μm, or 10 to 50 μm. In certain embodiments, the lateral walls of the shelf region, i.e., those defining the width, may be not parallel to one another. In other embodiments, the walls of the shelf region may narrower from the distal end of the first channel towards the step region. For example, the width of the shelf region adjacent the distal end of the first channel may be sufficiently large to support droplet formation. In other embodiments, the shelf region is not substantially rectangular, e.g., not rectangular or not rectangular with rounded or chamfered corners.

A step region includes a spatial displacement (e.g., depth). Typically, this displacement occurs at an angle of approximately 90°, e.g., between 85° and 95°. Other angles are possible, e.g., 10-90°, e.g., 20 to 90°, 45 to 90°, or 70 to 90°. The spatial displacement of the step region may be any suitable size to be accommodated on a device, as the ultimate extent of displacement does not affect performance of the device. Preferably the displacement is several times the diameter of the droplet being formed. In certain embodiments, the displacement is from about 1 μm to about 10 cm, e.g., at least 10 μm, at least 40 μm, at least 100 μm, or at least 500 μm, e.g., 40 μm to 600 μm. In some embodiments, the displacement is at least 40 μm, at least 45 μm, at least 50 μm, at least 55 μm, at least 60 μm, at least 65 μm, at least 70 μm, at least 75 μm, at least 80 μm, at least 85 μm, at least 90 μm, at least 95 μm, at least 100 μm, at least 110 μm, at least 120 μm, at least 130 μm, at least 140 μm, at least 150 μm, at least 160 μm, at least 170 μm, at least 180 μm, at least 190 μm, at least 200 μm, at least 220 μm, at least 240 μm, at least 260 μm, at least 280 μm, at least 300 μm, at least 320 μm, at least 340 μm, at least 360 μm, at least 380 μm, at least 400 μm, at least 420 μm, at least 440 μm, at least 460 μm, at least 480 μm, at least 500 μm, at least 520 μm, at least 540 μm, at least 560 μm, at least 580 μm, or at least 600 μm. In some cases, the depth of the step region is substantially constant. Alternatively, the depth of the step region may increase away from the shelf region, e.g., to allow droplets that sink or float to roll away from the spatial displacement as they are formed. The step region may also increase in depth in two dimensions relative to the shelf region, e.g., both above and below the plane of the shelf region. The reservoir may have an inlet and/or an outlet for the addition of continuous phase, flow of continuous phase, or removal of the continuous phase and/or droplets.

While dimensions of the devices may be described as width or depths, the channels, shelf regions, and step regions may be disposed in any plane. For example, the width of the shelf may be in the x-y plane, the x-z plane, the y-z plane or any plane therebetween. In addition, a droplet source region, e.g., including a shelf region, may be laterally spaced in the x-y plane relative to a channel or located above or below the channel. Similarly, a droplet source region, e.g., including a step region, may be laterally spaced in the x-y plane, e.g., relative to a shelf region or located above or below a shelf region. The spatial displacement in a step region may be oriented in any plane suitable to allow the nascent droplet to form a spherical shape. The fluidic components may also be in different planes so long as connectivity and other dimensional requirements are met.

The device may also include reservoirs for liquid reagents. For example, the device may include a reservoir for the liquid to flow into a channel and/or a reservoir for the liquid into which droplets are formed. In some cases, devices of the invention include a collection region, e.g., a volume for collecting formed droplets. A droplet collection region may be a reservoir that houses continuous phase or can be any other suitable structure, e.g., a channel, a shelf, a chamber, or a cavity, on or in the device. For reservoirs or other elements used in collection, the walls may be smooth and not include an orthogonal element that would impede droplet movement. For example, the walls may not include any feature that at least in part protrudes or recedes from the surface. It will be understood, however, that such elements may have a ceiling or floor. The droplets that are formed may be moved out of the path of the next droplet being formed by gravity (either upward or downward depending on the relative density of the droplet and continuous phase). Alternatively or in addition, formed droplets may be moved out of the path of the next droplet being formed by an external force applied to the liquid in the collection region, e.g., gentle stirring, flowing continuous phase, or vibration. Similarly, a reservoir for liquids to flow in additional channels, e.g., any additional reagent channels that may intersect a sample channel may be present. A single reservoir may also be connected to multiple channels in a device, e.g., when the same liquid is to be introduced at two or more different locations in the device. Waste reservoirs or overflow reservoirs may also be included to collect waste or overflow when droplets are formed. Alternatively, the device may be configured to mate with sources of the liquids, which may be external reservoirs such as vials, tubes, or pouches. Similarly, the device may be configured to mate with a separate component that houses the reservoirs. Reservoirs may be of any appropriate size, e.g., to hold 10 μL to 500 mL, e.g., 10 μL to 300 mL, 25 μL to 10 mL, 100 μL to 1 mL, 40 μL to 300 μL, 1 mL to 10 mL, or 10 mL to 50 mL. When multiple reservoirs are present, each reservoir may have the same or a different size.

Collection reservoirs may include one or more dividing walls, either integrated with the device or provided by an insert in the well. The dividing walls or walls separate the output from different droplet source regions. A dividing wall may include a variety of materials, including, but not limited to, e.g., polymers (e.g., polypropylene, polyethylene, cyclic olefin polymers, polycarbonates, PTFE, polysulfones, cellulose esters, etc.), glass, ceramics, etc. The dividing wall may include a permeable or semipermeable membrane, e.g., a hydrogel or micro-, meso-, or nanoporous film, such as, e.g., a track-etched polymer membrane, a glass or polymeric microfiber filter, etc.

In some instances, reservoirs, e.g., collection reservoirs, sample reservoirs, and/or reagent reservoirs, may hold about 10 μL to about 1 ml, e.g., about 10 μL to about 500 μL, about 10 μL to about 750 μL, about 10 μL to about 50 μL, about 40 μL to about 80 μL, about 20 μL to about 100 μL, about 70 μL to about 100 μL, about 90 μL to about 120 μL, about 110 μL to about 150 μL, about 140 μL to about 190 about μL, about 180 μL to about 220 μL, about 210 μL to about 250 μL, about 240 μL to about 280 μL, about 270 μL to about 340 μL, about 330 μL to about 345 μL, about 340 μL to about 375 μL, about 370 μL to about 420 μL, about 410 μL to about 470 μL, or about 460 μL to about 500 μL. In some instances, the reservoirs may hold about 480 μL, about 340 μL, about 280 μL, about 220 μL, about 110 μL or about 80 μL. Typically, the volume of the collection reservoir is equal to or greater than the volumes of the sample and reagent reservoirs (or portions thereof) that empty into it.

In some instances, the reservoirs are filled between 20% and 98% of the volume, e.g., about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, or 98%. In some instances, the reservoirs are filled between 20% and 35%, between 30% and 45%, between 40% and 55%, between 50% and 65%, between 60% and 75%, between 70% and 85%, between 80% and 95%, or between 90% and 98%.

Alternatively or in addition, reservoirs, e.g., collection reservoirs, sample reservoirs, and/or reagent reservoirs, may include a side wall canted between a 89.5° and 4° angle, e.g., between a 85° and 5° angle, e.g., about a 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, or 5° angle. In some instances, the side wall is canted between 85° and 70°, between 75° and 60°, between 65° and 50°, between 55° and 48°, between 50° and 43°, between 46° and 44°, between 44° and 35°, between 37° and 25°, between 30° and 15°, or between 20° and 5°. In certain embodiments, the side wall may be canted at two or more angles at various vertical heights. In other embodiments, the side wall is canted for a portion of the height and vertical for a portion of the height. For example, the side wall may be canted for 5-100% of the height, e.g., for 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%. In some instances, the side wall may be canted for between 100% and 85%, between 100% and 75%, between 100% and 50%, between 90% and 75%, between 80% and 65%, between 70% and 55%, between 60% and 45%, between 50% and 35%, between 50% and 5%, between 40% and 25%, between 30% and 15%, or between 20% and 5%. When the side wall is canted at two or more angles, the canted portions may have the same vertical height or different vertical heights. For example, for two canted portions, the higher angled portion may be between 5 to 95% of the canted portion of the side wall, e.g., 5 to 75% 5 to 50%, 5 to 25%, 50 to 95%, 50 to 75%, 75 to 95%, 25 to 75%, 25 to 50%, or 40 to 60%.

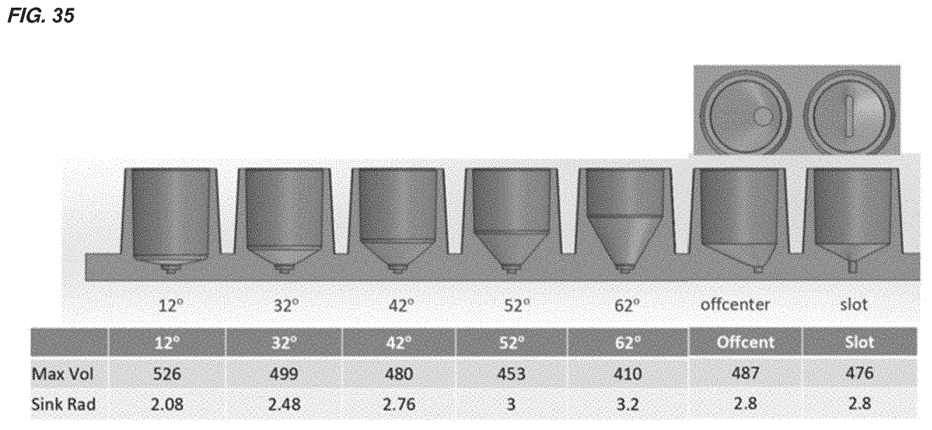

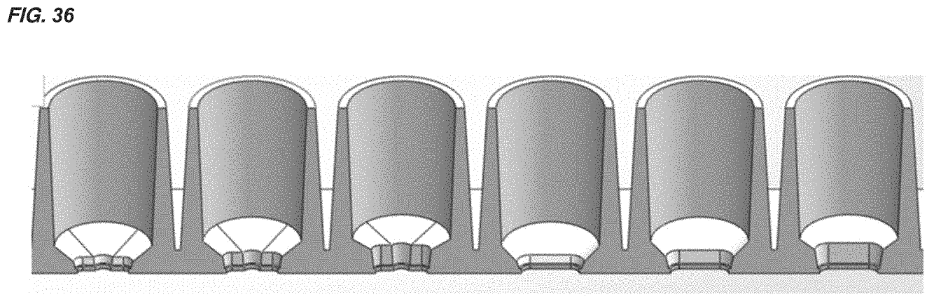

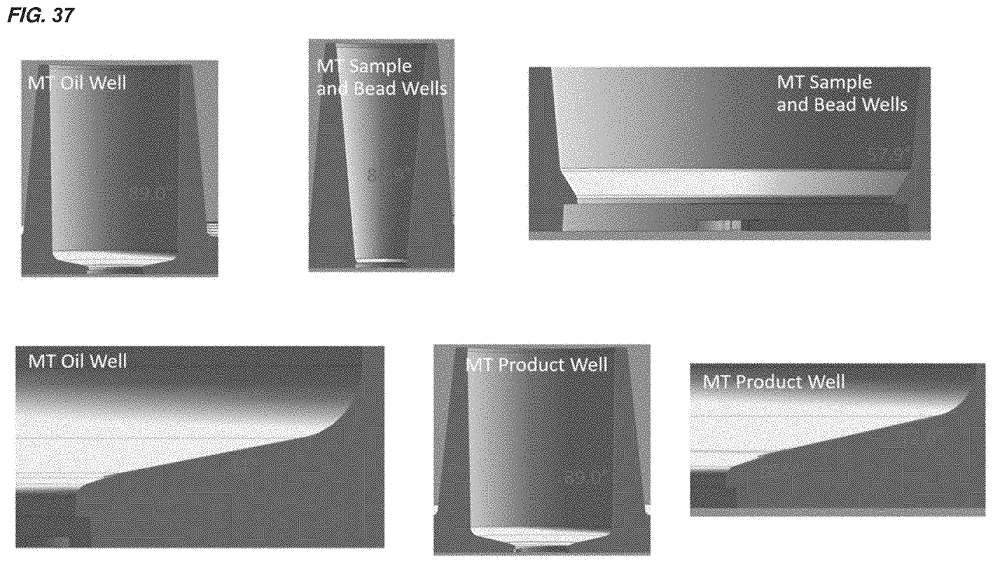

Alternatively, or in addition, reservoirs, e.g., collection reservoirs, sample reservoirs, and/or reagent reservoirs, may include canted sidewalls, slots, and slots with protrusions, i.e., expanding the opening of the slot, at the interface between the reservoir and the channel. In some embodiments, the canted sidewalls are an oblique circular cone shape, a circular cone that tapers to a slot, or a circular cone that tapers to a slot with protrusions at the interface between the reservoir and the channel. Exemplary device reservoir designs are depicted in FIGS. 35-38.

The vertical height of a reservoir, e.g., collection reservoir, sample reservoir, and/or reagent reservoir, may be between 1 and 20 mm, e.g., 1 to 5 mm, 1 to 10 mm, 1 to 15 mm, 5 to 10 mm, 5 to 15 mm, 10 to 22 mm, 2 to 7 mm, 7 to 13 mm, 12 to 18 mm or at least 5, at least 10, or at least 15 mm.

In addition to the components discussed above, devices of the invention can include additional components.

For example, channels may include filters to prevent introduction of debris into the device. In some cases, the microfluidic systems described herein may comprise one or more liquid flow units to direct the flow of one or more liquids, such as the aqueous liquid and/or the second liquid immiscible with the aqueous liquid. In some instances, the liquid flow unit may comprise a compressor to provide positive pressure at an upstream location to direct the liquid from the upstream location to flow to a downstream location. In some instances, the liquid flow unit may comprise a pump to provide negative pressure at a downstream location to direct the liquid from an upstream location to flow to the downstream location. In some instances, the liquid flow unit may comprise both a compressor and a pump, each at different locations. In some instances, the liquid flow unit may comprise different devices at different locations. The liquid flow unit may comprise an actuator. In some instances, where the second liquid is substantially stationary, the reservoir may maintain a constant pressure field at or near each droplet source region. Devices may also include various valves to control the flow of liquids along a channel or to allow introduction or removal of liquids or droplets from the device.

Suitable valves are known in the art. Valves useful for a device of the present invention include diaphragm valves, solenoid valves, pinch valves, or a combination thereof. Valves can be controlled manually, electrically, magnetically, hydraulically, pneumatically, or by a combination thereof. The device may also include integral liquid pumps or be connectable to a pump to allow for pumping in the first channels and any other channels requiring flow. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device. The device may also include one or more vents to allow pressure equalization, and one or more filters to remove particulates or other undesirable components from a liquid. The device may also include one or more inlets and or outlets, e.g., to introduce liquids and/or remove droplets. Such additional components may be actuated or monitored by one or more controllers or computers operatively coupled to the device, e.g., by being integrated with, physically connected to (mechanically or electrically), or by wired or wireless connection.

In some instances, a fluid may include suspended particles. The particles may be beads, biological particles, cells, nuclei, cell beads, or any combination thereof (e.g., a combination of beads and cells/nuclei or a combination of beads and cell beads, etc.). A discrete droplet generated may include a particle, such as when one or more particles are suspended in the volume of a first fluid that is propelled into a second fluid.

Alternatively, a discrete droplet generated may include more than one particle. Alternatively, a discrete droplet generated may not include any particles. For example, in some instances, a discrete droplet generated may contain one or more biological particles where the fluid includes a plurality of biological particles.

Droplets or particles may be first formed in a larger volume, such as in a reservoir, and then reentrained into a channel, e.g., for unit operations, such as trapping, holding, incubation, reaction, emulsion breaking, sorting, and/or detection. A device may include a first region in fluid communication with (e.g., fluidically connected to) a second region, e.g., with at least one (e.g., each) cross-sectional dimension smaller than the corresponding cross-sectional dimension of the first region. For example, the droplets or particles may be formed or provided in a region in which each cross-sectional dimension of the sorting region may have a length of at least 1 mm (e.g., 2 mm, 3 mm, 4 mm, 5 mm, 6 mm, 7 mm, 8 mm, 9 mm, 10 mm, or more).

Following formation or provision, the droplets or particles may be reentrained into a second region (e.g., a channel) in which each cross-section dimension is less than about 1 mm (e.g., less than about 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 5 nm, 1 nm, 900 μm, 800 μm, 700 μm, 600 μm, 500 μm, 400 μm, 300 μm, 200 μm, 100 μm, 50 μm, 10 μm, 5 μm, 2 μm, 1 μm, or less). Manipulations may be employed in the first region and/or the second region or a subsequent region downstream. This method may include detecting the droplets, e.g., as they are formed or provided in the first region, reentrained in the second region, or while traversing a subsequent region downstream. The device may further include additional regions, e.g., reservoirs, for manipulation, e.g., holding, incubation, reaction, or deemulsification. Any suitable mechanism for reentraining droplets may be employed. Examples include the use of magnetic, electric, dielectrophoretic, or optical energy, differences in density, advection, and pressure. In one example, droplets are produced in a ferrofluid, the magnetic actuation of which can be used to direct droplets to a reentrainment channel. Devices may include features in a reservoir to aid direction of droplets to a reentrainment channel. For example, a reservoir in which droplets are produced or held may have a funnel feature connecting to a reentrainment channel, e.g., sized to allow droplets to pass one by one into the reentrainment channel. In embodiments, droplets are produced in a channel in which they can be transported. In certain embodiments, the reentrainment channel is in fluid communication with one or more additional reservoirs, e.g., for any of the unit operations described herein.

Droplets or particles may be formed in a larger volume, such as a reservoir (e.g., a reservoir containing a ferrofluid (e.g., a colloidal suspension of small magnetic particles (e.g., iron oxide, nickel, cobalt, etc.) in a liquid (e.g., an aqueous liquid or an oil)), and then manipulated using a magnetic actuator. Droplets or particles in a ferrofluid may be reentrained into a channel using a magnetic actuator, e.g., for unit operations, such as trapping, holding, incubation, reaction, emulsion, breaking, sorting, and/or detection. A device may include a first region in fluid communication with (e.g., fluidically connected to) a second region, e.g., with at least one (e.g., each) cross-sectional dimension smaller than the corresponding cross-sectional dimension of the first region. For example, the droplets or particles may be formed or provided in a region containing a ferrofluid, and a magnetic actuator may alter the magnetic field, manipulating the droplets (e.g., the droplets may be separated based on size or the droplets may be directed above or below the ferrofluid). Following formation or provision, the droplets or particles may be reentrained into a second region (e.g., a channel) by activating the magnetic actuator. Manipulations may be employed in the first region and/or the second region or a subsequent region downstream. This method may include detecting the droplets, e.g., as they are formed or provided in the first region, reentrained in the second region, or while traversing a subsequent region downstream. The device may further include additional regions, e.g., reservoirs, for manipulation, e.g., holding, incubation, reaction, or deemulsification. The magnetic actuator can also be used to heat the ferrofluid and the droplets or particles by altering the magnetic field.

Multiplex Devices

Devices of the invention may be in multiplex format. Multiplex formats include devices having multiple droplet source regions downstream from a single sample inlet, multiple parallel flow paths with a sample inlet and a droplet formation, and combinations thereof. The flow paths, e.g., channels, funnels, filters, and droplet source regions, may be any as described herein. Inlets in multiplex devices may include a simple opening to allow introduction of fluid, or an inlet may be a chamber or reservoir housing a volume of fluid to be distributed (e.g., corresponding to a first or second reservoir or sample, reagent, or collection reservoir as described herein).

In certain embodiments, multiple inlets of a single type, e.g., sample or reagent (e.g., for particles such as gel beads) may be connected to a trough, allowing for loading using a single pipette or other transfer device. Troughs may be of any appropriate volume, e.g., at least the combined volumes of any reservoirs that would otherwise be present. For example, the volumes may be 2 to 50 times, e.g., 2 to 20 times, 2 to 10 times, or 2, 3, 4, 5, 6, 7, 8, 9, 10, 11, 12, 13, 14, 15, or 16 times, the volume of a reservoir as described herein.

In one embodiment, the multiplex devices include one or more sample inlets, one or more reagent inlets, and one or more collection reservoirs. The one or more sample inlets, one or more reagent inlets, and one or more collection reservoirs are placed in fluid communication by channels. A channel from the sample inlet intersects a channel from the reagent inlet at an intersection. Fluids flowing from the sample and reagent inlets combine at the intersection. A droplet source region is fluidically disposed between the intersection and the collection reservoir, and the combined sample and reagent fluids are formed into droplets. A single channel coming from an inlet may split into two or more branches, each of which may intersect another channel (or branch). Exemplary droplet source regions include a shelf and a step as described herein. Sample channels may correspond to first and/or second channels as described herein, and reagent channels may correspond to first and/or second channels as described herein.

Multiplex flow paths may include multiple sample inlets, multiple reagent inlets, and multiple collection reservoirs, where each sample inlet is in fluid communication with a particular reagent inlet-collection reservoir pair. When each reagent inlet includes a uniquely tagged population of particles, the multiplex flow path may be used to create libraries from many different combined samples (e.g., 2, 3, 4, 5, 6, 7, 8, 9, 10, 11, 12, or more sample inputs in one library). Droplets and their contents (e.g., cells, nuclei, or particulate components thereof) can be traced to a sample inlet of origin by the uniquely tagged particle(s) present in each droplet or, when sample inlets share a reagent inlet, by the combination of the uniquely tagged particle(s) present in the droplet and the collection reservoir in which the droplets are collected. Where the number of collection reservoirs in a flow path is two, reagent inlets may be shared by two sample inlets. Multiplexed devices may include multiple multiplex flow paths (e.g., 2, 3, 4, 5, 6, 7, 8, or more flow paths).

Multiplex devices may include multiple multiplex flow paths. Each multiplex flow path may be fluidically distinct or connected to other flow paths. For example, multiple flow paths may share a collection reservoir. In certain embodiments, a single reagent inlet delivers, via different reagent channels or different branches of a reagent channel, reagent to intersections with sample channels from different sample inlets. In the alternative or in addition, sample and/or reagent inlets may be connected by troughs. Where flow paths share a common inlet, outlet, or reservoir, the flow paths may be disposed radially about the common inlet, outlet, or reservoir. In some instances, devices described herein contain between 1 and 30 flow paths (e.g., at least 2, at least 4, at least 8, or 1, 2, 3, 4, 5, 6, 7, 8, 9, 10, 11, 12, 13, 14, or 15 flow paths). In some instances, devices described herein may feature troughs that connect inlets or collection reservoirs, e.g., a trough may connect between 1 and 30 inlets or collection reservoirs of the same and/or different flow paths (e.g., at least 2, at least 4, at least 8, or 1, 2, 3, 4, 5, 6, 7, 8, 9, 10, 11, 12, 13, 14, or 15 inlets or collection reservoirs of multiple flow paths). Where multiple inlets or collection reservoirs share a common trough, multiple channels may pass between the inlets or collection reservoirs and under the well. Channels may be of the same flow path as the inlets or collection reservoirs or of different flow paths of the same device.

For multiplex devices including multiple multiplex flow paths, the same or different samples can be introduced in different flow paths, and/or the same or different reagents can be introduced in different flow paths. For devices including flow paths, where the flow paths include multiple sample or reagent inlets, the same or different samples and/or reagents can be introduced in the inlets.

Combinations of different flow paths may be combined in a single multiplex device. Multiplex devices may also include common inlets, which may be a sample inlet, a reagent inlet, or a collection reservoir. In such devices, additional inlets are disposed around the common inlet. For example, the common inlet may be centrally located, with additional inlets arranged radially around the common inlet.

Inlets of the same type and/or collection reservoirs may be arranged substantially linearly, e.g., for ease of deliver or removal of fluids from the device by a multichannel pipette. Linear arrangement also allows for a more compact trough design when employed.

Multiplex devices may include a plurality of inlets surrounded by at least one common wall and have a dividing wall that has at least a portion of the dividing wall that is shorter than the one common wall. This arrangement allows a single pressure source to control fluid flow in two different inlets.

Multiplex devices may include multiplex flow path having either i) a connecting channel in fluid communication with two or more inlets or two or more reagent channels, or ii) one reagent channel that combines with another reagent channel for a distance before splitting into two separate reagent channels, as described herein.

Multiplex devices for producing droplets may include a) a sample inlet; b) one or more collection reservoirs; c) first and second reagent inlets; d) first and second sample channels in fluid communication with the sample inlet; e) a first reagent channel in fluid communication with the first reagent inlet and a second reagent channel in fluid communication with the second reagent inlet; and f) first and second droplet source regions. The first sample channel intersects with the first reagent channel at a first intersection, and the second sample channel intersects with the second reagent channel at a second intersection. The first droplet source region is fluidically disposed between the first intersection and the one or more collection reservoirs, and the second droplet source region is fluidically disposed between the second intersection and the one or more collection reservoirs. The first sample channel and/or the second sample channel is disposed between the first and second reagent inlets. The maximum cross sectional dimension of the sample channels may be 250 μm, e.g., about 1 μm, about 5 μm, about 10 μm, about 20 μm, about 30 μm, about 40 μm, about 50 μm, about 60 μm, about 70 μm, about 80 μm, about 90 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 247 μm, about 248 μm, about 249 μm, e.g., between about 1 μm to about 20 μm, about 10 μm to about 30 μm, about 20 μm to about 40 μm, about 30 μm to about 50 μm, about 40 μm to about 60 μm, about 50 μm to about 70 μm, about 60 μm to about 80 μm, about 70 μm to about 90 μm, about 80 μm to about 100 μm, about 90 μm to about 110 μm, about 100 μm to about 120 μm, about 110 μm to about 130 μm, about 120 μm to about 140 μm, about 130 μm to about 150 μm, about 140 μm to about 160 μm, about 150 μm to about 170 μm, about 160 μm to about 180 μm, about 170 μm to about 190 μm, about 180 μm to about 200 μm, about 190 μm to about 210 μm, about 200 μm to about 220 μm, about 210 μm to about 230 μm, about 220 μm to about 240 μm, or about 230 μm to about 245 μm. In some instances, the maximum cross-sectional dimension of the reagent channels is about 250 μm, e.g., about 1 μm, about 5 μm, about 10 μm, about 20 μm, about 30 μm, about 40 μm, about 50 μm, about 60 μm, about 70 μm, about 80 μm, about 90 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 247 μm, about 248 μm, about 249 μm, e.g., between about 1 μm to about 20 μm, about 10 μm to about 30 μm, about 20 μm to about 40 μm, about 30 μm to about 50 μm, about 40 μm to about 60 μm, about 50 μm to about 70 μm, about 60 μm to about 80 μm, about 70 μm to about 90 μm, about 80 μm to about 100 μm, about 90 μm to about 110 μm, about 100 μm to about 120 μm, about 110 μm to about 130 μm, about 120 μm to about 140 μm, about 130 μm to about 150 μm, about 140 μm to about 160 μm, about 150 μm to about 170 μm, about 160 μm to about 180 μm, about 170 μm to about 190 μm, about 180 μm to about 200 μm, about 190 μm to about 210 μm, about 200 μm to about 220 μm, about 210 μm to about 230 μm, about 220 μm to about 240 μm, or about 230 μm to about 245 μm. In some instances, the maximum cross-sectional dimension of the reagent channels is between about 10 μm and about 150 μm, between about 50 μm and about 150 μm, between about 80 μm and about 200 μm, or between about 100 μm and about 250 μm. In some instances, the number of droplet source regions per collection reservoir is at least 4, e.g., where the pitch is no greater than 20 mm per collection reservoir. For example, there may be 5, 6, 7, 8, 9, 10, 20, 30, 40, 50, 60, 70, 80, 90, 100, 150, 200, 250, 300, 350, 400, 450, 500, 600, 700, 800, 900, 1000, 1500, 2000 or more droplet source regions per collection reservoir, e.g. 2 to 16, such as 2, 3, 4, 5, 6, 7, 8, 9, 10, 11, 12, 13, 14, 15, or 16, e.g., 2 to 8. For example, the pitch may be about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18, about 18.5, about 19, or about 19.5 mm.

Advantageously, multiplexed devices of the invention may be compatible with equipment for use with multi-well plates, e.g., 96 well plates, 384 well plates, or 1536 well plates. Sizing and spacing the inlets and reservoirs of the multiplexed devices described herein to be in a linear sequence according to a row or column of a multi well plate allows the inlets to be filled or collection reservoirs emptied using multichannel pipettors, improving the efficiency of these steps. In another advantage, the multiplexed devices being sized and spaced to be in a linear sequence according to a row or column of a multi-well plate allow integration with robotic laboratory automation such as robotic plate handlers, samplers, analyzers, and other high-throughput systems adapted for multi well plate operations. Multiplexed devices of the invention can be disposed to fit a 96 well plate, a 384 well plate, or a 1536 well plate format. While it is preferable that the inlets and reservoirs of the multiplexed devices are arranged substantially linearly in order to maximize packing of flow paths into the area of a multi well plate, it is also possible for non-linear flow paths, and other non-linear arrangements of inlets and reservoirs, as described herein to be adapted to fit into a multi well plate format. In some embodiments, the number of flow paths possible in a multi well plate format is the number of wells of the multi well plate divided by the sum of the reservoirs and inlets in the flow path, provided the reservoirs and inlets are arranged substantially linearly. For example, for a flow path with two inlets and one collection reservoir, arranged substantially linearly, in a 96 well plate format the number of flow paths is 32. In some instances, the multiplexed devices described herein contain between 1 and 32 flow paths (e.g., up to 12, up to 13, up to 16, up to 19, or up to 24). In some instances, the multiplexed devices described herein contain between 1 and 128 flow paths (e.g., up to 48, up to 54, up to 64, up to 76, or up to 96). In some instances, the multiplexed devices described herein contain between 1 and 512 flow paths (e.g., up to 192, up to 219, up to 256, up to 307, or up to 384). Arrangements of multiple flow paths in other arrays is also within the scope of the invention.

Surface Properties

A surface of the device may include a material, coating, or surface texture that determines the physical properties of the device. In particular, the flow of liquids through a device of the invention may be controlled by the device surface properties (e.g., wettability of a liquid-contacting surface). In some cases, a device portion (e.g., a region, channel, or sorter) may have a surface having a wettability suitable for facilitating liquid flow (e.g., in a channel) or assisting droplet formation (e.g., in a channel), e.g., if droplet formation is performed.

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. The wettability of each surface may be suited to producing droplets. A device may include a channel having a surface with a first wettability in fluid communication with (e.g., fluidically connected to) a reservoir having a surface with a second wettability. The wettability of each surface may be suited to producing droplets of a first liquid in a second liquid. In this non-limiting example, the channel carrying the first liquid may have a surface with a first wettability suited for the first liquid wetting the channel surface. For example, when the first liquid is substantially miscible with water (e.g., the first liquid is an aqueous liquid), the surface material or coating may have a water contact angle of about 95° or less (e.g., 90° or less). Additionally, in this non-limiting example, a droplet source region, e.g., including a shelf, may have a surface with a second wettability so that the first liquid de-wets from it. For example, when the second liquid is substantially immiscible with water (e.g., the second liquid is an oil), the material or coating used may have a water contact angle of about 70° or more (e.g., 90° or more, 95° or more, or 100° or more). Typically, in this non-limiting example, the second wettability will be more hydrophobic than the channel. For example, the water contact angles of the materials or coatings employed in the channel and the droplet source region will differ by 5° to 150°.

For example, portions of the device carrying aqueous phases (e.g., a channel) may have a surface material or coating that is hydrophilic or more hydrophilic than another region of the device, e.g., include a material or coating having a water contact angle of less than or equal to about 90°, and/or the other region of the device may have a surface material or coating that is hydrophobic or more hydrophobic than the channel, e.g., include a material or coating having a water contact angle of greater than 70° (e.g., greater than 90°, greater than 95°, greater than 100° (e.g., 95°-120° or 100°-150°)). In certain embodiments, a region of the device may include a material or surface coating that reduces or prevents wetting by aqueous phases. The device can be designed to have a single type of material or coating throughout. Alternatively, the device may have separate regions having different materials or coatings.

In addition or in the alternative, portions of the device carrying or contacting oil phases (e.g., a collection reservoir or droplet source region) may have a surface material or coating that is hydrophobic, fluorophilic, or more hydrophobic or fluorophilic than the portions of the device that contact aqueous phases, e.g., include a material or coating having a water contact angle of greater than or equal to about 90°.

The device can be designed to have a single type of material or coating throughout. Alternatively, the device may have separate regions having different materials or coatings. Surface textures may also be employed to control fluid flow.

The device surface properties may be those of a native surface (i.e., the surface properties of the bulk material used for the device fabrication) or of a surface treatment. Non-limiting examples of surface treatments include, e.g., surface coatings and surface textures. In one approach, the device surface properties are attributable to one or more surface coatings present in a device portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the device. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition.

Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the device surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°).

The difference in water contact angles between that of a hydrophilic or more hydrophilic material or coating and a hydrophobic or more hydrophobic material or coating may be 5° to 150°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, 100°, 110°, 120°, 130°, 140°, or 150°.

The above discussion centers on the water contact angle. It will be understood that liquids employed in the devices and methods of the invention may not be water, or even aqueous. Accordingly, the actual contact angle of a liquid on a surface of the device may differ from the water contact angle. Furthermore, the determination of a water contact angle of a material or coating can be made on that material or coating when not incorporated into a device of the invention.

Particles

The invention includes devices, systems, and kits having particles, e.g., for use in analysis. For example, particles configured with analyte moieties (e.g., barcodes, nucleic acids, binding molecules (e.g., proteins, peptides, aptamers, antibodies, or antibody fragments), enzymes, substrates, etc.) can be included in a droplet containing an analyte to modify the analyte and/or detect the presence or concentration of the analyte. In some embodiments, particles are synthetic particles (e.g., beads, e.g., gel beads).

For example, a droplet may include one or more analyte moieties, e.g., unique identifiers, such as barcodes. Analyte moieties, e.g., barcodes, may be introduced into droplets previous to, subsequent to, or concurrently with droplet formation. The delivery of the analyte moieties, e.g., barcodes, to a particular droplet allows for the later attribution of the characteristics of an individual sample (e.g., biological particle) to the particular droplet. Analyte moieties, e.g., barcodes, may be delivered, for example on a nucleic acid (e.g., an oligonucleotide), to a droplet via any suitable mechanism. Analyte moieties, e.g., barcoded nucleic acids (e.g., oligonucleotides), can be introduced into a droplet via a support, such as a particle, e.g., a bead. In some cases, analyte moieties, e.g., barcoded nucleic acids (e.g., oligonucleotides), can be initially associated with the particle (e.g., bead) and then released upon application of a stimulus which allows the analyte moieties, e.g., nucleic acids (e.g., oligonucleotides), to dissociate or to be released from the particle.

A particle, e.g., a bead, may be porous, non-porous, hollow (e.g., a microcapsule), solid, semi-solid, semi-fluidic, fluidic, and/or a combination thereof. In some instances, a particle, e.g., a bead, may be dissolvable, disruptable, and/or degradable. In some cases, a particle, e.g., a bead, may not be degradable. In some cases, the particle, e.g., a bead, may be a gel bead. A gel bead may be a hydrogel bead. A gel bead may be formed from molecular precursors, such as a polymeric or monomeric species. A semi-solid particle, e.g., a bead, may be a liposomal bead. Solid particles, e.g., beads, may comprise metals including iron oxide, gold, and silver. In some cases, the particle, e.g., the bead, may be a silica bead. In some cases, the particle, e.g., a bead, can be rigid. In other cases, the particle, e.g., a bead, may be flexible and/or compressible.

A particle, e.g., a bead, may comprise natural and/or synthetic materials. For example, a particle, e.g., a bead, can comprise a natural polymer, a synthetic polymer or both natural and synthetic polymers.

Examples of natural polymers include proteins and sugars such as deoxyribonucleic acid, rubber, cellulose, starch (e.g., amylose, amylopectin), proteins, enzymes, polysaccharides, silks, polyhydroxyalkanoates, chitosan, dextran, collagen, carrageenan, ispaghula, acacia, agar, gelatin, shellac, sterculia gum, xanthan gum, corn sugar gum, guar gum, gum karaya, agarose, alginic acid, alginate, or natural polymers thereof.

Examples of synthetic polymers include acrylics, nylons, silicones, spandex, viscose rayon, polycarboxylic acids, polyvinyl acetate, polyacrylamide, polyacrylate, polyethylene glycol, polyurethanes, polylactic acid, silica, polystyrene, polyacrylonitrile, polybutadiene, polycarbonate, polyethylene, polyethylene terephthalate, poly(chlorotrifluoroethylene), poly(ethylene oxide), poly(ethylene terephthalate), polyethylene, polyisobutylene, poly(methyl methacrylate), poly(oxymethylene), polyformaldehyde, polypropylene, polystyrene, poly(tetrafluoroethylene), poly(vinyl acetate), poly(vinyl alcohol), poly(vinyl chloride), poly(vinylidene dichloride), poly(vinylidene difluoride), poly(vinyl fluoride) and/or combinations (e.g., co-polymers) thereof. Beads may also be formed from materials other than polymers, including lipids, micelles, ceramics, glass-ceramics, material composites, metals, other inorganic materials, and others.

In some instances, the particle, e.g., the bead, may contain molecular precursors (e.g., monomers or polymers), which may form a polymer network via polymerization of the molecular precursors. In some cases, a precursor may be an already polymerized species capable of undergoing further polymerization via, for example, a chemical cross-linkage. In some cases, a precursor can comprise one or more of an acrylamide or a methacrylamide monomer, oligomer, or polymer. In some cases, the particle, e.g., the bead, may comprise prepolymers, which are oligomers capable of further polymerization. For example, polyurethane beads may be prepared using prepolymers. In some cases, the particle, e.g., the bead, may contain individual polymers that may be further polymerized together. In some cases, particles, e.g., beads, may be generated via polymerization of different precursors, such that they comprise mixed polymers, co-polymers, and/or block co-polymers. In some cases, the particle, e.g., the bead, may comprise covalent or ionic bonds between polymeric precursors (e.g., monomers, oligomers, linear polymers), oligonucleotides, primers, and other entities. In some cases, the covalent bonds can be carbon-carbon bonds or thioether bonds.

Cross-linking may be permanent or reversible, depending upon the particular cross-linker used. Reversible cross-linking may allow for the polymer to linearize or dissociate under appropriate conditions. In some cases, reversible cross-linking may also allow for reversible attachment of a material bound to the surface of a bead. In some cases, a cross-linker may form disulfide linkages. In some cases, the chemical cross-linker forming disulfide linkages may be cystamine or a modified cystamine.

Particles, e.g., beads, may be of uniform size or heterogeneous size. In some cases, the diameter of a particle, e.g., a bead, may be at least about 1 micrometer (μm), 5 μm, 10 μm, 20 μm, 30 μm, 40 μm, 50 μm, 60 μm, 70 μm, 80 μm, 90 μm, 100 μm, 250 μm, 500 μm, 1 mm, or greater. In some cases, a particle, e.g., a bead, may have a diameter of less than about 1 μm, 5 μm, 10 μm, 20 μm, 30 μm, 40 μm, 50 μm, 60 μm, 70 μm, 80 μm, 90 μm, 100 μm, 250 μm, 500 μm, 1 mm, or less. In some cases, a particle, e.g., a bead, may have a diameter in the range of about 40-75 μm, 30-75 μm, 20-75 μm, 40-85 μm, 40-95 μm, 20-100 μm, 10-100 μm, 1-100 μm, 20-250 μm, or 20-500 μm. The size of a particle, e.g., a bead, e.g., a gel bead, used to produce droplets is typically on the order of a cross section of the first channel (width or depth). In some cases, the gel beads are larger than the width and/or depth of the first channel and/or shelf, e.g., at least 1.5×, 2×, 3×, or 4× larger than the width and/or depth of the first channel and/or shelf.

In certain embodiments, particles, e.g., beads, can be provided as a population or plurality of particles, e.g., beads, having a relatively monodisperse size distribution. Where it may be desirable to provide relatively consistent amounts of reagents within droplets, maintaining relatively consistent particle, e.g., bead, characteristics, such as size, can contribute to the overall consistency. In particular, the particles, e.g., beads, described herein may have size distributions that have a coefficient of variation in their cross-sectional dimensions of less than 50%, less than 40%, less than 30%, less than 20%, and in some cases less than 15%, less than 10%, less than 5%, or less.

Particles may be of any suitable shape. Examples of particles, e.g., beads, shapes include, but are not limited to, spherical, non-spherical, oval, oblong, amorphous, circular, cylindrical, and variations thereof.

A particle, e.g., bead, injected or otherwise introduced into a droplet may comprise releasably, cleavably, or reversibly attached analyte moieties (e.g., barcodes). A particle, e.g., bead, injected or otherwise introduced into a droplet may comprise activatable analyte moieties (e.g., barcodes). A particle, e.g., bead, injected or otherwise introduced into a droplet may be a degradable, disruptable, or dissolvable particle, e.g., a dissolvable bead.

Particles, e.g., beads, within a channel may flow at a substantially regular flow profile (e.g., at a regular flow rate). Such regular flow profiles can permit a droplet, when formed, to include a single particle (e.g., bead) and a single cell, single nucleus, or other biological particle. Such regular flow profiles may permit the droplets to have an dual occupancy (e.g., droplets having at least one bead and at least one cell, one nucleus, or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. In some embodiments, the droplets have a 1:1 dual occupancy (i.e., droplets having exactly one particle (e.g., bead) and exactly one cell, one nucleus or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. Such regular flow profiles and devices that may be used to provide such regular flow profiles are provided, for example, in U.S. Patent Publication No. 2015/0292988, which is entirely incorporated herein by reference.

As discussed above, analyte moieties (e.g., barcodes) can be releasably, cleavably or reversibly attached to the particles, e.g., beads, such that analyte moieties (e.g., barcodes) can be released or be releasable through cleavage of a linkage between the barcode molecule and the particle, e.g., bead, or released through degradation of the particle (e.g., bead) itself, allowing the barcodes to be accessed or be accessible by other reagents, or both. Releasable analyte moieties (e.g., barcodes) may sometimes be referred to as activatable analyte moieties (e.g., activatable barcodes), in that they are available for reaction once released.

Thus, for example, an activatable analyte-moiety (e.g., activatable barcode) may be activated by releasing the analyte moiety (e.g., barcode) from a particle, e.g., bead (or other suitable type of droplet described herein). Other activatable configurations are also envisioned in the context of the described methods and systems.

In addition to, or as an alternative to the cleavable linkages between the particles, e.g., beads, and the associated moieties, such as barcode containing nucleic acids (e.g., oligonucleotides), the particles, e.g., beads may be degradable, disruptable, or dissolvable spontaneously or upon exposure to one or more stimuli (e.g., temperature changes, pH changes, exposure to particular chemical species or phase, exposure to light, reducing agent, etc.). In some cases, a particle, e.g., bead, may be dissolvable, such that material components of the particle, e.g., bead, are degraded or solubilized when exposed to a particular chemical species or an environmental change, such as a change temperature or a change in pH. In some cases, a gel bead can be degraded or dissolved at elevated temperature and/or in basic conditions. In some cases, a particle, e.g., bead, may be thermally degradable such that when the particle, e.g., bead, is exposed to an appropriate change in temperature (e.g., heat), the particle, e.g., bead, degrades. Degradation or dissolution of a particle (e.g., bead) bound to a species (e.g., a nucleic acid, e.g., an oligonucleotide, e.g., barcoded oligonucleotide) may result in release of the species from the particle, e.g., bead. As will be appreciated from the above disclosure, the degradation of a particle, e.g., bead, may refer to the disassociation of a bound or entrained species from a particle, e.g., bead, both with and without structurally degrading the physical particle, e.g., bead, itself. For example, entrained species may be released from particles, e.g., beads, through osmotic pressure differences due to, for example, changing chemical environments. By way of example, alteration of particle, e.g., bead, pore sizes due to osmotic pressure differences can generally occur without structural degradation of the particle, e.g., bead, itself. In some cases, an increase in pore size due to osmotic swelling of a particle (e.g., a bead or a liposome), can permit the release of entrained species within the particle. In other cases, osmotic shrinking of a particle may cause the particle, e.g., bead, to better retain an entrained species due to pore size contraction.

A degradable particle, e.g., bead, may be introduced into a droplet, such that the particle, e.g., bead, degrades within the droplet and any associated species (e.g., nucleic acids, oligonucleotides, or fragments thereof) are released within the droplet when the appropriate stimulus is applied. The free species (e.g., nucleic acid, oligonucleotide, or fragment thereof) may interact with other reagents contained in the droplet. For example, a polyacrylamide bead comprising cystamine and linked, via a disulfide bond, to a barcode sequence, may be combined with a reducing agent within a droplet of a water-in-oil emulsion. Within the droplet, the reducing agent can break the various disulfide bonds, resulting in particle, e.g., bead, degradation and release of the barcode sequence into the aqueous, inner environment of the droplet. In another example, heating of a droplet comprising a particle-, e.g., bead-, bound analyte moiety (e.g., barcode) in basic solution may also result in particle, e.g., bead, degradation and release of the attached barcode sequence into the aqueous, inner environment of the droplet.

Any suitable number of analyte moieties (e.g., molecular tag molecules (e.g., primer, barcoded oligonucleotide, etc.)) can be associated with a particle, e.g., bead, such that, upon release from the particle, the analyte moieties (e.g., molecular tag molecules (e.g., primer, e.g., barcoded oligonucleotide, etc.)) are present in the droplet at a pre-defined concentration. Such pre-defined concentration may be selected to facilitate certain reactions for generating a sequencing library, e.g., amplification, within the droplet. In some cases, the pre-defined concentration of a primer can be limited by the process of producing oligonucleotide-bearing particles, e.g., beads.

Additional reagents may be included as part of the particles (e.g., analyte moieties) and/or in solution or dispersed in the droplet, for example, to activate, mediate, or otherwise participate in a reaction, e.g., between the analyte and analyte moiety.

Biological Samples

A droplet of the invention may include biological particles (e.g., cells, nuclei, or particulate components thereof) and/or macromolecular constituents thereof (e.g., components of cells (e.g., intracellular or extracellular proteins, nucleic acids, glycans, or lipids) or products of cells (e.g., secretion products)). An analyte from a biological particle, e.g., component or product thereof, may be considered to be a bioanalyte. In some embodiments, a biological particle, e.g., cell, nucleus, or product thereof is included in a droplet, e.g., with one or more particles (e.g., beads) having an analyte moiety. A biological particle, e.g., cell, nucleus, and/or components or products thereof can, in some embodiments, be encased inside a gel, such as via polymerization of a droplet containing the biological particle and precursors capable of being polymerized or gelled.

Biological samples may also be processed to provide cell beads for use with methods and systems described herein. A cell bead can be a biological particle and/or one or more of its macromolecular constituents encased inside of a gel or polymer matrix, such as via polymerization of a droplet containing the biological particle and precursors capable of being polymerized or gelled. Polymeric precursors (as described herein) may be subjected to conditions sufficient to polymerize or gel the precursors thereby forming a polymer or gel around the biological particle. A cell bead can contain biological particles (e.g., a cell or an organelle of a cell) or macromolecular constituents (e.g., RNA, DNA, proteins, etc.) of biological particles. A cell bead may include a single cell/nucleus or multiple cells/nuclei, or a derivative of the single cell/nucleus or multiple cells/nuclei. For example, after lysing and washing the cells, inhibitory components from cell lysates can be washed away and the macromolecular constituents can be bound as cell beads.

Systems and methods disclosed herein can be applicable to both cell beads (and/or droplets or other partitions) containing biological particles and cell beads (and/or droplets or other partitions) containing macromolecular constituents of biological particles. Cell beads may be or include a cell, nuclei, cell derivative, cellular material and/or material derived from the cell in, within, or encased in a matrix, such as a polymeric matrix. In some cases, a cell bead may comprise a live cell. In some instances, the live cell may be capable of being cultured when enclosed in a gel or polymer matrix, or of being cultured when comprising a gel or polymer matrix. In some instances, the polymer or gel may be diffusively permeable to certain components and diffusively impermeable to other components (e.g., macromolecular constituents). It will be appreciated that other techniques for generating and utilizing cell beads can be used with the present invention, see, e.g., U.S. Pat. Nos. 10,590,244 and 10,428,326, as well as U.S. Pat. Pub. Nos. 2019/0233878, each of which is hereby incorporated by reference in its entirety.

In the case of encapsulated biological particles (e.g., cells, nuclei, or particulate components thereof, or cell beads), a biological particle may be included in a droplet that contains lysis reagents in order to release the contents (e.g., contents containing one or more analytes (e.g., bioanalytes)) of the biological particles within the droplet. In such cases, the lysis agents can be contacted with the biological particle suspension concurrently with, or immediately prior to the introduction of the biological particles into the droplet source region, for example, through an additional channel or channels upstream or proximal to a second channel or a third channel that is upstream or proximal to a second droplet source region. Examples of lysis agents include bioactive reagents, such as lysis enzymes that are used for lysis of different cell types, e.g., gram positive or negative bacteria, plants, yeast, mammalian, etc., such as lysozymes, achromopeptidase, lysostaphin, labiase, kitalase, lyticase, and a variety of other lysis enzymes available from, e.g., Sigma-Aldrich, Inc. (St Louis, Mo.), as well as other commercially available lysis enzymes. Other lysis agents may additionally or alternatively be contained in a droplet with the biological particles (e.g., cells, nuclei, or particulate components thereof) to cause the release of the biological particles' contents into the droplets.

For example, in some cases, surfactant based lysis solutions may be used to lyse cells, although these may be less desirable for emulsion based systems where the surfactants can interfere with stable emulsions. In some cases, lysis solutions may include non-ionic surfactants such as, for example, TritonX-100 and Tween 20. In some cases, lysis solutions may include ionic surfactants such as, for example, sarcosyl and sodium dodecyl sulfate (SDS). In some embodiments, lysis solutions are hypotonic, thereby lysing cells by osmotic shock. Electroporation, thermal, acoustic or mechanical cellular disruption may also be used in certain cases, e.g., non-emulsion based droplet formation such as encapsulation of biological particles that may be in addition to or in place of droplet formation, where any pore size of the encapsulate is sufficiently small to retain nucleic acid fragments of a desired size, following cellular disruption.

In addition to the lysis agents, other reagents can also be included in droplets with the biological particles, including, for example, DNase and RNase inactivating agents or inhibitors, such as proteinase K, chelating agents, such as EDTA, and other reagents employed in removing or otherwise reducing negative activity or impact of different cell lysate components on subsequent processing of nucleic acids. In addition, in the case of encapsulated biological particles (e.g., cells, nuclei, or particulate components thereof), the biological particles may be exposed to an appropriate stimulus to release the biological particles or their contents from a particle (e.g., a bead or a microcapsule) within a droplet. For example, in some cases, a chemical stimulus may be included in a droplet along with an encapsulated biological particle to allow for degradation of the encapsulating matrix and release of the cell/nucleus or its contents into the larger droplet. In some cases, this stimulus may be the same as the stimulus described elsewhere herein for release of analyte moieties (e.g., oligonucleotides) from their respective particle (e.g., bead). In alternative aspects, this may be a different and non-overlapping stimulus, in order to allow an encapsulated biological particle to be released into a droplet at a different time from the release of analyte moieties (e.g., oligonucleotides) into the same droplet.

Additional reagents may also be included in droplets with the biological particles, such as endonucleases to fragment a biological particle's DNA, DNA polymerase enzymes and dNTPs used to amplify the biological particle's nucleic acid fragments and to attach the barcode molecular tags to the amplified fragments. Other reagents may also include reverse transcriptase enzymes, including enzymes with terminal transferase activity, primers and oligonucleotides, and switch oligonucleotides (also referred to herein as “switch oligos” or “template switching oligonucleotides”) which can be used for template switching. In some cases, template switching can be used to increase the length of a cDNA. In some cases, template switching can be used to append a predefined nucleic acid sequence to the cDNA. In an example of template switching, cDNA can be generated from reverse transcription of a template, e.g., cellular mRNA, where a reverse transcriptase with terminal transferase activity can add additional nucleotides, e.g., polyC, to the cDNA in a template independent manner. Switch oligos can include sequences complementary to the additional nucleotides, e.g., polyG. The additional nucleotides (e.g., polyC) on the cDNA can hybridize to the additional nucleotides (e.g., polyG) on the switch oligo, whereby the switch oligo can be used by the reverse transcriptase as template to further extend the cDNA. Template switching oligonucleotides may comprise a hybridization region and a template region. The hybridization region can comprise any sequence capable of hybridizing to the target. In some cases, as previously described, the hybridization region comprises a series of G bases to complement the overhanging C bases at the 3′ end of a cDNA molecule. The series of G bases may comprise 1 G base, 2 G bases, 3 G bases, 4 G bases, 5 G bases or more than 5 G bases. The template sequence can comprise any sequence to be incorporated into the cDNA. In some cases, the template region comprises at least 1 (e.g., at least 2, 3, 4, 5 or more) tag sequences and/or functional sequences. Switch oligos may comprise deoxyribonucleic acids; ribonucleic acids; modified nucleic acids including 2-Aminopurine, 2,6-Diaminopurine (2-Amino-dA), inverted dT, 5-Methyl dC, 2′-deoxyinosine, Super T (5-hydroxybutynl-2′-deoxyuridine), Super G (8-aza-7-deazaguanosine), locked nucleic acids (LNAs), unlocked nucleic acids (UNAs, e.g., UNA-A, UNA-U, UNA-C, UNA-G), Iso-dG, Iso-dC, 2′ Fluoro bases (e.g., Fluoro C, Fluoro U, Fluoro A, and Fluoro G), or any combination.

In some cases, the length of a switch oligo may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124,125, 126, 127, 128, 129, 130, 131, 132, 133, 134, 135, 136, 137, 138, 139, 140, 141, 142, 143, 144, 145,146, 147, 148, 149, 150, 151, 152, 153, 154, 155, 156, 157, 158, 159, 160, 161, 162, 163, 164, 165, 166,167, 168, 169, 170, 171, 172, 173, 174, 175, 176, 177, 178, 179, 180, 181, 182, 183, 184, 185, 186, 187,188, 189, 190, 191, 192, 193, 194, 195, 196, 197, 198,199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250 nucleotides or longer.

In some cases, the length of a switch oligo may be at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122,123, 124, 125, 126, 127, 128, 129, 130, 131, 132, 133, 134, 135, 136, 137, 138, 139, 140, 141, 142, 143,144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185,186, 187, 188, 189, 190, 191, 192, 193, 194, 195, 196, 197, 198,199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides or longer.

In some cases, the length of a switch oligo may be at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143,144, 145, 146, 147, 148, 149, 150, 151, 152, 153, 154, 155, 156, 157, 158, 159, 160, 161, 162, 163, 164,165, 166, 167, 168, 169, 170, 171, 172, 173, 174, 175, 176, 177, 178, 179, 180, 181, 182, 183, 184, 185,186, 187, 188, 189, 190, 191, 192, 193, 194, 195, 196, 197, 198,199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides.

Once the contents of the cells are released into their respective droplets, the macromolecular components (e.g., macromolecular constituents of biological particles, such as RNA, DNA, or proteins) contained therein may be further processed within the droplets.

As described above, the macromolecular components (e.g., bioanalytes) of individual biological particles (e.g., cells, nuclei, or particulate components thereof) can be provided with unique identifiers (e.g., barcodes) such that upon characterization of those macromolecular components, at which point components from a heterogeneous population of cells may have been mixed and are interspersed or solubilized in a common liquid, any given component (e.g., bioanalyte) may be traced to the biological particle (e.g., cell or nucleus) from which it was obtained. The ability to attribute characteristics to individual biological particles or groups of biological particles is provided by the assignment of unique identifiers specifically to an individual biological particle or groups of biological particles. Unique identifiers, for example, in the form of nucleic acid barcodes, can be assigned or associated with individual biological particles (e.g., cells or nuclei) or populations of biological particles (e.g., cells or nuclei), in order to tag or label the biological particle's macromolecular components (and as a result, its characteristics) with the unique identifiers. These unique identifiers can then be used to attribute the biological particle's components and characteristics to an individual biological particle or group of biological particles. This can be performed by forming droplets including the individual biological particle or groups of biological particles with the unique identifiers (via particles, e.g., beads), as described in the systems and methods herein.

In some aspects, the unique identifiers are provided in the form of oligonucleotides that comprise nucleic acid barcode sequences that may be attached to or otherwise associated with the nucleic acid contents of individual biological particle, or to other components of the biological particle, and particularly to fragments of those nucleic acids. The oligonucleotides are partitioned such that as between oligonucleotides in a given droplet, the nucleic acid barcode sequences contained therein are the same, but as between different droplets, the oligonucleotides can, and do have differing barcode sequences, or at least represent a large number of different barcode sequences across all of the droplets in a given analysis. In some aspects, only one nucleic acid barcode sequence can be associated with a given droplet, although in some cases, two or more different barcode sequences may be present.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter.

These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Analyte moieties (e.g., oligonucleotides) in droplets can also include other functional sequences useful in processing of nucleic acids from biological particles contained in the droplet. These sequences include, for example, targeted or random/universal amplification primer sequences for amplifying the genomic DNA from the individual biological particles within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

Other mechanisms of forming droplets containing oligonucleotides may also be employed, including, e.g., coalescence of two or more droplets, where one droplet contains oligonucleotides, or microdispensing of oligonucleotides into droplets, e.g., droplets within microfluidic systems.

In an example, particles (e.g., beads) are provided that each include large numbers of the above described barcoded oligonucleotides releasably attached to the beads, where all of the oligonucleotides attached to a particular bead will include the same nucleic acid barcode sequence, but where a large number of diverse barcode sequences are represented across the population of beads used. In some embodiments, hydrogel beads, e.g., beads having polyacrylamide polymer matrices, are used as a solid support and delivery vehicle for the oligonucleotides into the droplets, as they are capable of carrying large numbers of oligonucleotide molecules, and may be configured to release those oligonucleotides upon exposure to a particular stimulus, as described elsewhere herein. In some cases, the population of beads will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more. Additionally, each bead can be provided with large numbers of oligonucleotide molecules attached. In particular, the number of molecules of oligonucleotides including the barcode sequence on an individual bead can be at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules, or more.

Moreover, when the population of beads are included in droplets, the resulting population of droplets can also include a diverse barcode library that includes at least about 1,000 different barcode sequences, at least about 5,000 different barcode sequences, at least about 10,000 different barcode sequences, at least at least about 50,000 different barcode sequences, at least about 100,000 different barcode sequences, at least about 1,000,000 different barcode sequences, at least about 5,000,000 different barcode sequences, or at least about 10,000,000 different barcode sequences. Additionally, each droplet of the population can include at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules.

In some cases, it may be desirable to incorporate multiple different barcodes within a given droplet, either attached to a single or multiple particles, e.g., beads, within the droplet. For example, in some cases, mixed, but known barcode sequences set may provide greater assurance of identification in the subsequent processing, for example, by providing a stronger address or attribution of the barcodes to a given droplet, as a duplicate or independent confirmation of the output from a given droplet.

Oligonucleotides may be releasable from the particles (e.g., beads) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature of the particle, e.g., bead, environment will result in cleavage of a linkage or other release of the oligonucleotides form the particles, e.g., beads. In still other cases, a chemical stimulus is used that cleaves a linkage of the oligonucleotides to the beads, or otherwise results in release of the oligonucleotides from the particles, e.g., beads. In one case, such compositions include the polyacrylamide matrices described above for encapsulation of biological particles, and may be degraded for release of the attached oligonucleotides through exposure to a reducing agent, such as dithiothreitol (DTT).

The droplets described herein may contain either one or more biological particles (e.g., cells, nuclei, or particulate components thereof), either one or more barcode carrying particles, e.g., beads, or both at least a biological particle and at least a barcode carrying particle, e.g., bead. In some instances, a droplet may be unoccupied and contain neither biological particles nor barcode-carrying particles, e.g., beads. As noted previously, by controlling the flow characteristics of each of the liquids combining at the droplet source region(s), as well as controlling the geometry of the droplet source region(s), droplet formation can be optimized to achieve a desired occupancy level of particles, e.g., beads, biological particles, or both, within the droplets that are generated.

Kits and Systems

Devices of the invention may be combined with various external components, e.g., pumps, reservoirs, or controllers, reagents, e.g., analyte moieties, liquids, particles (e.g., beads), and/or sample in the form of kits and systems.

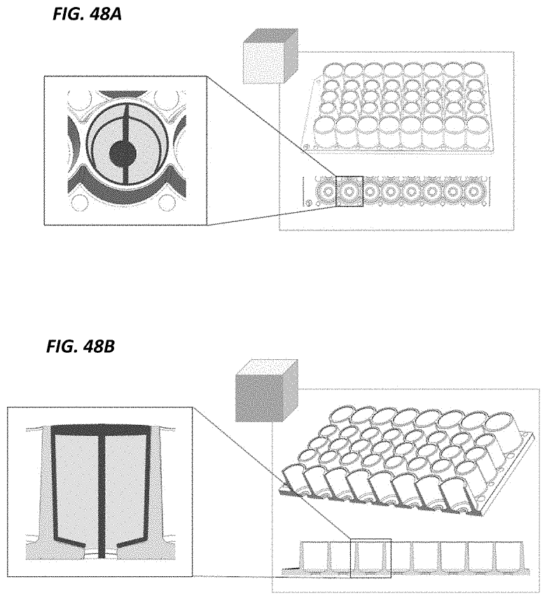

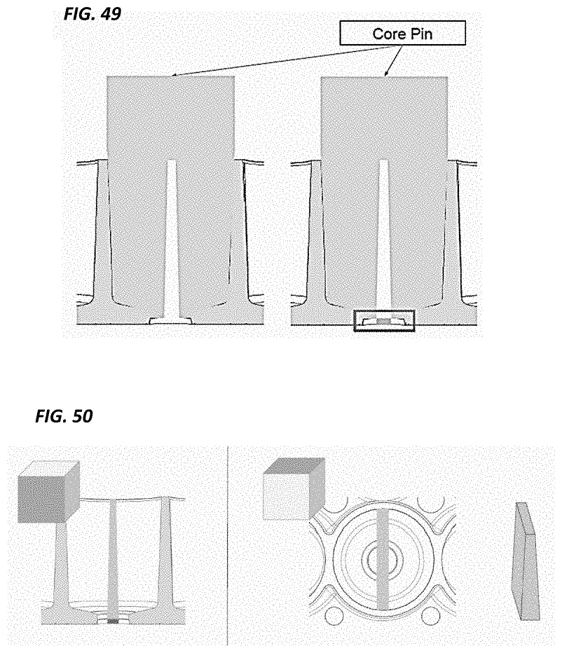

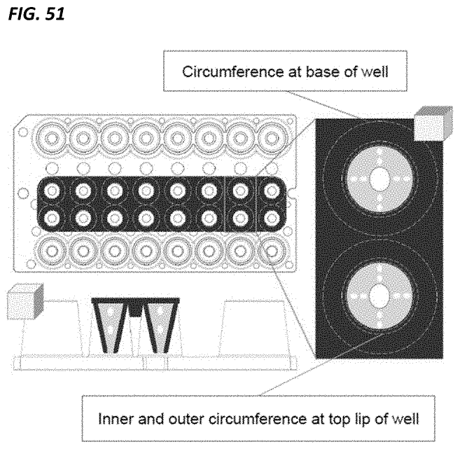

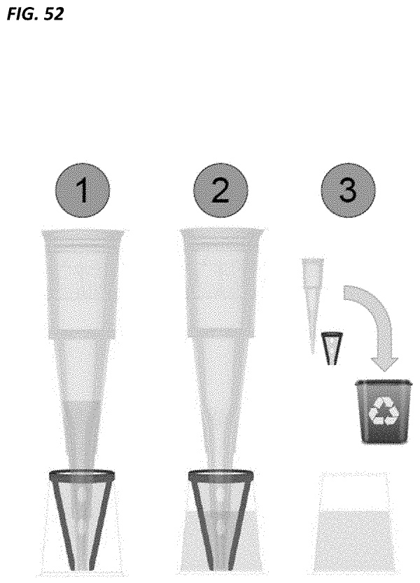

Kits and systems of the invention may include inserts, e.g., to fluidically separate droplet source regions in a common reservoir, or to assist with liquid handling operations, e.g., priming of wells by pipette. Inserts may be pre-inserted or may be inserted by the user. Inserts may fit in an individual well, reservoir, inlet, etc., or may fit in multiple wells, inlets, reservoirs, etc., simultaneously. Inserts may be removable or designed to remain within the device once inserted. An example of an insert of the invention is shown in FIGS. 48A and 48B, which divides a collection reservoir into two fluidically separated regions. Such an insert can prevent droplet failures from one droplet source region from impacting droplets produced in other droplet source regions that fluidically connect to the collection reservoir. Another example of an insert of the invention is shown in FIGS. 51 and 52, which detail an insert for priming, which guides a pipette tip, e.g., to the center of a sample and/or reagent inlet, and prevents collision of the pipette tip with the walls of the inlet, which can result in errors or damage.

Methods

The methods described herein to generate droplets, e.g., of uniform and predictable content, and with high throughput, may be used to greatly increase the efficiency of single cell applications and/or other applications receiving droplet-based input. Such single cell applications and other applications may often be capable of processing a certain range of droplet sizes. The methods may be employed to generate droplets for use as microscale chemical reactors, where the volumes of the chemical reactants are small (˜pLs).

Methods of the invention include the step of allowing one or more liquids to flow from the channels (e.g., the first, second, and optional third channel) to the droplet source region.

The methods disclosed herein may produce emulsions, generally, i.e., droplet of a dispersed phases in a continuous phase. For example, droplets may include a first liquid (and optionally a third liquid, and, further, optionally a fourth liquid), and the other liquid may be a second liquid. The first liquid may be substantially immiscible with the second liquid. In some instances, the first liquid may be an aqueous liquid or may be substantially miscible with water. Droplets produced according to the methods disclosed herein may combine multiple liquids. For example, a droplet may combine a first and third liquids. The first liquid may be substantially miscible with the third liquid. The second liquid may be an oil, as described herein.

A variety of applications require the evaluation of the presence and quantification of different biological particle or organism types within a population of biological particles, including, for example, microbiome analysis and characterization, environmental testing, food safety testing, epidemiological analysis, e.g., in tracing contamination or the like.

The methods described herein may allow for the production of one or more droplets containing a single particle, e.g., bead, and/or single biological particle (e.g., cell, nucleus, or particulate component thereof) with uniform and predictable droplet content. The methods described herein may allow for the production of one or more droplets containing a single particle, e.g., bead, and/or single biological particle (e.g., cell or nucleus) with uniform and predictable droplet size. The methods may also allow for the production of one or more droplets comprising a single biological particle (e.g., cell or nucleus) and more than one particle, e.g., bead, one or more droplets comprising more than one biological particle (e.g., cell or nucleus) and a single particle, e.g., bead, and/or one or more droplets comprising more than one biological particle (e.g., cell, nucleus, or particulate component thereof) and more than one particle, e.g., beads. The methods may also allow for increased throughput of droplet formation.

Droplets are in general formed by allowing a first liquid, or a combination of a first liquid with a third liquid and optionally fourth liquid, to flow into a second liquid in a droplet source region, where droplets spontaneously form as described herein. The droplet content uniformity may be controlled using, e.g., funnels (e.g., funnels including hurdles), side channels, and/or mixers.

Mixers can be used to mix two liquid streams, e.g., before the droplet formation. Mixing two liquids is advantageous for controlling content uniformity of liquid streams and of droplets formed from such liquid streams. For example, one liquid (e.g., a third or fourth liquid) and another liquid (e.g., a first, third, or fourth liquid) may be combined at an intersection of two channels (e.g., an intersection of a first side-channel and a second channel, or an intersection of a second channel and a third channel). The one liquid may contain a biological particle (e.g., a cell, nucleus, or particulate component thereof), and the other liquid may contain reagents. By using a mixer, the two liquids can be rapidly mixed, thereby reducing localized high concentrations of lysing reagents. Thus, biological particle lysis may be reduced or eliminated until the droplet formation.

The mixer may be included downstream of an intersection between the second and third channels. In this configuration, a third liquid may be combined with a fourth liquid at the intersection. The combined third and fourth liquids may be mixed in the second channel mixer. The mixed third and fourth liquids may then be combined with a first liquid at an intersection between the first and second channels downstream from the mixer.

Alternatively, the mixer may be included downstream of an intersection between a first side-channel and a second channel. For example, a mixer may be included in the first side-channel between an intersection of the first side-channel with the second channel and an intersection of the first side-channel with the first channel. In this configuration, a first liquid flowing through the first side-channel may be combined with the third liquid at the intersection of the first side-channel with the second channel. The combined first and third liquids may be mixed in the first side-channel mixer and are then combined with the liquid in the first channel.

In methods described herein, funnels and/or side-channels may be used to control particle (e.g., bead) flow, e.g., to provide evenly spaced particles (e.g., beads). The evenly spaced particles may be used for forming droplets containing a single particle. Methods described herein including a step of allowing a liquid (e.g., a first liquid) to flow from the first channel to the droplet source region may include allowing the liquid to flow through the first side-channel and optionally through the second side-channel.

The droplets may comprise an aqueous liquid dispersed phase within a non-aqueous continuous phase, such as an oil phase. In some cases, droplet formation may occur in the absence of externally driven movement of the continuous phase, e.g., a second liquid, e.g., an oil. As discussed above, the continuous phase may nonetheless be externally driven, even though it is not required for droplet formation. Emulsion systems for creating stable droplets in non-aqueous (e.g., oil) continuous phases are described in detail in, for example, U.S. Pat. No. 9,012,390, which is entirely incorporated herein by reference for all purposes. Alternatively or in addition, the droplets may comprise, for example, micro-vesicles that have an outer barrier surrounding an inner liquid center or core. In some cases, the droplets may comprise a porous matrix that is capable of entraining and/or retaining materials within its matrix. A variety of different vessels are described in, for example, U.S. Patent Application Publication No. 2014/0155295, which is entirely incorporated herein by reference for all purposes. The droplets can be collected in a substantially stationary volume of liquid, e.g., with the buoyancy of the formed droplets moving them out of the path of nascent droplets (up or down depending on the relative density of the droplets and continuous phase). Alternatively or in addition, the formed droplets can be moved out of the path of nascent droplets actively, e.g., using a gentle flow of the continuous phase, e.g., a liquid stream or gently stirred liquid.

Allocating supports, e.g., particles (e.g., beads carrying barcoded oligonucleotides) or biological particles (e.g., cells, nuclei or particulate components thereof) to discrete droplets may generally be accomplished by introducing a flowing stream of particles, e.g., beads, in an aqueous liquid into a flowing stream or non-flowing reservoir of a non-aqueous liquid, such that droplets are generated. In some instances, the occupancy of the resulting droplets (e.g., number of particles, e.g., beads, per droplet) can be controlled by providing the aqueous stream at a certain concentration or frequency of particles, e.g., beads. In some instances, the occupancy of the resulting droplets can also be controlled by adjusting one or more geometric features at the droplet source region, such as a width of a fluidic channel carrying the particles, e.g., beads, relative to a diameter of a given particles, e.g., beads.

Where single particle-, e.g., bead-, containing droplets are desired, the relative flow rates of the liquids can be selected such that, on average, the droplets contain fewer than one particle, e.g., bead, per droplet in order to ensure that those droplets that are occupied are primarily singly occupied. In some embodiments, the relative flow rates of the liquids can be selected such that a majority of droplets are occupied, for example, allowing for only a small percentage of unoccupied droplets. The flows and channel architectures can be controlled as to ensure a desired number of singly occupied droplets, less than a certain level of unoccupied droplets and/or less than a certain level of multiply occupied droplets.

The methods described herein can be operated such that a majority of occupied droplets include no more than one biological particle per occupied droplet. In some cases, the droplet formation process is conducted such that fewer than 25% of the occupied droplets contain more than one biological particle (e.g., multiply occupied droplets), and in many cases, fewer than 20% of the occupied droplets have more than one biological particle. In some cases, fewer than 10% or even fewer than 5% of the occupied droplets include more than one biological particle per droplet.

It may be desirable to avoid the creation of excessive numbers of empty droplets, for example, from a cost perspective and/or efficiency perspective. However, while this may be accomplished by providing sufficient numbers of particles, e.g., beads, into the droplet source region, the Poisson distribution may expectedly increase the number of droplets that may include multiple biological particles. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles, or liquids directed into the droplet source region can be conducted using devices and systems of the invention (e.g., those including one or more side-channels and/or funnels) such that, in many cases, no more than about 50% of the generated droplets, no more than about 25% of the generated droplets, or no more than about 10% of the generated droplets are unoccupied. These flows can be controlled so as to present non-Poisson distribution of singly occupied droplets while providing lower levels of unoccupied droplets. The above noted ranges of unoccupied droplets can be achieved while still providing any of the single occupancy rates described above. For example, in many cases, the use of the systems and methods described herein creates resulting droplets that have multiple occupancy rates of less than about 25%, less than about 20%, less than about 15%, less than about 10%, and in many cases, less than about 5%, while having unoccupied droplets of less than about 50%, less than about 40%, less than about 30%, less than about 20%, less than about 10%, less than about 5%, or less.

The flow of the first fluid may be such that the droplets contain a single particle, e.g., bead. In certain embodiments, the yield of droplets containing a single particle is at least 80%, e.g., at least 85%, at least 86%, at least 87%, at least 88%, at least 89%, at least 90%, at least 91%, at least 92%, at least 93%, at least 94%, at least 95%, at least 96%, at least 97%, at least 98%, or at least 99%.

As will be appreciated, the above-described occupancy rates are also applicable to droplets that include both biological particles (e.g., cells, nuclei, or particulate components thereof or cells incorporated into cell beads) and supports, e.g., particles such as beads (e.g., gel beads). The occupied droplets (e.g., at least about 10%, 20%, 30%, 40%, 50%, 60%, 70%, 80%, 90%, 95%, or 99% of the occupied droplets) can include both a bead and a biological particle. Supports, e.g., particles, e.g., beads, within a channel (e.g., a particle channel) may flow at a substantially regular flow profile (e.g., at a regular flow rate; e.g., the flow profile being controlled by one or more side-channels and/or one or more funnels) to provide a droplet, when formed, with a single particle (e.g., bead) and a single cell, single nucleus, or other biological particle (e.g., within a cell bead). Such regular flow profiles may permit the droplets to have a dual occupancy (e.g., droplets having at least one bead and at least one cell, one nucleus, or biological particle, e.g., within a cell bead) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. In some embodiments, the droplets have a 1:1 dual occupancy (i.e., droplets having exactly one particle (e.g., bead) and exactly one cell or biological particle, e.g., within a cell bead) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. Such regular flow profiles and devices that may be used to provide such regular flow profiles are provided, for example, in U.S. Patent Publication No. 2015/0292988, which is entirely incorporated herein by reference.

In some cases, additional particles may be used to deliver additional reagents to a droplet. In such cases, it may be advantageous to introduce different particles (e.g., beads) into a common channel (e.g., proximal to or upstream from a droplet source region) or droplet source intersection from different bead sources (e.g., containing different associated reagents) through different channel inlets into such common channel or droplet source region. In such cases, the flow and/or frequency of each of the different particle, e.g., bead, sources into the channel or fluidic connections may be controlled to provide for the desired ratio of particles, e.g., beads, from each source, while optionally ensuring the desired pairing or combination of such particles, e.g., beads, are formed into a droplet with the desired number of biological particles.

The droplets described herein may comprise small volumes, for example, less than about 10 microliters (μL), 5 μL, 1 μL, 900 picoliters (μL), 800 μL, 700 μL, 600 μL, 500 μL, 400 μL, 300 μL, 200 μL, 100 μL, 50 μL, 20 μL, 10 μL, 1 μL, 500 nanoliters (nL), 100 nL, 50 nL, or less. For example, the droplets may have overall volumes that are less than about 1000 μL, 900 μL, 800 μL, 700 μL, 600 μL, 500 μL, 400 μL, 300 μL, 200 μL, 100 μL, 50 μL, 20 μL, 10 μL, 1 μL, or less. Where the droplets further comprise supports (e.g., particles, such as beads), it will be appreciated that the sample liquid volume within the droplets may be less than about 90% of the above described volumes, less than about 80%, less than about 70%, less than about 60%, less than about 50%, less than about 40%, less than about 30%, less than about 20%, or less than about 10% the above described volumes (e.g., of a partitioning liquid), e.g., from 1% to 99%, from 5% to 95%, from 10% to 90%, from 20% to 80%, from 30% to 70%, or from 40% to 60%, e.g., from 1% to 5%, 5% to 10%, 10% to 15%, 15% to 20%, 20% to 25%, 25% to 30%, 30% to 35%, 35% to 40%, 40% to 45%, 45% to 50%, 50% to 55%, 55% to 60%, 60% to 65%, 65% to 70%, 70% to 75%, 75% to 80%, 80% to 85%, 85% to 90%, 90% to 95%, or 95% to 100% of the above described volumes.

Any suitable number of droplets can be generated. For example, in a method described herein, a plurality of droplets may be generated that comprises at least about 1,000 droplets, at least about 5,000 droplets, at least about 10,000 droplets, at least about 50,000 droplets, at least about 100,000 droplets, at least about 500,000 droplets, at least about 1,000,000 droplets, at least about 5,000,000 droplets at least about 10,000,000 droplets, at least about 50,000,000 droplets, at least about 100,000,000 droplets, at least about 500,000,000 droplets, at least about 1,000,000,000 droplets, or more. Moreover, the plurality of droplets may comprise both unoccupied droplets (e.g., empty droplets) and occupied droplets.

The fluid to be dispersed into droplets may be transported from a reservoir to the droplet source region.

Alternatively, the fluid to be dispersed into droplets is formed in situ by combining two or more fluids in the device. For example, the fluid to be dispersed may be formed by combining one fluid containing one or more reagents with one or more other fluids containing one or more reagents. In these embodiments, the mixing of the fluid streams may result in a chemical reaction. For example, when a particle is employed, a fluid having reagents that disintegrates the particle may be combined with the particle, e.g., immediately upstream of the droplet generating region. In these embodiments, the particles may be cells, which can be combined with lysing reagents, such as surfactants. When particles, e.g., beads, are employed, the particles, e.g., beads, may be dissolved or chemically degraded, e.g., by a change in pH (acid or base), redox potential (e.g., addition of an oxidizing or reducing agent), enzymatic activity, change in salt or ion concentration, or other mechanism.

The first fluid is transported through the first channel at a flow rate sufficient to produce droplets in the droplet source region. Faster flow rates of the first fluid generally increase the rate of droplet production; however, at a high enough rate, the first fluid will form a jet, which may not break up into droplets. Typically, the flow rate of the first fluid though the first channel may be between about 0.01 μL/min to about 100 L/min, e.g., 0.1 to 50 μL/min, 0.1 to 10 μL/min, or 1 to 5 μL/min. In some instances, the flow rate of the first liquid may be between about 0.04 μL/min and about 40 μL/min. In some instances, the flow rate of the first liquid may be between about 0.01 μL/min and about 100 L/min. Alternatively, the flow rate of the first liquid may be less than about 0.01 L/min. Alternatively, the flow rate of the first liquid may be greater than about 40 L/min, e.g., 45 L/min, 50 μL/min, 55 μL/min, 60 μL/min, 65 μL/min, 70 L/min, 75 μL/min, 80 μL/min, 85 L/min, 90 L/min, 95 μL/min, 100 μL/min, 110 L/min, 120 μL/min, 130 L/min, 140 μL/min, 150 μL/min, or greater. At lower flow rates, such as flow rates of about less than or equal to 10 μL/min, the droplet radius may not be dependent on the flow rate of first liquid. Alternatively, or in addition, for any of the abovementioned flow rates, the droplet radius may be independent of the flow rate of the first liquid.

The typical droplet formation rate for a single channel in a device of the invention is between 0.1 Hz to 10,000 Hz, e.g., 1 to 1000 Hz or 1 to 500 Hz. The use of multiple first channels can increase the rate of droplet formation by increasing the number of locations of formation.

As discussed above, droplet formation may occur in the absence of externally driven movement of the continuous phase. In such embodiments, the continuous phase flows in response to displacement by the advancing stream of the first fluid or other forces. Channels may be present in the droplet source region, e.g., including a shelf region, to allow more rapid transport of the continuous phase around the first fluid.

This increase in transport of the continuous phase can increase the rate of droplet formation. Alternatively, the continuous phase may be actively transported. For example, the continuous phase may be actively transported into the droplet source region, e.g., including a shelf region, to increase the rate of droplet formation; continuous phase may be actively transported to form a sheath flow around the first fluid as it exits the distal end; or the continuous phase may be actively transported to move droplets away from the point of formation.

Additional factors that affect the rate of droplet formation include the viscosity of the first fluid and of the continuous phase, where increasing the viscosity of either fluid reduces the rate of droplet formation. In certain embodiments, the viscosity of the first fluid and/or continuous is between 0.5 cP to 10 cP.

Furthermore, lower interfacial tension results in slower droplet formation. In certain embodiments, the interfacial tension is between 0.1 and 100 mN/m, e.g., 1 to 100 mN/m or 2 mN/m to 60 mN/m. The depth of the shelf region can also be used to control the rate of droplet formation, with a shallower depth resulting in a faster rate of formation.

The methods may be used to produce droplets in range of 1 μm to 500 μm in diameter, e.g., 1 to 250 μm, 5 to 200 μm, 5 to 150 μm, or 12 to 125 μm. Factors that affect the size of the droplets include the rate of formation, the cross-sectional dimension of the distal end of the first channel, the depth of the shelf, and fluid properties and dynamic effects, such as the interfacial tension, viscosity, and flow rate.

The first liquid may be aqueous, and the second liquid may be an oil (or vice versa). Examples of oils include perfluorinated oils, mineral oil, and silicone oils. For example, a fluorinated oil may include a fluorosurfactant for stabilizing the resulting droplets, for example, inhibiting subsequent coalescence of the resulting droplets. Examples of particularly useful liquids and fluorosurfactants are described, for example, in U.S. Pat. No. 9,012,390, which is entirely incorporated herein by reference for all purposes. Specific examples include hydrofluoroethers, such as HFE 7500, 7300, 7200, or 7100. Suitable liquids are those described in US 2015/0224466 and U.S. 62/522,292, the liquids of which are hereby incorporated by reference. In some cases, liquids include additional components such as a biological particle (e.g., a cell, nucleus, or particulate components thereof), or support, e.g., a particle, such as a bead (e.g., a gel bead). As discussed above, the first fluid or continuous phase may include reagents for carrying out various reactions, such as nucleic acid amplification, lysis, or bead dissolution. The first liquid or continuous phase may include additional components that stabilize or otherwise affect the droplets or a component inside the droplet. Such additional components include surfactants, antioxidants, preservatives, buffering agents, antibiotic agents, salts, chaotropic agents, enzymes, nanoparticles, and sugars.

Once formed, droplets may be manipulated, e.g., transported, detected, sorted, held, incubated, reacted, or demulsified. Droplets may be manipulated in a reservoir or reentrained into a channel for manipulation.

Reentrainment may occur by any mechanism, e.g., pressure, magnetic, electric, dielectrophoretic, optical, etc. Various generally applicable methods for reentrainment are described herein.

Devices, systems, compositions, and methods of the invention may be used for various applications, such as, for example, processing a single analyte (e.g., bioanalytes, e.g., RNA, DNA, or protein) or multiple analytes (e.g., bioanalytes, e.g., DNA and RNA, DNA and protein, RNA and protein, or RNA, DNA and protein) from a single cell or single nucleus. For example, a biological particle (e.g., a cell, a nucleus, or virus) can be formed in a droplet, and one or more analytes (e.g., bioanalytes) from the biological particle (e.g., cell or nucleus) can be modified or detected (e.g., bound or labeled) for subsequent processing. The multiple analytes may be from the single cell or the single nucleus. This process may enable, for example, proteomic, transcriptomic, and/or genomic analysis of the cell (or nucleus) or population thereof (e.g., simultaneous proteomic, transcriptomic, and/or genomic analysis of the cell (or nucleus) or population thereof).

Methods of modifying analytes include providing a plurality of particles (e.g., beads) in a liquid carrier (e.g., an aqueous carrier); providing a sample containing an analyte (e.g., as part of a cell or nucleus, or component or product thereof) in a sample liquid; and using the device to combine the liquids and form an analyte droplet containing one or more particles and one or more analytes (e.g., as part of one or more cells or nuclei, or components or products thereof). Such sequestration of one or more particles with analyte (e.g., bioanalyte associated with a cell or nucleus) in a droplet enables labeling of discrete portions of large, heterologous samples (e.g., single cells or nuclei within a heterologous population). Once labeled or otherwise modified, droplets can be combined (e.g., by breaking an emulsion), and the resulting liquid can be analyzed to determine a variety of properties associated with each of numerous single cells or nuclei.

In particular embodiments, the invention features methods of producing analyte droplets using a device having a particle channel (e.g., a first channel) and a sample channel (e.g., a second channel or a first side-channel that intersects a second channel) that intersect upstream of a droplet source region. Particles in a liquid carrier flow proximal-to-distal (e.g., towards the droplet source region) through the particle channel (e.g., a first channel) and a sample liquid containing an analyte flows in the proximal-to-distal direction (e.g., towards the droplet source region) through the sample channel (e.g., a second channel or a first side-channel that intersects a second channel) until the two liquids meet and combine at the intersection of the sample channel and the particle channel, upstream (and/or proximal to) the droplet source region. The combination of the liquid carrier with the sample liquid results in a droplet formation liquid. In some embodiments, the two liquids are miscible (e.g., they both contain solutes in water or aqueous buffer). The two liquids may be mixed in a mixer as described herein. The combination of the two liquids can occur at a controlled relative rate, such that the droplet formation liquid has a desired volumetric ratio of particle liquid to sample liquid, a desired numeric ratio of particles to cells, or a combination thereof (e.g., one particle per cell per 50 μL). As the droplet formation liquid flows through the droplet source region into a partitioning liquid (e.g., a liquid which is immiscible with the droplet formation liquid, such as an oil), analyte droplets form. These analyte droplets may continue to flow through one or more channels. Alternatively or in addition, the analyte droplets may accumulate (e.g., as a substantially stationary population) in a droplet collection region. In some cases, the accumulation of a population of droplets may occur by a gentle flow of a fluid within the droplet collection region, e.g., to move the formed droplets out of the path of the nascent droplets. In some cases, an insert may first be applied to a collection region in order to fluidically separate droplets which share a droplet source region.

In some embodiments, analyte droplets are formed at a droplet source region having a shelf region, where the droplet formation liquid expands in at least one dimension as it passes through the droplet source region. Any shelf region described herein can be useful in the methods of analyte droplet formation provided herein. Additionally or alternatively, the droplet source region may have a step at or distal to an inlet of the droplet source region (e.g., within the droplet source region or distal to the droplet source region). In some embodiments, analyte droplets are formed without externally driven flow of a continuous phase (e.g., by one or more crossing flows of liquid at the droplet source region). Alternatively, analyte droplets are formed in the presence of an externally driven flow of a continuous phase.

A device useful for droplet formation, may feature multiple droplet source regions (e.g., in or out of (e.g., as independent, parallel circuits) fluid communication with one another. For example, such a device may have 2-100, 3-50, 4-40, 5-30, 6-24, 8-18, or 9-12, e.g., 2-6, 6-12, 12-18, 18-24, 24-36, 36-48, or 48-96, e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or more droplet source regions configured to produce analyte droplets).

Source reservoirs can store liquids prior to and during droplet formation. In some embodiments, a device useful in analyte droplet formation includes one or more particle reservoirs connected proximally to one or more particle channels. Particle suspensions can be stored in particle reservoirs (e.g., a first reservoir) prior to analyte droplet formation. Particle reservoirs can be configured to store particles. For example, particle reservoirs can include, e.g., a coating to prevent adsorption or binding (e.g., specific or non-specific binding) of particles.

Additionally, or alternatively, a device includes one or more sample reservoirs connected proximally to one or more sample channels. Samples containing cells, nuclei, and/or other reagents useful in analyte droplet formation can be stored in sample reservoirs prior to analyte droplet formation. Sample reservoirs can be configured to reduce degradation of sample components, e.g., by including nuclease (e.g., DNAse or RNAse).

Methods of the invention may include adding a sample and/or particles to the device, for example, (a) by pipetting a sample liquid, or a component or concentrate thereof, into a sample reservoir (e.g., a second reservoir) and/or (b) by pipetting a liquid carrier (e.g., an aqueous carrier) and/or particles into a particle reservoir (e.g., a first reservoir). In some embodiments, the method involves first adding (e.g., pipetting) the liquid carrier (e.g., an aqueous carrier) and/or particles into the particle reservoir prior to adding (e.g., pipetting) the sample liquid, or a component or concentrate thereof, into the sample reservoir. In some embodiments, the liquid carrier added to the particle reservoir includes lysing reagents. Alternatively, the methods of the invention include adding a liquid (e.g., a fourth liquid) containing lysing reagent(s) to a lysing reagent reservoir (e.g., a third reservoir).

The sample reservoir and/or particle reservoir may be incubated in conditions suitable to preserve or promote activity of their contents until the initiation or commencement of droplet formation.

Formation of bioanalyte droplets, as provided herein, can be used for various applications. In particular, by forming bioanalyte droplets using the methods, devices, systems, and kits herein, a user can perform standard downstream processing methods to barcode heterogeneous populations of cells (or nuclei) or perform single-cell (or nucleus) nucleic acid sequencing.

In methods of barcoding a population of cells or nuclei, an aqueous sample having a population of cells or nuclei is combined with particles having a nucleic acid primer sequence and a barcode in an aqueous carrier at an intersection of the sample channel and the particle channel to form a reaction liquid. In some embodiments, the particles are in a liquid carrier including lysing reagents. For example, the liquid carrier including particles and a liquid carrier may be used in a device or system including a first side-channel intersection with a second channel. In some embodiments, the lysing reagents are included in a lysing liquid. For example, a lysing liquid may be used in a device or system including a second channel, a third channel, and an intersection between them. The lysing reagent(s) (e.g., in a first liquid or in a fourth liquid) may be combined with a sample liquid (e.g., a third liquid) at a channel intersection (e.g., an intersection between a first side-channel and a second channel or an intersection between a first channel and a second channel). The combined liquids can be mixed in a mixer disposed downstream of the intersection.

Upon passing through the droplet source region, the reaction liquid meets a partitioning liquid (e.g., a partitioning oil) under droplet-forming conditions to form a plurality of reaction droplets, each reaction droplet having one or more of the particles and one or more cells/nuclei in the reaction liquid. The reaction droplets are incubated under conditions sufficient to allow for barcoding of the nucleic acid of the cells/nuclei in the reaction droplets. In some embodiments, the conditions sufficient for barcoding are thermally optimized for nucleic acid replication, transcription, and/or amplification. For example, reaction droplets can be incubated at temperatures configured to enable reverse transcription of RNA produced by a cell/nucleus in a droplet into DNA, using reverse transcriptase. Additionally or alternatively, reaction droplets may be cycled through a series of temperatures to promote amplification, e.g., as in a polymerase chain reaction (PCR).

Accordingly, in some embodiments, one or more nucleotide amplification reagents (e.g., PCR reagents) are included in the reaction droplets (e.g., primers, nucleotides, and/or polymerase). Any one or more reagents for nucleic acid replication, transcription, and/or amplification can be provided to the reaction droplet by the aqueous sample, the liquid carrier, or both. In some embodiments, one or more of the reagents for nucleic acid replication, transcription, and/or amplification are in the aqueous sample.

Also provided herein are methods of single-cell (or single-nucleus) nucleic acid sequencing, in which a heterologous population of cells/nuclei can be characterized by their individual gene expression, e.g., relative to other cells/nuclei of the population. Methods of barcoding cells/nuclei discussed above and known in the art can be part of the methods of single-cell (or single nucleus) nucleic acid sequencing provided herein.

After barcoding, nucleic acid transcripts that have been barcoded are sequenced, and sequences can be processed, analyzed, and stored according to known methods. In some embodiments, these methods enable the generation of a genome library containing gene expression data for any single cell (or nucleus) within a heterologous population.

Alternatively, the ability to sequester a single cell, single nucleus, or particulate component thereof in a reaction droplet provided by methods herein enables applications beyond genome characterization. For example, a reaction droplet containing a single cell, single nucleus, or particulate component thereof can allow a single cell to be detectably labeled to provide relative protein expression data. Binding of antibodies to proteins can occur within the reaction droplet, and cells/nuclei can be subsequently analyzed for bound antibodies according to known methods to generate a library of protein expression. Other methods known in the art can be employed to characterize cells/nuclei within heterologous populations after detecting analytes using the methods provided herein. In one example, following the formation of droplets, subsequent operations that can be performed can include formation of amplification products, purification (e.g., via solid phase reversible immobilization (SPRI)), further processing (e.g., shearing, ligation of functional sequences, and subsequent amplification (e.g., via PCR)). These operations may occur in bulk (e.g., outside the droplet). An exemplary use for droplets formed using methods of the invention is in performing nucleic acid amplification, e.g., polymerase chain reaction (PCR), where the reagents necessary to carry out the amplification are contained within the first fluid. In the case where a droplet is a droplet in an emulsion, the emulsion can be broken and the contents of the droplet pooled for additional operations. Additional reagents that may be included in a droplet along with the barcode bearing bead may include oligonucleotides to block ribosomal RNA (rRNA) and nucleases to digest genomic DNA from cells or nuclei. Alternatively, rRNA removal agents may be applied during additional processing operations. The configuration of the constructs generated by such a method can help minimize (or avoid) sequencing of poly-T sequence during sequencing and/or sequence the 5′ end of a polynucleotide sequence. The amplification products, for example first amplification products and/or second amplification products, may be subject to sequencing for sequence analysis. In some cases, amplification may be performed using the Partial Hairpin Amplification for Sequencing (PHASE) method.

Methods of the invention may include first attaching an insert, e.g., to assist with priming. Exemplary inserts are shown in FIGS. 51 and 52. Such an insert may also be removed and discarded after priming. Methods may also first involve attaching inserts which divide a collection region to fluidically separate droplet sources which share the collection region.

Methods of Device Manufacture

The microfluidic devices of the invention may be fabricated in any of a variety of conventional ways. For example, in some cases the devices comprise layered structures, where a first layer includes a planar surface into which is disposed a series of channels or grooves that correspond to the channel network in the finished device. A second layer includes a planar surface on one side, and a series of reservoirs defined on the opposing surface, where the reservoirs communicate as passages through to the planar layer, such that when the planar surface of the second layer is mated with the planar surface of the first layer, the reservoirs defined in the second layer are positioned in liquid communication with the termini of the channels on the first layer. Alternatively, both the reservoirs and the connected channels may be fabricated into a single part, where the reservoirs are provided upon a first surface of the structure, with the apertures of the reservoirs extending through to the opposing surface of the structure. The channel network is fabricated as a series of grooves and features in this second surface. A thin laminating layer is then provided over the second surface to seal, and provide the final wall of the channel network, and the bottom surface of the reservoirs. These layered structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof. Polymeric device components may be fabricated using any of a number of processes including soft lithography, embossing techniques, micromachining, e.g., laser machining, or in some aspects injection molding of the layer components that include the defined channels as well as other structures, e.g., reservoirs, integrated functional components, etc. In some aspects, the structure comprising the reservoirs and channels may be fabricated using, e.g., injection molding techniques to produce polymeric structures. In such cases, a laminating layer may be adhered to the molded structured part through readily available methods, including thermal lamination, solvent based lamination, sonic welding, or the like. Where structures of devices of the invention are produced using injection molding, shaped core pins may be used to generate specific inlet or reservoir shapes, e.g., to include a dividing wall, or a saddle point under which channels may run. Flow paths of the invention including channels which run under a common well shared by multiple inlets or collection reservoirs are particularly amenable to production by injection molding.

As will be appreciated, structures comprised of inorganic materials also may be fabricated using known techniques. For example, channels and other structures may be micro-machined into surfaces or etched into the surfaces using standard photolithographic techniques. In some aspects, the microfluidic devices or components thereof may be fabricated using three-dimensional printing techniques to fabricate the channel or other structures of the devices and/or their discrete components.

Methods for Surface Modifications

The invention features methods for producing a microfluidic device that has a surface modification, e.g., a surface with a modified water contact angle. The methods may be employed to modify the surface of a device such that a liquid can “wet” the surface by altering the contact angle the liquid makes with the surface. An exemplary use of the methods of the invention is in creating a device having differentially coated surfaces to optimize droplet formation.

Devices to be modified with surface coating agents may be primed, e.g., pre-treated, before coating processes occur. In one embodiment, the device has a channel that is in fluid communication with a droplet source region. In particular, the droplet source region is configured to allow a liquid exiting the channel to expand in at least one dimension. A surface of the droplet source region is contacted by at least one reagent that has an affinity for the primed surface to produce a surface having a first water contact angle of greater than about 90°, e.g., a hydrophobic or fluorophilic surface. In certain embodiments, the first contact angle is greater than the water contact angle of the primed surface. In other embodiments, the first contact angle is greater than the water contact angle of the channel surface. Thus, the method allows for the differential coating of surfaces within the microfluidic device.

A surface may be primed by depositing a metal oxide onto it. Example metal oxides useful for priming surfaces include, but are not limited to, Al₂O₃, TiO₂, SiO₂, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be prepared on a surface by depositing trimethylaluminum (TMA) and water.

In some cases, the coating agent may create a surface that has a water contact angle greater than 90°, e.g., hydrophobic or fluorophilic, or may create a surface with a water contact angle of less than 90°, e.g., hydrophilic. For example, a fluorophilic surface may be created by flowing fluorosilane (e.g., H₃FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent. For example, when a liquid coating agent is used to coat a surface, the coating agent may be directly introduced to the droplet source region by a feed channel in fluid communication with the droplet source region. In order to keep the coating agent localized to the droplet source region, e.g., prevent ingress of the coating agent to another portion of the device, e.g., the channel, the portion of the device that is not to be coated can be substantially blocked by a substance that does not allow the coating agent to pass. For example, in order to prevent ingress of a liquid coating agent into the channel, the channel may be filled with a blocking liquid that is substantially immiscible with the coating agent. The blocking liquid may be actively transported through the portion of the device not to be coated, or the blocking liquid may be stationary. Alternatively, the channel may be filled with a pressurized gas such that the pressure prevents ingress of the coating agent into the channel. The coating agent may also be applied to the regions of interest external to the main device. For example, the device may incorporate an additional reservoir and at least one feed channel that connects to the region of interest such that no coating agent is passed through the device.

### EXAMPLES

Examples 1-10 show various droplets source regions and configurations that may be used in any device of the invention. It will be understood, that although channels, reservoirs, and inlets are labeled as “sample” and “reagent” herein, each channel, reservoir, and inlet may be for either a sample or a reagent being used.

### Example 1

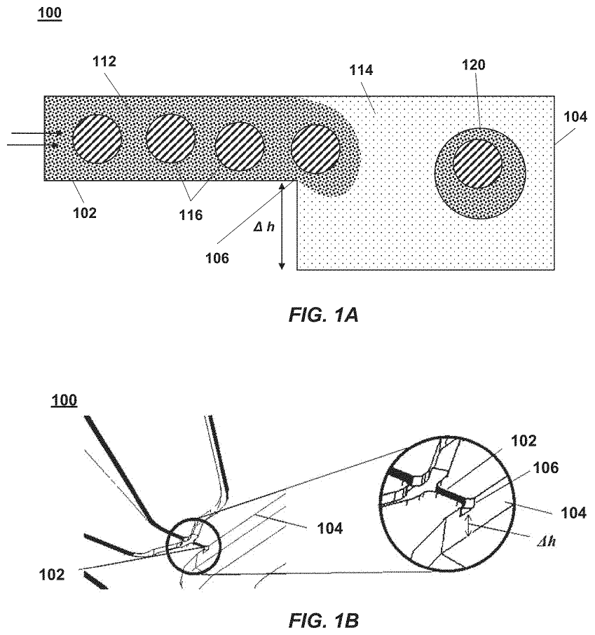

FIG. 1A shows a cross-section view of another example of a microfluidic device with a geometric feature for droplet formation. A device 100 can include a channel 102 communicating at a fluidic connection 106 (or intersection) with a reservoir 104. FIG. 1B shows a perspective view of the device 100 of FIG. 1A.

An aqueous liquid 112 comprising a plurality of particles 116 may be transported along the channel 102 into the fluidic connection 106 to meet a second liquid 114 (e.g., oil, etc.) that is immiscible with the aqueous liquid 112 in the reservoir 104 to create droplets 120 of the aqueous liquid 112 flowing into the reservoir 104.

At the fluidic connection 106 where the aqueous liquid 112 and the second liquid 114 meet, droplets can form based on factors such as the hydrodynamic forces at the fluidic connection 106, relative flow rates of the two liquids 112, 114, liquid properties, and certain geometric parameters (e.g., Δh, etc.) of the device 500. A plurality of droplets can be collected in the reservoir 104 by continuously injecting the aqueous liquid 112 from the channel 102 at the fluidic connection 106.

While FIGS. 1A and 1B illustrate the height difference, Δh, being abrupt at the fluidic connection 106 (e.g., a step increase), the height difference may increase gradually (e.g., from about 0 μm to a maximum height difference). Alternatively, the height difference may decrease gradually (e.g., taper) from a maximum height difference. A gradual increase or decrease in height difference, as used herein, may refer to a continuous incremental increase or decrease in height difference, wherein an angle between any one differential segment of a height profile and an immediately adjacent differential segment of the height profile is greater than 90°. For example, at the fluidic connection 506, a bottom wall of the channel and a bottom wall of the reservoir can meet at an angle greater than 90°. Alternatively or in addition, a top wall (e.g., ceiling) of the channel and a top wall (e.g., ceiling) of the reservoir can meet an angle greater than 90°. A gradual increase or decrease may be linear or non-linear (e.g., exponential, sinusoidal, etc.). Alternatively or in addition, the height difference may variably increase and/or decrease linearly or non-linearly.

### Example 2

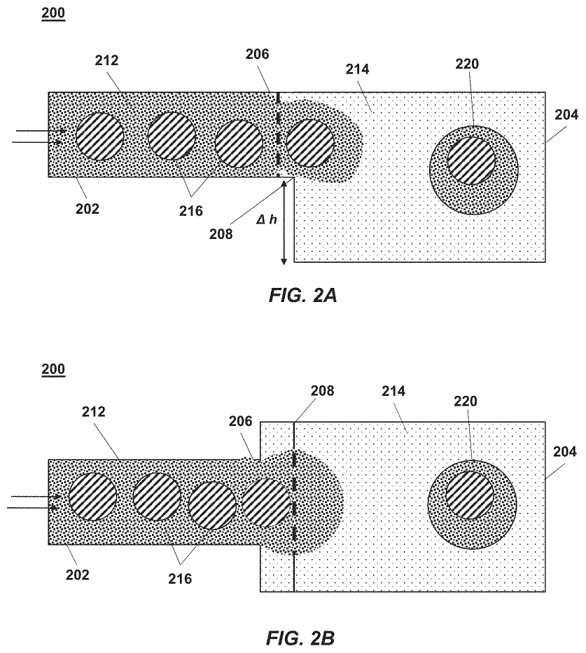

FIGS. 2A and 2B show a cross-section view and a top view, respectively, of another example of a microfluidic device with a geometric feature for droplet formation. A device 200 can include a channel 202 communicating at a fluidic connection 206 (or intersection) with a reservoir 204. In some instances, the device 200 and one or more of its components can correspond to the channel 500 and one or more of its components.

An aqueous liquid 212 comprising a plurality of particles 216 may be transported along the channel 202 into the fluidic connection 206 to meet a second liquid 214 (e.g., oil, etc.) that is immiscible with the aqueous liquid 212 in the reservoir 204 to create droplets 220 of the aqueous liquid 212 flowing into the reservoir 204.

At the fluidic connection 206 where the aqueous liquid 212 and the second liquid 214 meet, droplets can form based on factors such as the hydrodynamic forces at the fluidic connection 206, relative flow rates of the two liquids 212, 214, liquid properties, and certain geometric parameters (e.g., Δh, ledge, etc.) of the channel 202. A plurality of droplets can be collected in the reservoir 204 by continuously injecting the aqueous liquid 212 from the channel 202 at the fluidic connection 206.

The aqueous liquid may comprise particles. The particles 216 (e.g., beads) can be introduced into the channel 202 from a separate channel (not shown in FIG. 2). In some instances, the particles 216 can be introduced into the channel 202 from a plurality of different channels, and the frequency controlled accordingly. In some instances, different particles may be introduced via separate channels. For example, a first separate channel can introduce beads and a second separate channel can introduce biological particles into the channel 202. The first separate channel introducing the beads may be upstream or downstream of the second separate channel introducing the biological particles.

While FIGS. 2A and 2B illustrate one ledge (e.g., step) in the reservoir 204, as can be appreciated, there may be a plurality of ledges in the reservoir 204, for example, each having a different cross-section height. For example, where there is a plurality of ledges, the respective cross-section height can increase with each consecutive ledge. Alternatively, the respective cross-section height can decrease and/or increase in other patterns or profiles (e.g., increase then decrease then increase again, increase then increase then increase, etc.).

While FIGS. 2A and 2B illustrate the height difference, Δh, being abrupt at the ledge 208 (e.g., a step increase), the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. The same may apply to a height difference, if any, between the first cross-section and the second cross-section.

### Example 3

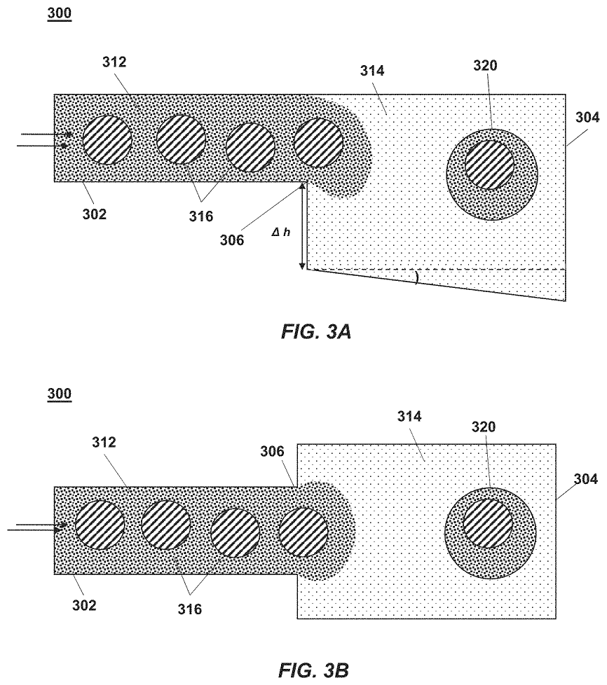

FIGS. 3A and 3B show a cross-section view and a top view, respectively, of another example of a microfluidic device with a geometric feature for droplet formation. A device 300 can include a channel 302 communicating at a fluidic connection 306 (or intersection) with a reservoir 304. In some instances, the device 300 and one or more of its components can correspond to the channel 200 and one or more of its components.

An aqueous liquid 312 comprising a plurality of particles 316 may be transported along the channel 302 into the fluidic connection 306 to meet a second liquid 314 (e.g., oil, etc.) that is immiscible with the aqueous liquid 312 in the reservoir 304 to create droplets 320 of the aqueous liquid 312 flowing into the reservoir 304.

At the fluidic connection 306 where the aqueous liquid 312 and the second liquid 314 meet, droplets can form based on factors such as the hydrodynamic forces at the fluidic connection 306, relative flow rates of the two liquids 312, 314, liquid properties, and certain geometric parameters (e.g., Δh, etc.) of the device 300. A plurality of droplets can be collected in the reservoir 304 by continuously injecting the aqueous liquid 312 from the channel 302 at the fluidic connection 306.

In some instances, the second liquid 314 may not be subjected to and/or directed to any flow in or out of the reservoir 304. For example, the second liquid 314 may be substantially stationary in the reservoir 304. In some instances, the second liquid 314 may be subjected to flow within the reservoir 304, but not in or out of the reservoir 304, such as via application of pressure to the reservoir 304 and/or as affected by the incoming flow of the aqueous liquid 312 at the fluidic connection 306. Alternatively, the second liquid 314 may be subjected and/or directed to flow in or out of the reservoir 304. For example, the reservoir 304 can be a channel directing the second liquid 314 from upstream to downstream, transporting the generated droplets. Alternatively or in addition, the second liquid 314 in reservoir 304 may be used to sweep formed droplets away from the path of the nascent droplets.

The device 300 at or near the fluidic connection 306 may have certain geometric features that at least partly determine the sizes and/or shapes of the droplets formed by the device 300. The channel 302 can have a first cross-section height, h₁, and the reservoir 304 can have a second cross-section height, h₂. The first cross-section height, h₁, may be different from the second cross-section height h₂ such that at or near the fluidic connection 306, there is a height difference of Δh. The second cross-section height, h₂, may be greater than the first cross-section height, h₁. The reservoir may thereafter gradually increase in cross-section height, for example, the more distant it is from the fluidic connection 306. In some instances, the cross-section height of the reservoir may increase in accordance with expansion angle, β, at or near the fluidic connection 306. The height difference, Δh, and/or expansion angle, β, can allow the tongue (portion of the aqueous liquid 312 leaving channel 302 at fluidic connection 306 and entering the reservoir 304 before droplet formation) to increase in depth and facilitate decrease in curvature of the intermediately formed droplet. For example, droplet size may decrease with increasing height difference and/or increasing expansion angle.

While FIGS. 3A and 3B illustrate the height difference, Δh, being abrupt at the fluidic connection 306, the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. While FIGS. 3A and 3B illustrate the expanding reservoir cross-section height as linear (e.g., constant expansion angle, β), the cross-section height may expand non-linearly. For example, the reservoir may be defined at least partially by a dome-like (e.g., hemispherical) shape having variable expansion angles. The cross-section height may expand in any shape.

### Example 4

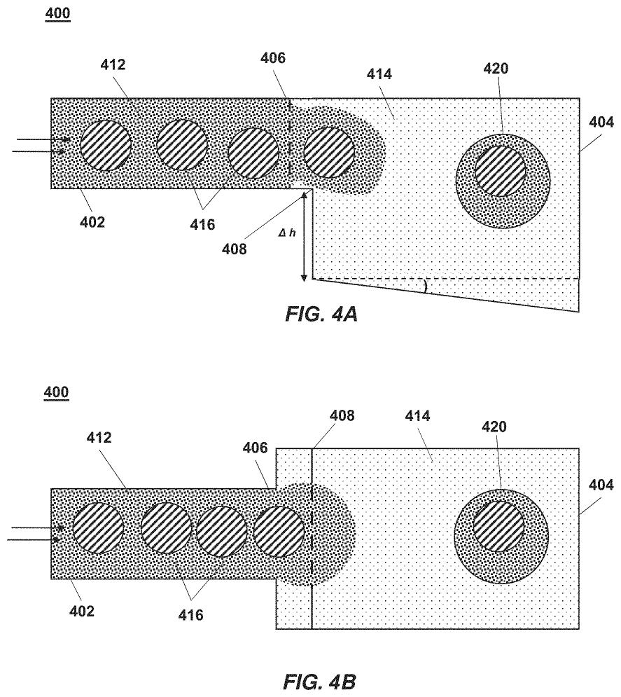

FIGS. 4A and 4B show a cross-section view and a top view, respectively, of another example of a microfluidic device with a geometric feature for droplet formation. A device 400 can include a channel 402 communicating at a fluidic connection 406 (or intersection) with a reservoir 404. In some instances, the device 400 and one or more of its components can correspond to the device 300 and one or more of its components and/or correspond to the device 200 and one or more of its components.

An aqueous liquid 412 comprising a plurality of particles 416 may be transported along the channel 402 into the fluidic connection 406 to meet a second liquid 414 (e.g., oil, etc.) that is immiscible with the aqueous liquid 412 in the reservoir 404 to create droplets 420 of the aqueous liquid 412 flowing into the reservoir 404. At the fluidic connection 406 where the aqueous liquid 412 and the second liquid 414 meet, droplets can form based on factors such as the hydrodynamic forces at the fluidic connection 406, relative flow rates of the two liquids 412, 414, liquid properties, and certain geometric parameters (e.g., Δh, etc.) of the device 400. A plurality of droplets can be collected in the reservoir 404 by continuously injecting the aqueous liquid 412 from the channel 402 at the fluidic connection 406.

A discrete droplet generated may comprise one or more particles of the plurality of particles 416. As described elsewhere herein, a particle may be any particle, such as a bead, cell bead, gel bead, biological particle, macromolecular constituents of biological particle, or other particles. Alternatively, a discrete droplet generated may not include any particles.

In some instances, the second liquid 414 may not be subjected to and/or directed to any flow in or out of the reservoir 404. For example, the second liquid 414 may be substantially stationary in the reservoir 404. In some instances, the second liquid 414 may be subjected to flow within the reservoir 404, but not in or out of the reservoir 404, such as via application of pressure to the reservoir 404 and/or as affected by the incoming flow of the aqueous liquid 412 at the fluidic connection 406. Alternatively, the second liquid 414 may be subjected and/or directed to flow in or out of the reservoir 404. For example, the reservoir 404 can be a channel directing the second liquid 414 from upstream to downstream, transporting the generated droplets. Alternatively or in addition, the second liquid 414 in reservoir 404 may be used to sweep formed droplets away from the path of the nascent droplets.

While FIGS. 4A and 4B illustrate one ledge (e.g., step) in the reservoir 404, as can be appreciated, there may be a plurality of ledges in the reservoir 404, for example, each having a different cross-section height. For example, where there is a plurality of ledges, the respective cross-section height can increase with each consecutive ledge. Alternatively, the respective cross-section height can decrease and/or increase in other patterns or profiles (e.g., increase then decrease then increase again, increase then increase then increase, etc.).

While FIGS. 4A and 4B illustrate the height difference, Δh, being abrupt at the ledge 808, the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. While FIGS. 4A and 4B illustrate the expanding reservoir cross-section height as linear (e.g., constant expansion angle), the cross-section height may expand non-linearly. For example, the reservoir may be defined at least partially by a dome-like (e.g., hemispherical) shape having variable expansion angles. The cross-section height may expand in any shape.

### Example 5

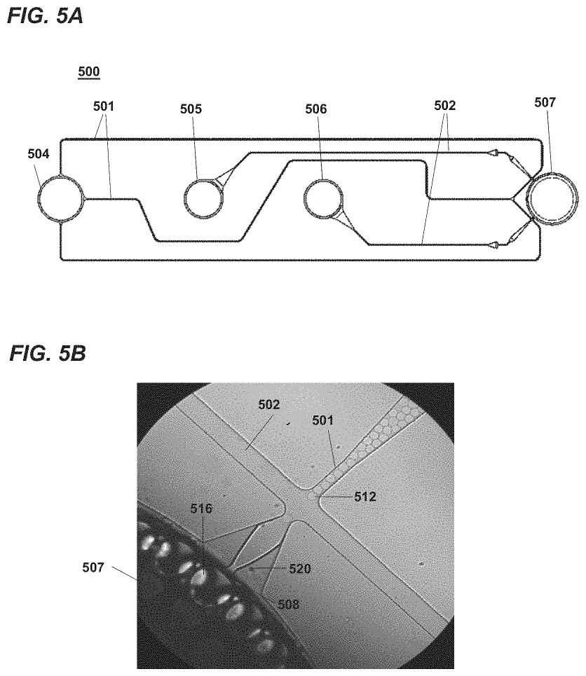

An example of a device according to the invention is shown in FIGS. 5A-5B. The device 500 includes four fluid reservoirs, 504, 505, 506, and 507, respectively. Reservoir 504 houses one liquid; reservoirs 505 and 506 house another liquid, and reservoir 507 houses continuous phase in the step region 508. This device 500 include two first channels 502 connected to reservoir 505 and reservoir 506 and connected to a shelf region 520 adjacent a step region 508. As shown, multiple channels 501 from reservoir 504 deliver additional liquid to the first channels 502. The liquids from reservoir 504 and reservoir 505 or 506 combine in the first channel 502 forming the first liquid that is dispersed into the continuous phase as droplets. In certain embodiments, the liquid in reservoir 505 and/or reservoir 506 includes a particle, such as a gel bead. FIG. 5B shows a view of the first channel 502 containing gel beads intersected by a second channel 501 adjacent to a shelf region 520 leading to a step region 508, which contains multiple droplets 516.

### Example 6

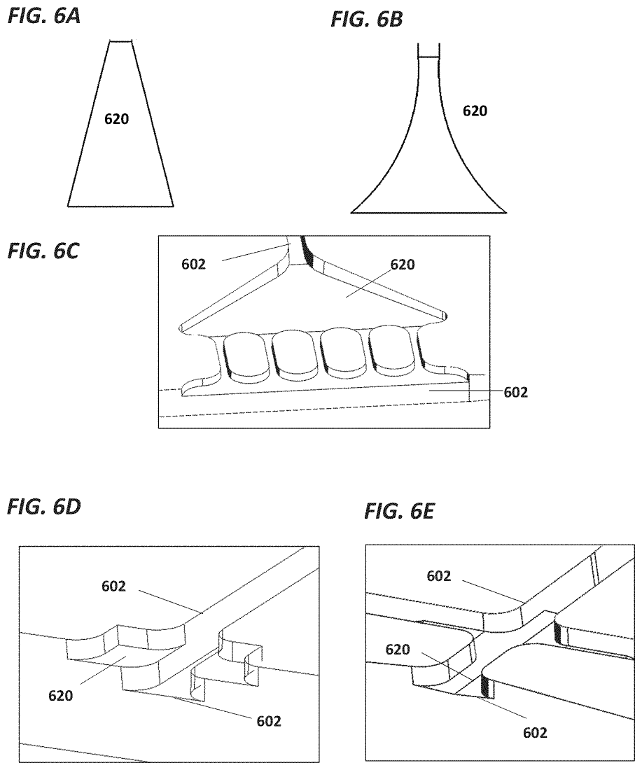

Variations on shelf regions 620 are shown in FIGS. 6A-6E. As shown in FIGS. 6A-6B, the width of the shelf region 620 can increase from the distal end of a first channel 602 towards the step region 608, linearly as in 6A or non-linearly as in 6B. As shown in FIG. 6C, multiple first channels 602 can branch from a single feed channel 602 and introduce fluid into interconnected shelf regions 620. As shown in FIG. 6D, the depth of the first channel 602 may be greater than the depth of the shelf region 620 and cut a path through the shelf region 620. As shown in FIG. 6E, the first channel 602 and shelf region 620 may contain a grooved bottom surface. This device 600 also includes a second channel 602 that intersects the first channel 602 proximal to its distal end.

### Example 7

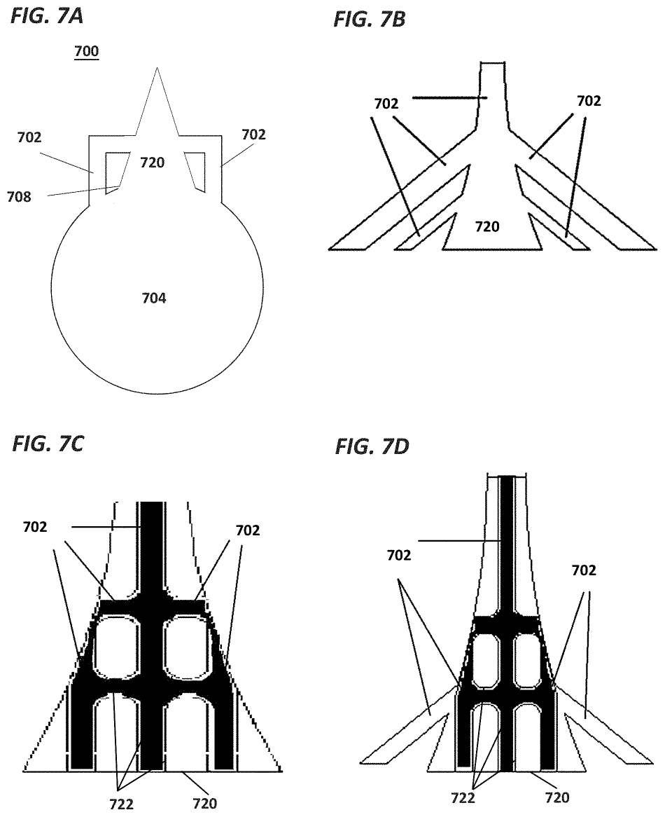

Continuous phase delivery channels 702, shown in FIGS. 7A-7D, are variations on shelf regions 720 including channels 702 for delivery (passive or active) of continuous phase behind a nascent droplet. In one example in FIG. 7A, the device 700 includes two channels 702 that connect the reservoir 1304 of the step region 708 to either side of the shelf region 720. In another example in FIG. 7B, four channels 702 provide continuous phase to the shelf region 720. These channels 702 can be connected to the reservoir 704 of the step region 708 or to a separate source of continuous phase. In a further example in FIG. 7C, the shelf region 720 includes one or more channels 702 (white) below the depth of the first channel 702 (black) that connect to the reservoir 704 of the step region 708. The shelf region 720 contains islands 722 in black. In another example FIG. 7D, the shelf region 720 of FIG. 7C includes two additional channels 702 for delivery of continuous phase on either side of the shelf region 720.

### Example 8

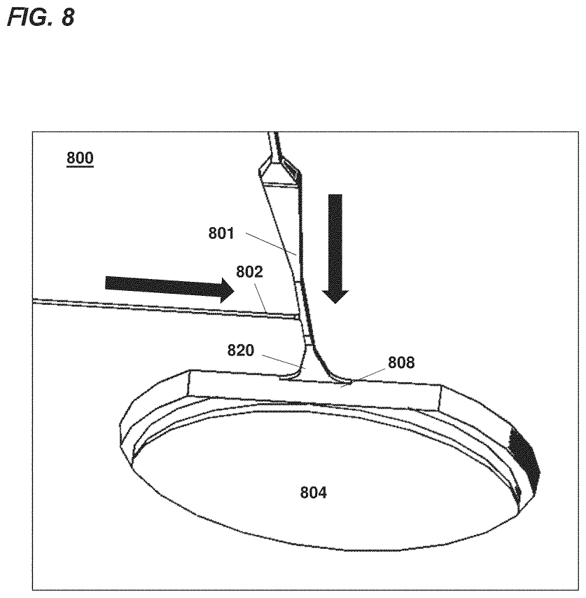

An embodiment of a device according to the invention is shown in FIG. 8. This device 800 includes two channels 801, 802 that intersect upstream of a droplet source region. The droplet source region includes both a shelf region 820 and a step region 808 disposed between the distal end of the first channel 801 and the step region 808 that lead to a collection reservoir 804. The black and white arrows show the flow of liquids through each of first channel 801 and second channel 802, respectively. In certain embodiments, the liquid flowing through the first channel 801 or second channel 802 includes a particle, such as a gel bead.

As shown in the FIG. 8, the width of the shelf region 820 can increase from the distal end of a first channel 801 towards the step region 808; in particular, the width of the shelf region 820 in FIG. 8 increases non-linearly. In this embodiment, the shelf region extends from the edge of a reservoir to allow droplet formation away from the edge. Such a geometry allows droplets to move away from the droplet source region due to differential density between the continuous and dispersed phase.

### Example 9

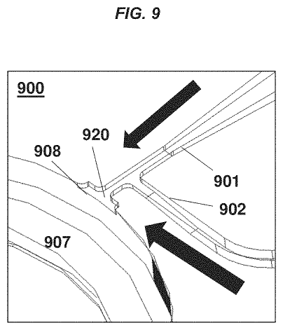

A zoomed-in view of a droplet source region of an embodiment of a device according to the invention for multiplexed droplet formation is shown in FIG. 9. The second channel 902, with its flow indicated by the white arrow, has its distal end intersecting a channel 902 from reservoir 904, with the flow of the channel indicated by the black arrow, upstream of the droplet source region. The liquid from reservoir 904 and reservoir 906, separately, are introduced into channels 901, 903 and flow towards the collection reservoir 907. The liquid from the second reservoir 905 combines with the fluid from reservoir 904 or reservoir 906, and the combined fluid is dispersed into the droplet source region and to the continuous phase. In certain embodiments, the liquid flowing through the first channel 901 or 903 or second channel 902 includes a particle, such as a gel bead.

### Example 10

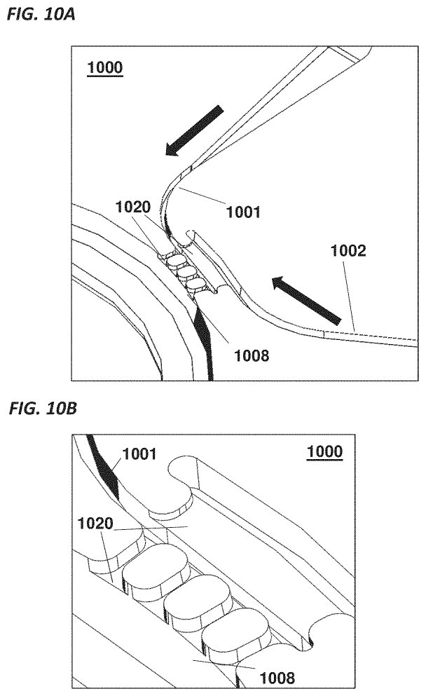

An embodiment of a device according to the invention that has a plurality of droplet source regions is shown in FIGS. 10A-10B (FIG. 10B is a zoomed in view of FIG. 10A), with the droplet source region including a shelf region 1020 and a step region 1008. This device 1000 includes two channels 1001, 1002 that meet at the shelf region 1020. As shown, after the two channels 1001, 1002 meet at the shelf region 1020, the combination of liquids is divided, in this example, by four shelf regions. In certain embodiments, the liquid with flow indicated by the black arrow includes a particle, such as a gel bead, and the liquid flow from the other channel, indicated by the white arrow, can move the particles into the shelf regions such that each particle can be introduced into a droplet.

### Example 11

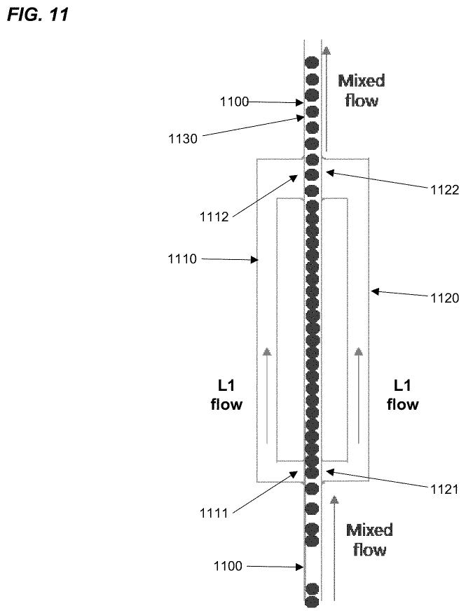

FIG. 11 illustrates a device for converting a stream of unevenly spaced particles (e.g., beads) into a stream of evenly spaced particles. The device includes first channel 1100, first side-channel 1110, and second side-channel 1120. In the operating device, particles 1130 propagate through channel 1100 in the direction of an arrow labeled “Mixed flow.” Prior to proximal intersections 1111 and 1121, spacing between consecutive particles is non-uniform. At the proximal intersections, excess first liquid L1 escapes into side-channels 1110 and 1120. Inlets of side-channels 1110 and 1120 are sized to substantially prevent ingress of particles from first channel 1100. The liquid that escapes into side-channels 1110 and 1120 rejoins first channel 1100 at distal intersections 1112 and 1122. Upon rejoining first channel 1100, liquid L1 separates consecutively packed particles 1130, thereby providing evenly spaced particles 1130.

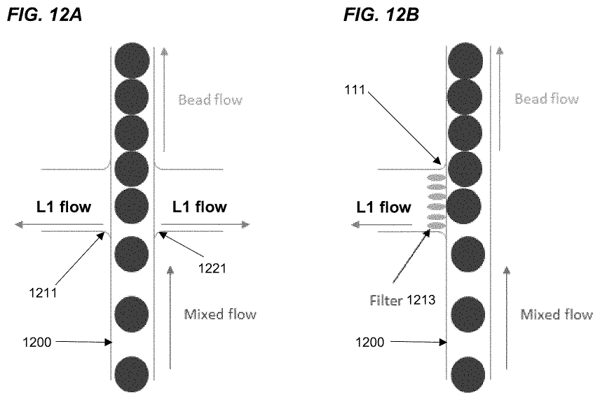

FIG. 12A and FIG. 12B are alternative configurations of proximal intersections of first channel 1200 with first side-channel 1210 (FIG. 12A and FIG. 12B) and second side-channel 1220 (FIG. 12A).

FIG. 12A illustrates the direction of the excess liquid flow from first channel 1200 into the side-channels at proximal intersections 1211 and 1221. In this configuration, the side-channels have a depth sized to substantially prevent particle ingress from first channel 1200.

FIG. 12B illustrates the direction of the excess liquid flow from first channel 1200 into the side-channel at proximal intersection 1211. In this configuration, the side-channel includes filter 1213 to substantially prevent particle ingress from first channel 1200.

### Example 12

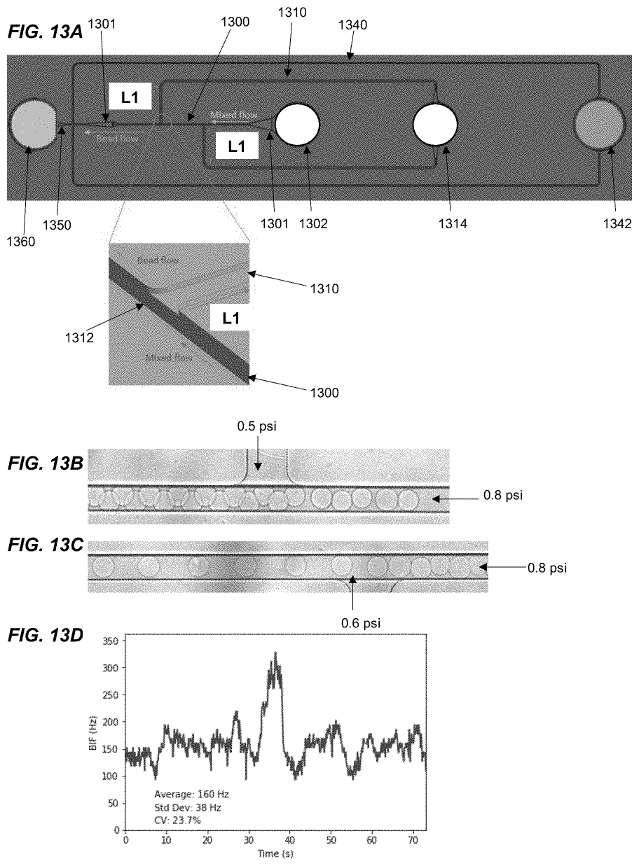

FIG. 13A illustrates an exemplary device of the invention. The device includes first channel 1300 having two funnels 1301, first reservoir 1302, first side-channel 1310 including first side-channel reservoir 1314, two second channels 1340 fluidically connected to second reservoir 1342, droplet source region 1350, and droplet collection region 1360. First channel 1300 has a depth of 60 μm, and first side-channel 1310 has a depth of 14 μm. This configuration may be used, e.g., with beads having a mean diameter of about 54 μm. This device is adapted to control pressure in first channel 1300 through the use of first side-channel 1310. In use, beads and first liquid L1, preloaded into reservoir 1302, are allowed to flow from reservoir 1302 to droplet source region 1350. The bead spacing is controlled by way of side-channel 1310, which includes side-channel reservoir 1314. In use, side-channel reservoir 1314 can be used for active control of the pressure in side-channel 1310. Thus, the bead flow rate, spacing, and spacing uniformity may be adjusted as needed by controlling the pressure in reservoirs 1302 and 1314. Rectifiers 1301 can provide additional control over bead spacing and spacing uniformity. Sample (e.g., a third liquid) may be loaded into reservoir 1342 and allowed to flow to droplet source region 1350 through two second channels 1340. At an intersection between first channel 1300 and second channels 1340, the bead stream is combined with the sample stream, and the combined beads, first liquid, and sample proceed to droplet source region 1350, where the combined stream contacts a second liquid in droplet collection region 1360 to form droplets, preferably, droplets containing a single bead. Rectifiers 1301 and side channel 1310 thus can be used to control particle (e.g., bead) spacing to allow for the formation of droplets containing a single particle.

The inset shows an isometric view of distal intersection 1312 with first-side channel 1310 having a first side-channel depth that is smaller than the first depth and a first side-channel width that is greater than the first width. Droplet collection region 1360 is in fluid communication with first reservoir 1302, first side-channel reservoir 1314, and second reservoir 1342. In operation, beads flow with the first liquid L1 along first channel 1300, and excess first liquid L1 is removed through first side-channel 1310, and beads are sized to reduce or even substantially eliminate their ingress into first side-channel 1310.

FIG. 13B shows an intersection between a first channel and a first side-channel in use. In this figure, the first liquid and beads flow along a first channel at a pressure of 0.8 psi, the first liquid pressure applied in the first side-channel is 0.5 psi. Accordingly, excess first liquid is removed from the space between consecutive beads, and these beads are then tightly packed in the first channel.

FIG. 13C shows an intersection between a first channel and a first side-channel in use. In this figure, the first liquid and beads flow along a first channel. The pressure applied to reservoir 1302 is 0.8 psi, and the pressure applied to reservoir 1314 is 0.6 psi. The beads are tightly packed in the first channel upstream of the channel intersection. The first liquid added to the first channel from the first side-channel is evenly distributed between consecutive beads, thereby providing a stream of evenly spaced beads.

FIG. 13D is a chart showing the frequency at which beads flow through a fixed region in the chip (Bead Injection Frequency, or BIF) as a function of time, during normal chip operation. The measurement was carried out by video analysis of a fixed region of the first channel, after the intersection between the first channel and first side-channel.

### Example 13

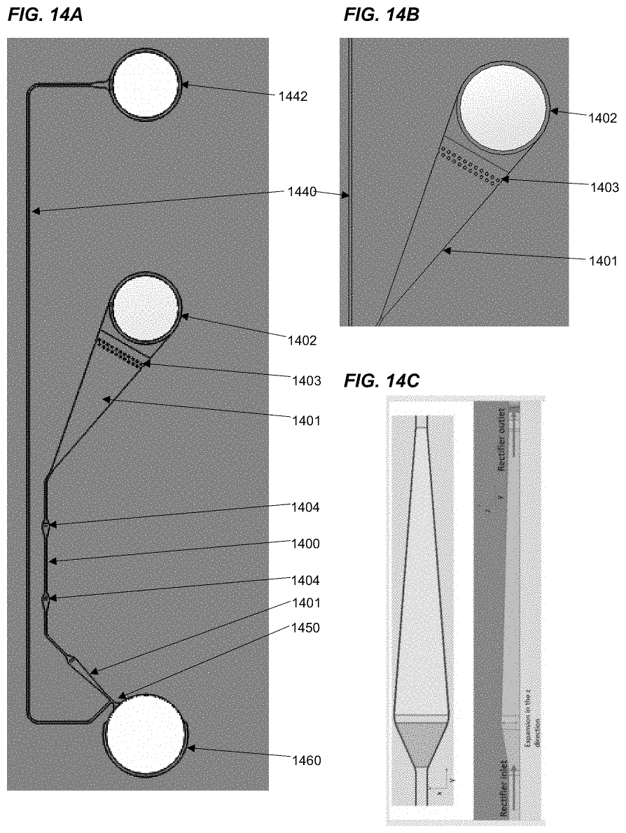

FIG. 14A illustrates an exemplary device of the invention. The device includes first channel 1400 having two funnels 1401 and two mini-rectifiers 1404, first reservoir 1402, second channel 1440 fluidically connected to second reservoir 1442, droplet source region 1450, and droplet collection region 1460. The proximal funnel width is substantially equal to the width of first reservoir 1402. Funnels 1401 and mini-rectifiers 1404 include pegs 1403 as hurdles. There are two rows of pegs 1403 in proximal funnel 1401 as hurdles. Droplet collection region 1460 is in fluid communication with first reservoir 1402 and second reservoir 1442. The spacing between pegs 1403 is 100 μm.

In use, beads and a first liquid, preloaded into reservoir 1402, are allowed to flow from reservoir 1402 to droplet source region 1450. The bead flow rate and spacing may be adjusted as needed by controlling the pressure in reservoir 1402. Rectifiers 1401 and mini-rectifiers 1404 can also provide control over bead spacing and spacing uniformity. Sample (e.g., a third liquid) may be loaded into reservoir 1442 and allowed to flow to droplet source region 1450 through second channel 1440. At an intersection between first channel 1400 and second channel 1440, the bead stream is combined with the sample stream, and the combined beads, first liquid, and sample proceed to droplet source region 1450, where the combined stream contacts a second liquid in droplet collection region 1460 to form droplets, preferably, droplets containing a single bead. Rectifiers 1401, mini-rectifiers 1404, and hurdles 1403 thus can be used to control particle (e.g., bead) spacing to allow for the formation of droplets containing a single particle.

FIG. 14B is an image focused on the combination of proximal funnel 1401 and first reservoir 1402 in the device of FIG. 14A. Proximal funnel 1401 is fluidically connected to first reservoir 1402 and includes two rows of pegs 1403 as hurdles.

### Example 14

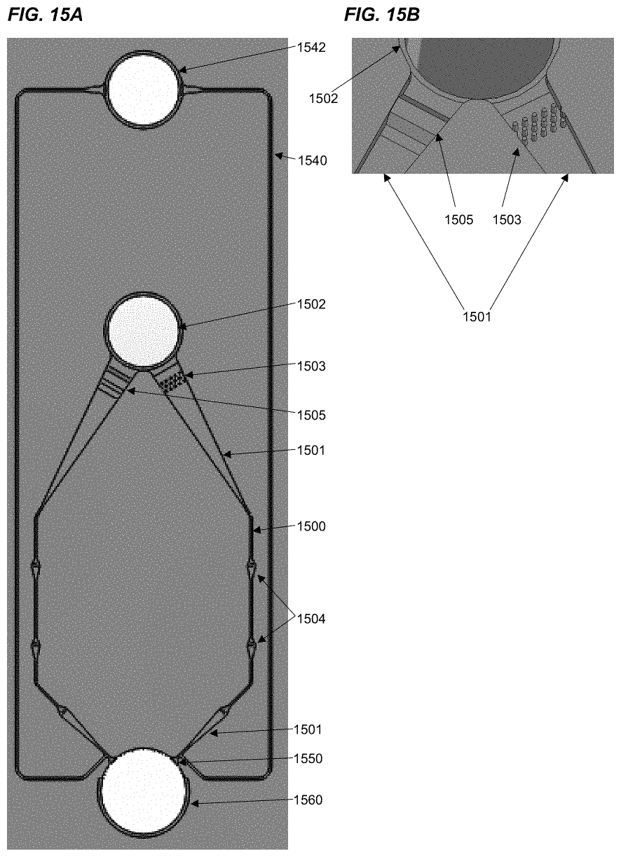

FIG. 15A illustrates an exemplary device of the invention. The device includes two first channels 1500, each first channel having two funnels 1501 and two mini-rectifiers 1504; first reservoir 1502; two second channels 1540 fluidically connected to the same second reservoir 1542; two droplet source regions 1550; and one droplet collection region 1560. The proximal funnel 1501 on the left includes one barrier 1505 as a hurdle. The proximal funnel 1501 on the right includes three rows of pegs 1503 as hurdles. Droplet collection region 1560 is in fluid communication with first reservoir 1502 and second reservoir 1542. Barrier 1505 has a height of 30 μm, and pegs 1503 are spaced at 100 μm intervals.

In use, beads and a first liquid, preloaded into reservoir 1502, are allowed to flow from reservoir 1502 to droplet source regions 1550. The bead flow rate and spacing may be adjusted as needed by controlling the pressure in reservoir 1502. Rectifiers 1501 and mini-rectifiers 1504 can also provide control over bead spacing and spacing uniformity. Sample (e.g., a third liquid) may be loaded into reservoir 1542 and allowed to flow to droplet source regions 1550 through second channels 1540. At intersections between first channels 1500 and second channels 1540, the bead stream is combined with the sample stream, and the combined beads, first liquid, and sample proceed to droplet source regions 1550, where the combined streams contact a second liquid in droplet collection region 1560 to form droplets, preferably, droplets containing a single bead. Rectifiers 1501, mini-rectifiers 1504, and hurdles 1503 and 1505 thus can be used to control particle (e.g., bead) spacing to allow for the formation of droplets containing a single particle.

FIG. 15B is an image focused on the combination of two proximal funnels 1501 and first reservoir 1502. Proximal funnel 1501 on the left is fluidically connected to first reservoir 1502 and includes one barrier 1505 as a hurdle. Proximal funnel 1501 on the right is fluidically connected to first reservoir 1502 includes three rows of pegs 1503 as hurdles.

### Example 15

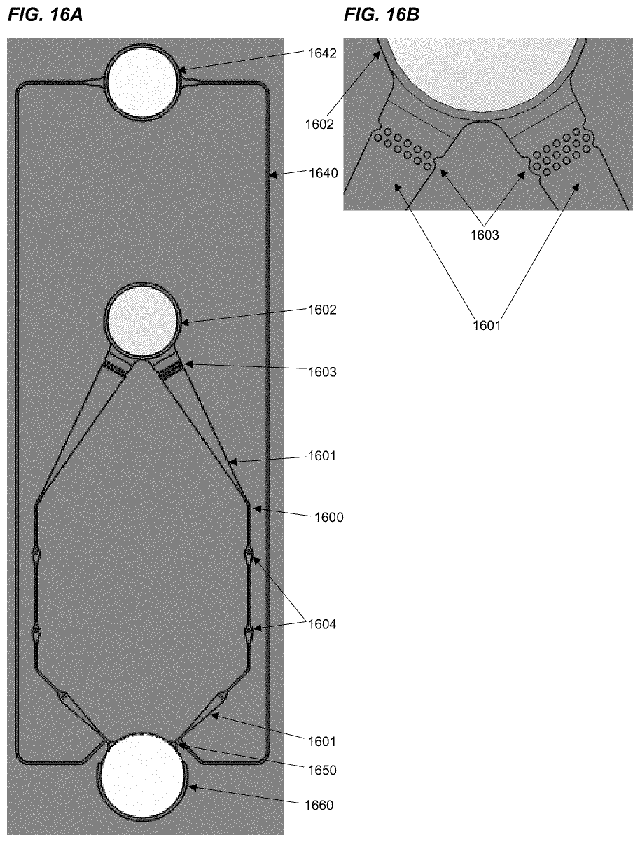

FIG. 16A is an image showing the top view of an exemplary device of the invention. The device includes two first channels 1600, each first channel having two funnels 1601 and two mini-rectifiers 1604; first reservoir 1602; two second channels 1640 fluidically connected to the same second reservoir 1642; two droplet source regions 1650; and one droplet collection region 1660. Proximal funnel 1601 on the left includes two rows of pegs 1603 as hurdles. Proximal funnel 1601 on the right includes three rows of pegs 1603 as hurdles. Droplet collection region 1660 is in fluid communication with first reservoir 1602 and second reservoir 1642. The spacing between pegs 1603 is 65 μm.

In use, beads and a first liquid, preloaded into reservoir 1602, are allowed to flow from reservoir 1602 to droplet source regions 1650. The bead flow rate and spacing may be adjusted as needed by controlling the pressure in reservoir 1602. Rectifiers 1601 and mini-rectifiers 1604 can also provide control over bead spacing and spacing uniformity. Sample (e.g., a third liquid) may be loaded into reservoir 1642 and allowed to flow to droplet source regions 1650 through second channels 1640. At intersections between first channels 1600 and second channels 1640, the bead stream is combined with the sample stream, and the combined beads, first liquid, and sample proceed to droplet source regions 1650, where the combined streams contact a second liquid in droplet collection region 1660 to form droplets, preferably, droplets containing a single bead. Rectifiers 1601, mini-rectifiers 1604, and hurdles 1603 thus can be used to control particle (e.g., bead) spacing to allow for the formation of droplets containing a single particle.

FIG. 16B is an image focused on the combination of proximal funnels 1601 and first reservoir 1602. Proximal funnel 1601 on the left is fluidically connected to first reservoir 1602 and includes two rows of pegs 1603 as hurdles. Proximal funnel 1601 on the right is fluidically connected to first reservoir 1602 and includes three rows of pegs 1603 as hurdles.

### Example 16

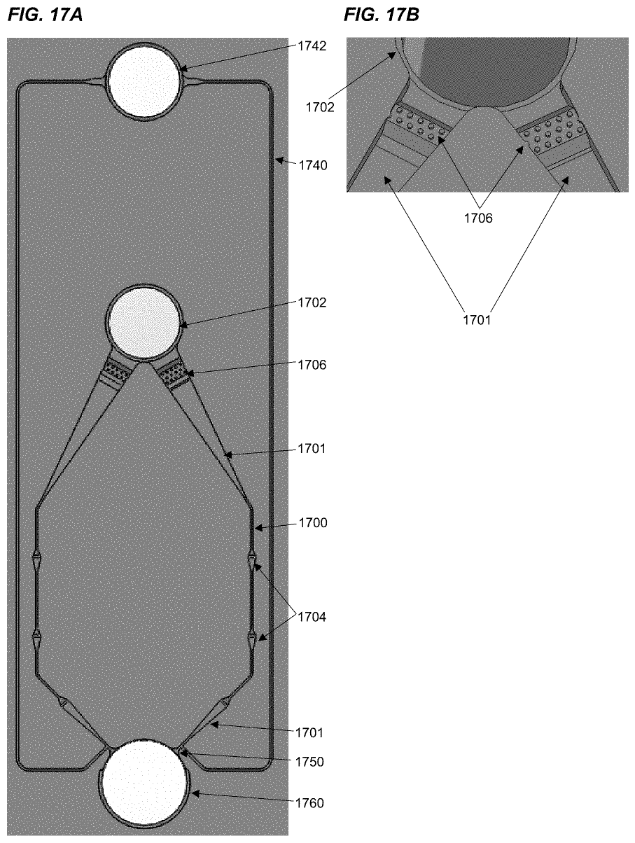

FIG. 17A is an image showing the top view of an exemplary device of the invention. The device includes two first channels 1700, each first channel having two funnels 1701 and two mini-rectifiers 1704; first reservoir 1702; two second channels 1740 fluidically connected to the same second reservoir 1742; two droplet source regions 1750; and one droplet collection region 1760. Proximal funnel 1701 on the left includes a barrier with two rows of pegs disposed on top of the barrier as hurdle 1706. Proximal funnel 1701 on the right includes a barrier with three rows of pegs disposed on top of the barrier as a hurdle 1706. Droplet collection region 1760 is in fluid communication with first reservoir 1702 and second reservoir 1742. Each hurdle 1706 is a 30 μm-tall barrier with pegs spaced at 100 μm.

In use, beads and a first liquid, preloaded into reservoir 1702, are allowed to flow from reservoir 1702 to droplet source regions 1750. The bead flow rate and spacing may be adjusted as needed by controlling the pressure in reservoir 1702. Rectifiers 1701 and mini-rectifiers 1704 can also provide control over bead spacing and spacing uniformity. Sample (e.g., a third liquid) may be loaded into reservoir 1742 and allowed to flow to droplet source regions 1750 through second channels 1740. At intersections between first channels 1700 and second channels 1740, the bead stream is combined with the sample stream, and the combined beads, first liquid, and sample proceed to droplet source regions 1750, where the combined streams contact a second liquid in droplet collection region 1760 to form droplets, preferably, droplets containing a single bead. Rectifiers 1701, mini-rectifiers 1704, and hurdles 1706 thus can be used to control particle (e.g., bead) spacing to allow for the formation of droplets containing a single particle.

FIG. 17B is an image focused on the combination of proximal funnels 1701 and first reservoir 1702. Proximal funnel 1701 on the left is fluidically connected to first reservoir 1702 and includes a barrier with two rows of pegs disposed on top of the barrier as hurdle 1706. Proximal funnel 1701 on the right is fluidically connected to first reservoir 1702 includes a barrier with three rows of pegs disposed on top of the barrier as hurdle 1706.

### Example 17

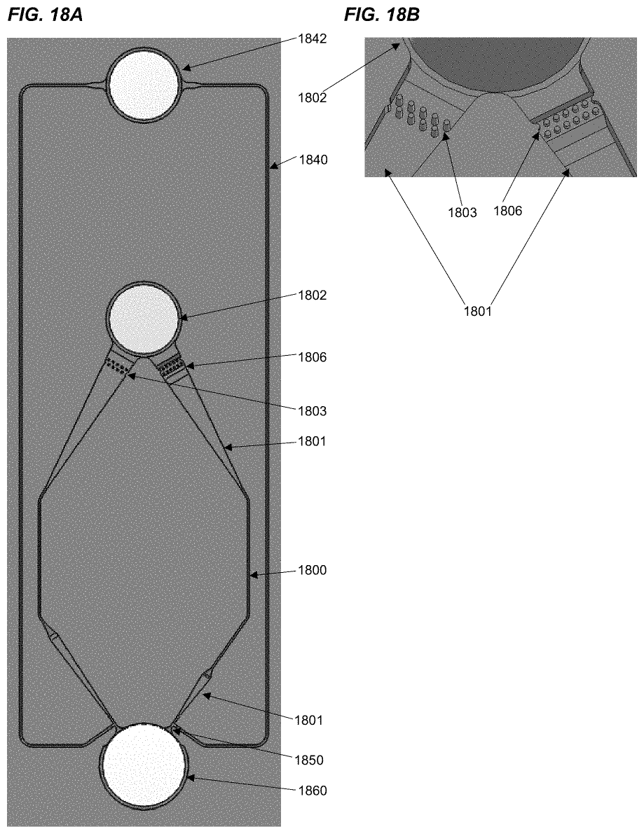

FIG. 18A is an image showing the top view of an exemplary device of the invention. The device includes two first channels 1800, each first channel having two funnels 1801; first reservoir 1802; two second channels 1840 fluidically connected to the same second reservoir 1842; two droplet source regions 1850; and one droplet collection region 1860. Proximal funnel 1801 on the left includes two rows of pegs 1803 as hurdles.

Pegs 1803 are spaced at 100 μm. Proximal funnel 1801 on the right includes a barrier with two rows of pegs disposed on top of the barrier as a hurdle 1806. Hurdle 1806 is a 60 μm-tall barrier with pegs spaced at 65 μm. Distal funnel 1801 on the left is elongated (2 mm in length). Droplet collection region 1860 is in fluid communication with first reservoir 1802 and second reservoir 1842.

In use, beads and a first liquid, preloaded into reservoir 1802, are allowed to flow from reservoir 1802 to droplet source regions 1850. The bead flow rate and spacing may be adjusted as needed by controlling the pressure in reservoir 1802. Rectifiers 1801 can also provide control over bead spacing and spacing uniformity. Sample (e.g., a third liquid) may be loaded into reservoir 1842 and allowed to flow to droplet source regions 1850 through second channels 1840. At intersections between first channels 1800 and second channels 1840, the bead stream is combined with the sample stream, and the combined beads, first liquid, and sample proceed to droplet source regions 1850, where the combined streams contact a second liquid in droplet collection region 1860 to form droplets, preferably, droplets containing a single bead. Rectifiers 1801 and hurdles 1803 and 1806 thus can be used to control particle (e.g., bead) spacing to allow for the formation of droplets containing a single particle.

FIG. 18B is an image focused on the combination of proximal funnels 1801 and first reservoir 1802. Proximal funnel 1801 on the left is fluidically connected to first reservoir 1802 and includes two rows of pegs 1803 as hurdles. Proximal funnel 1801 on the right is fluidically connected to first reservoir 1802 includes a barrier with two rows of pegs disposed on top of the barrier as hurdle 1806.

### Example 18

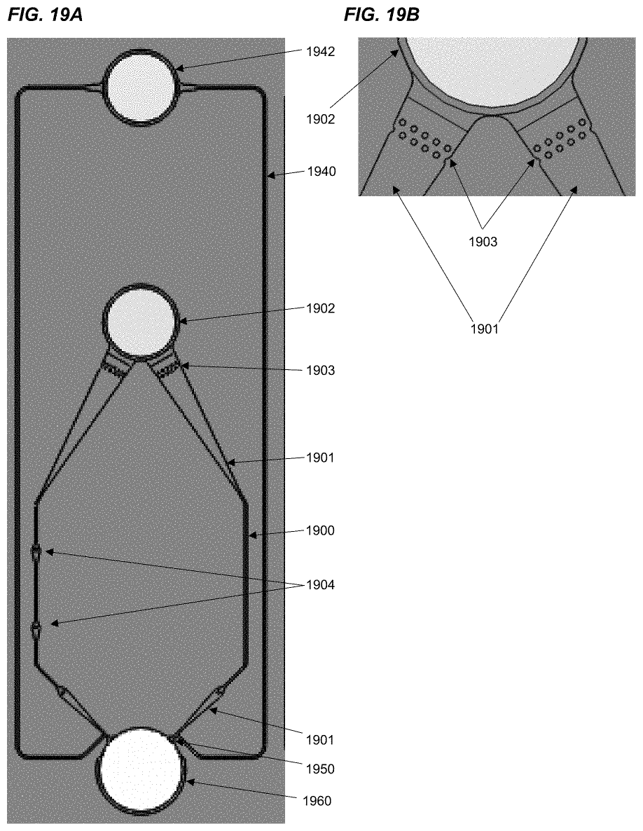

FIG. 19A is an image showing the top view of an exemplary device of the invention. The device includes two first channels 1900, each first channel having two funnels 1901, where first channel 1900 on the left includes two mini-rectifiers 1904, and first channel 1900 on the right does not; first reservoir 1902; two second channels 1940 fluidically connected to the same second reservoir 1942; two droplet source regions 1950; and one droplet collection region 1960. First channel 1900 on the left has dimensions of 65×60 μm, and first channel 1900 on the right has dimensions of 70×65 μm. Each proximal funnel 1901 includes a barrier with two rows of pegs 1903 as hurdles. Droplet collection region 1960 is in fluid communication with first reservoir 1902 and second reservoir 1942.

In use, beads and a first liquid, preloaded into reservoir 1902, are allowed to flow from reservoir 1902 to droplet source regions 1950. The bead flow rate and spacing may be adjusted as needed by controlling the pressure in reservoir 1902. Rectifiers 1901 alone or in combination with mini-rectifiers 1904 can also provide control over bead spacing and spacing uniformity. Sample (e.g., a third liquid) may be loaded into reservoir 1942 and allowed to flow to droplet source regions 1950 through second channels 1940. At intersections between first channels 1900 and second channels 1940, the bead stream is combined with the sample stream, and the combined beads, first liquid, and sample proceed to droplet source regions 1950, where the combined streams contact a second liquid in droplet collection region 1960 to form droplets, preferably, droplets containing a single bead. Rectifiers 1901, mini-rectifiers 1904, and hurdles 1903 thus can be used to control particle (e.g., bead) spacing to allow for the formation of droplets containing a single particle.

FIG. 19B is an image focused on the combination of proximal funnels 1901 and first reservoir 1902. Each proximal funnel 1901 on the left is fluidically connected to first reservoir 1902 and includes two rows of pegs 1903 as hurdles.

### Example 19

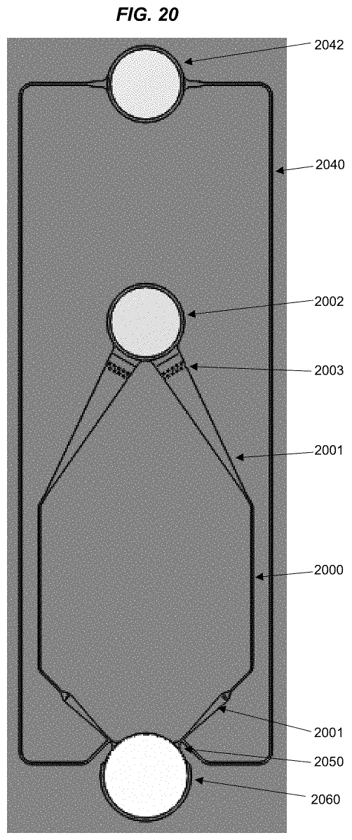

FIG. 20 illustrates an exemplary device of the invention. The device includes two first channels 2000, each first channel having two funnels 2001; first reservoir 2002; two second channels 2040 fluidically connected to the same second reservoir 2042; two droplet source regions 2050; and one droplet collection region 2060.

First channel 2000 on the left has dimensions of 65×110 μm, and first channel 2000 on the right has dimensions of 60×55 μm. Each proximal funnel 2001 includes two rows of pegs 2003 as hurdles. Droplet collection region 2060 is in fluid communication with first reservoir 2002 and second reservoir 2042.

In use, beads and a first liquid, preloaded into reservoir 2002, are allowed to flow from reservoir 2002 to droplet source regions 2050. The bead flow rate and spacing may be adjusted as needed by controlling the pressure in reservoir 2002. Rectifiers 2001 can also provide control over bead spacing and spacing uniformity. Sample (e.g., a third liquid) may be loaded into reservoir 2042 and allowed to flow to droplet source regions 2050 through second channels 2040. At intersections between first channels 2000 and second channels 2040, the bead stream is combined with the sample stream, and the combined beads, first liquid, and sample proceed to droplet source regions 2050, where the combined streams contact a second liquid in droplet collection region 2060 to form droplets, preferably, droplets containing a single bead.

Rectifiers 2001 and hurdles 2003 thus can be used to control particle (e.g., bead) spacing to allow for the formation of droplets containing a single particle.

### Example 20

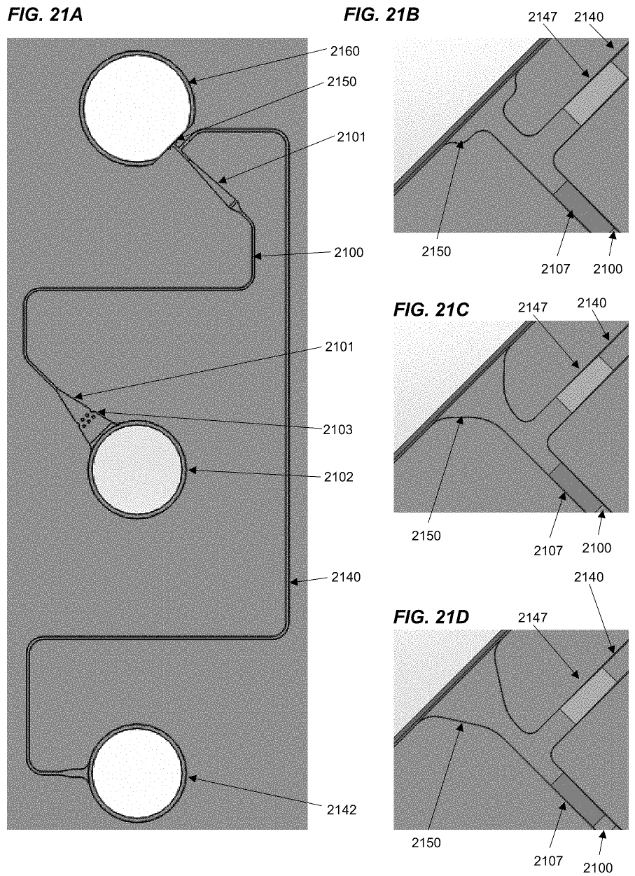

FIG. 21A is an image showing the top view of an exemplary device of the invention. The device includes first channel 2100 having two funnels 2101, first reservoir 2102, second channel 2140 fluidically connected to second reservoir 2142, droplet source region 2150, and droplet collection region 2160. First channel 2100 on the left has dimensions of 55×50 μm, and first channel 2100 on the right has dimensions of 50×50 μm. Proximal funnel 2101 includes two rows of pegs 2103 as hurdles. Droplet collection region 2160 is in fluid communication with first reservoir 2102 and second reservoir 2142.

In use, beads and a first liquid, preloaded into reservoir 2102, are allowed to flow from reservoir 2102 to droplet source region 2150. The bead flow rate and spacing may be adjusted as needed by controlling the pressure in reservoir 2102. Rectifiers 2101 can also provide control over bead spacing and spacing uniformity. Sample (e.g., a third liquid) may be loaded into reservoir 2142 and allowed to flow to droplet source region 2150 through second channel 2140. At an intersection between first channel 2100 and second channel 2140, the bead stream is combined with the sample stream, and the combined beads, first liquid, and sample proceed to droplet source region 2150, where the combined streams contact a second liquid in droplet collection region 2160 to form droplets, preferably, droplets containing a single bead. Rectifiers 2101 and hurdles 2103 thus can be used to control particle (e.g., bead) spacing to allow for the formation of droplets containing a single particle.

FIG. 21B, FIG. 21C, and FIG. 21D focus on droplet source region 2150 and intersection between first channel 2100 and second channel 2140. In these figures, first channel 2100 includes channel portion 2107 where first depth is reduced in proximal-to-distal direction, second channel 2140 includes a channel portion 2147 where second depth is reduced in proximal-to-distal direction.

### Example 21

FIG. 23 is an image showing the top view of an exemplary device of the invention. The device includes first channel 2300 fluidically connected to first reservoir 2302, second channel 2340 including mixer 2380 and fluidically connected to second reservoir 2342, third channel 2370 fluidically connected to third reservoir 2372, droplet source region 2350, and droplet collection region 2360. Third channel 2370 intersects second channel 2340, the distal end of which is fluidically connected to first channel 2300. Droplet collection region 2360 is in fluid communication with first reservoir 2302, second reservoir 2342, and third reservoir 2372.

In use, beads and a first liquid, preloaded into reservoir 2302, are allowed to flow from reservoir 2302 to droplet source region 2350. The bead flow rate and spacing may be adjusted as needed by controlling the pressure in reservoir 2302. Channel 2300 may be modified upstream of the intersection between first channel 2300 and second channel 2340 to include one or more funnels to control bead spacing as needed. Sample (e.g., cells or nuclei in a third liquid) may be loaded into reservoir 2342 and allowed to flow to droplet source region 2350 through second channel 2340. Lysing reagents (e.g., a fourth liquid) may be loaded into reservoir 2372 and allowed to flow to droplet source region 2350 through third channel 2370. At an intersection between second channel 2340 and third channel 2370, the sample stream is combined with the lysing reagent stream, and the combined liquids are mixed in mixer 2380. At an intersection between first channel 2300 and second channel 2340, the bead stream is combined with the mixed sample/lysing reagent stream, and the combined beads, sample, and lysing reagent proceed to droplet source region 2350, where the combined streams contact a second liquid in droplet collection region 2360 to form droplets, preferably, droplets containing a single bead.

Mixer 2380 thus can be used to mix a sample (e.g., cells or nuclei) and lysing reagents to avoid prolonged exposure of a sample portion to a localized high concentration of lysing reagents, which, absent mixing in a mixer, can result in sample (e.g., cell or nuclei) lysis prior to droplet formation.

The channel/mixer configuration described in this Example is particularly advantageous, as it provides superior control over relative proportions of beads, cells (or nuclei), and lysing reagent. This is because each of the beads, cells (or nuclei), and lysing reagent proportions can be controlled independently through controlling pressures in reservoirs 2302, 2342, and 2372.

### Example 22

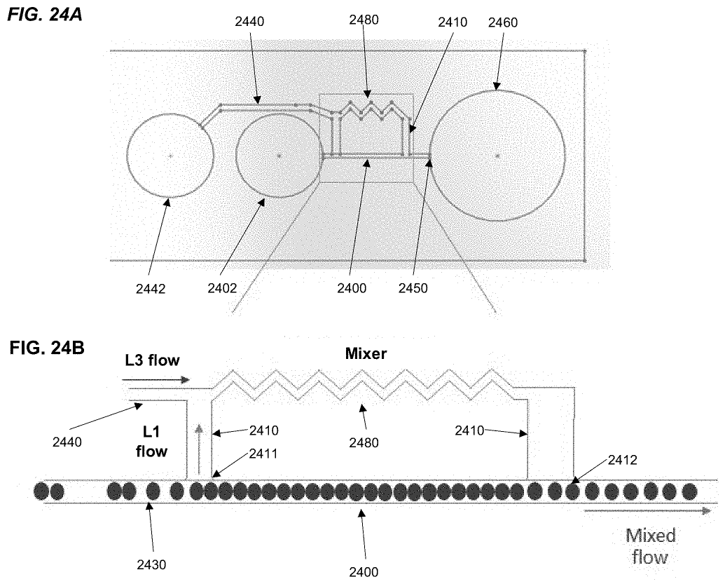

FIG. 24A is an image showing the top view of an exemplary device of the invention. The device includes first channel 2400 fluidically connected to first reservoir 2402, first side channel 2410 including mixer 2480, second channel 2440 fluidically connected to second reservoir 2442 and to first side-channel 2410, droplet source region 2450, and droplet collection region 2460. Droplet collection region 2460 is in fluid communication with first reservoir 2402 and second reservoir 2442.

FIG. 24B focuses on a portion of the device of FIG. 24A in use. A mixture of first liquid L1 and beads 2430 is carried through first channel 2400 in the proximal-to-distal direction. Excess first liquid L1 is diverted from first channel 2400 at intersection 2411 into first side-channel 2410. Excess L1 is then combined with L3 at the intersection of first side-channel 2410 and second channel 2440. The combination of first liquid L1 and third liquid L3 then enters mixer 2480 and, after mixing, is combined with beads 2430/first liquid L1 at intersection 2412. As shown in FIG. 24B, beads 2430 are unevenly spaced in the proximal portion of first channel 2400 before intersection 2411. Between intersections 2411 and 2412 beads 2430 are tightly packed in first channel 2400. After intersection 2412, beads 2430 are substantially evenly spaced.

In use, beads and a first liquid containing lysing reagents, preloaded into reservoir 2402, are allowed to flow from reservoir 2402 to droplet source region 2450. The bead flow rate and spacing may be adjusted as needed by controlling the pressure in reservoir 2402 and in first side-channel 2410. Channel 2400 may also be modified upstream of intersection 2412 to include one or more funnels to control bead spacing as needed. Sample (e.g., cells or nuclei in a third liquid) may be loaded into reservoir 2442 and allowed to flow to droplet source region 2450 through second channel 2440. At an intersection between first side-channel 2410 and second channel 2440, the sample stream is combined with the bead-free lysing reagent stream, and the combined liquids are mixed in mixer 2480. At intersection 2412, the bead stream is combined with the mixed sample/lysing reagent stream, and the combined beads, sample, and lysing reagent proceed to droplet source region 2450, where the combined streams contact a second liquid in droplet collection region 2460 to form droplets, preferably, droplets containing a single bead.

Mixer 2480 thus can be used to mix a sample (e.g., cells or nuclei) and lysing reagents to avoid prolonged exposure of a sample portion to a localized high concentration of lysing reagents, which, absent mixing in a mixer, can result in sample (e.g., cell) lysis prior to droplet formation.

The channel/mixer configuration described in this Example is particularly advantageous, as control over fewer fluid pressure parameters is required. In particular, the channel/mixer configuration described in this Example requires control over relative pressures in only two reservoirs, 2402 and 2442.

### Example 23

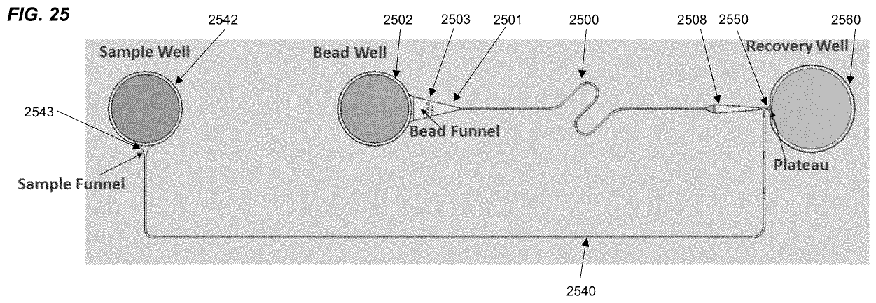

FIG. 25 illustrates an exemplary device of the invention. The device includes first channel 2500 fluidically connected to first reservoir 2502. First channel 2500 includes funnel 2501 disposed at its proximal end. Funnel 2501 at the proximal end of first channel 2500 includes pegs 2503. The device includes droplet collection region 2560 fluidically connected to droplet source region 2550. The device also includes second reservoir 2542 fluidically connected to second channel 2540 that includes funnel 2543 at its proximal end. Second channel 2540 intersects channel 2500 between the first distal end and funnel 2508.

In use, beads and a first liquid containing lysing reagents, preloaded into reservoir 2502, are allowed to flow from reservoir 2502 to droplet source region 2550. Sample (e.g., cells or nuclei in a third liquid) may be loaded into reservoir 2542 and allowed to flow to droplet source region 2550 through second channel 2540. At an intersection between first channel 2500 and second channel 2540, the sample stream is combined with the bead/lysing reagent stream, and the combined liquids proceed to droplet source region 2550 to form droplets, preferably, droplets containing a single bead, for collection in droplet collection region 2560.

### Example 24

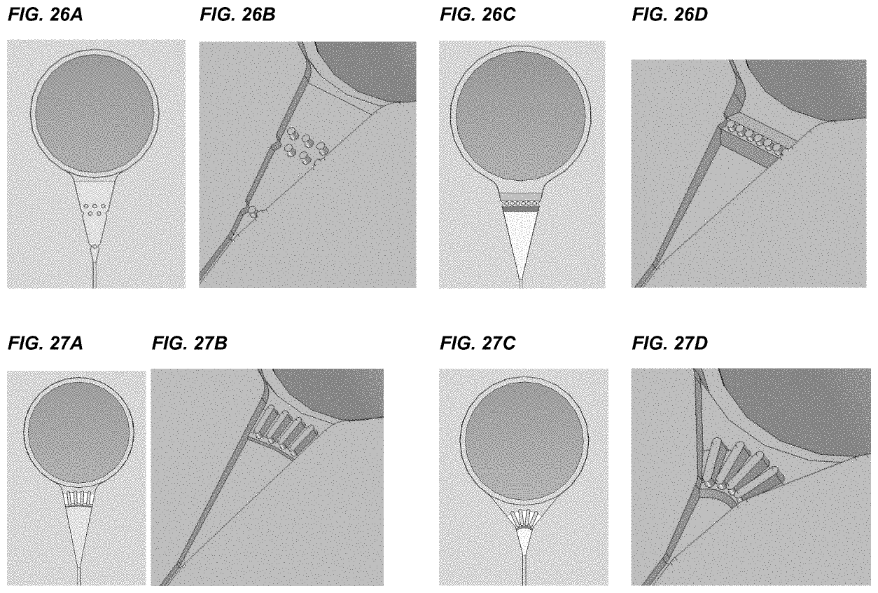

FIGS. 26A, 26B, 26C, 26D, 27A, 27B, 27C, and 27D show exemplary funnel configurations that may be included in any of the devices described herein (e.g., in a first channel).

FIG. 26A is a top view of an exemplary funnel that may be included, e.g., at the proximal end of a first channel. The funnel includes two rows of pegs as hurdles closer to the funnel inlet and a single row of pegs (in this instance, a peg) closer to the funnel outlet. FIG. 26B is a perspective view of an exemplary funnel shown in FIG. 26A.

FIG. 27A is a top view of an exemplary funnel that may be included, e.g., at the proximal end of a first channel. The funnel includes a barrier with one row of pegs disposed on top of the barrier as hurdle. FIG. 27B is a perspective view of an exemplary funnel shown in FIG. 27A.

FIG. 27C is a top view of an exemplary funnel that may be included, e.g., at the proximal end of a first channel. The funnel includes a barrier with one row of pegs disposed on top of the barrier as hurdle. The pegs have a peg length that is greater than the peg width. FIG. 27D is a perspective view of an exemplary funnel shown in FIG. 27C.

### Example 25

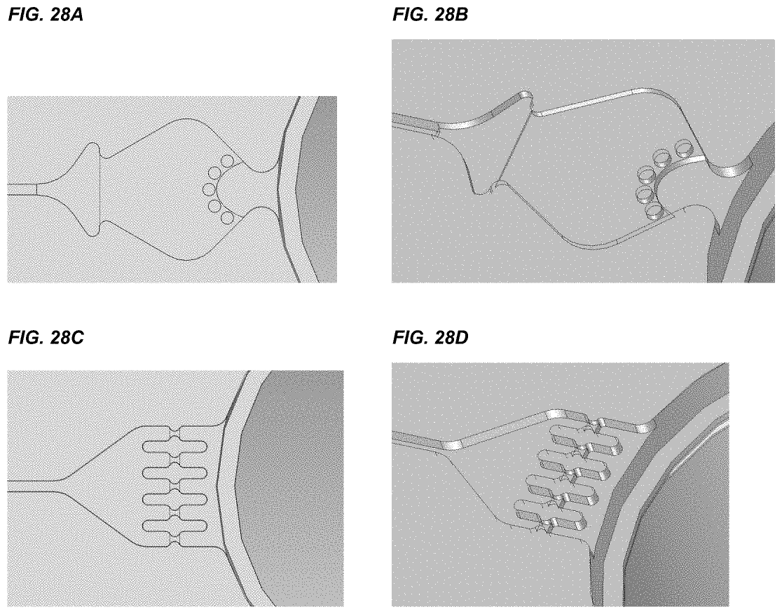

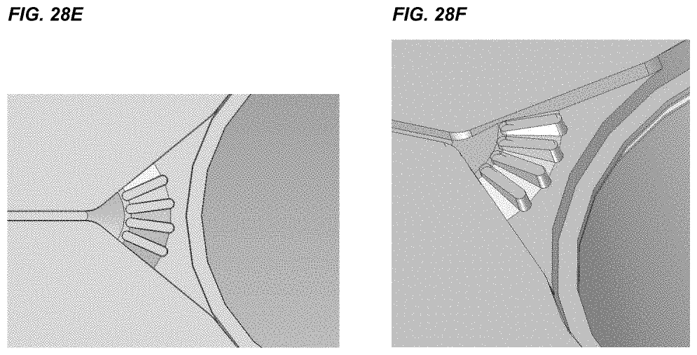

FIGS. 28A, 28B, 28C, 28D, 28E, and 28F show exemplary funnel configurations that may be included in any of the devices described herein (e.g., in a second channel).

FIG. 28A is a top view of an exemplary funnel that may be included, e.g., at the proximal end of a second channel. The funnel includes a barrier with one row of pegs disposed along a curve on top of the barrier as hurdle. FIG. 28B is a perspective view of an exemplary funnel shown in FIG. 28B.

FIG. 28C is a top view of an exemplary funnel that may be included, e.g., at the proximal end of a first channel. The funnel includes a barrier with one row of pegs disposed on top of the barrier as hurdle. The pegs have a peg length that is greater than the peg width. FIG. 28D is a perspective view of an exemplary funnel shown in FIG. 28C.

FIG. 28E is a top view of an exemplary funnel that may be included, e.g., at the proximal end of a first channel. The funnel includes a barrier with one row of pegs disposed along a curve. The pegs have a peg length that is greater than the peg width. The funnel also includes a ramp. FIG. 28F is a perspective view of an exemplary funnel shown in FIG. 28E.

### Example 26

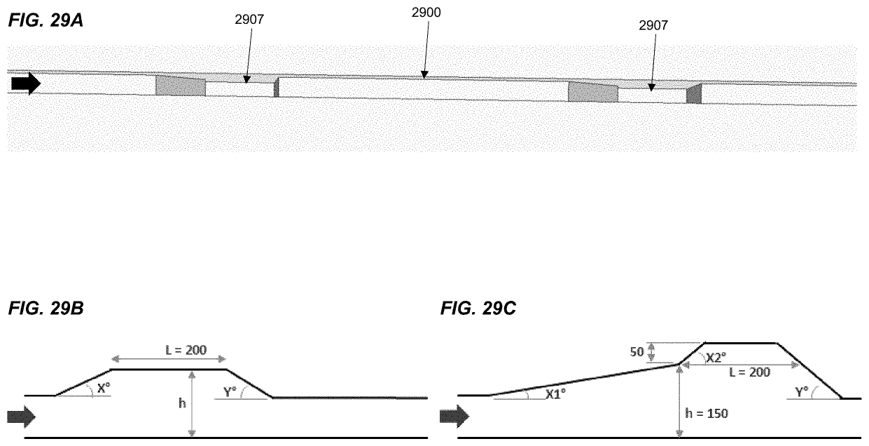

FIGS. 29A, 29B, and 29C show exemplary traps arranged in a channel. These traps can be included in any of the devices described herein (e.g., in a first channel, a second channel, a third channel, a first side-channel, or a second side-channel). FIG. 29A is a top view of an exemplary series of traps. In this figure, channel 2900 includes two traps 2907. The solid-fill arrow indicates the liquid flow direction through the channel including a series of traps. FIG. 29B is a side view cross section of a channel including a trap. The trap has a length (L) and depth (h). In operation, air bubbles that might be carried with a liquid can be lifted by the air buoyancy and thus are removed from the liquid flow. FIG. 29C is a side view cross section of a channel including a trap. The trap has a length (L) and depth (h+50). In operation, air bubbles that might be carried with a liquid can be lifted by the air buoyancy and thus are removed from the liquid flow.

### Example 27

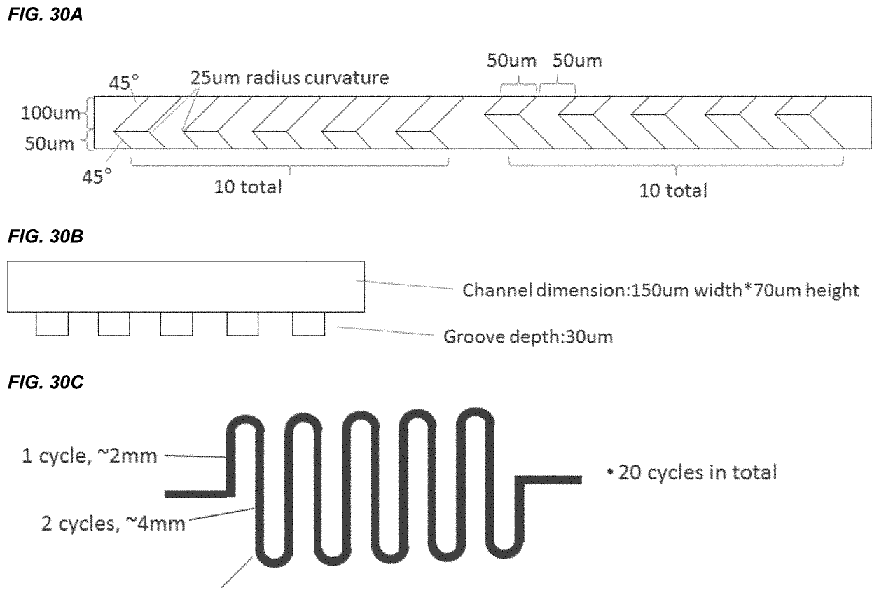

FIGS. 30A, 30B, and 30C show an exemplary herringbone mixer and its arrangement in a channel. These mixers can be included in any of the devices described herein (e.g., in a first channel or a second channel, preferably, after an intersection in which two or more liquids from different liquid sources mix). FIG. 30A is a top view of an exemplary herringbone mixer. This herringbone mixer may be used to provide a single mix cycle in a channel. The herringbone mixer includes and grooves extending transversely across the channel. In this drawing, um stands for microns. FIG. 30B is a side view cross section of an exemplary herringbone mixer portion shown in FIG. 30A. In this drawing, um stands for microns. FIG. 30C is a top view of an exemplary herringbone mixer including twenty mix cycles assembled from herringbone mixers shown in FIG. 30A.

### Example 28

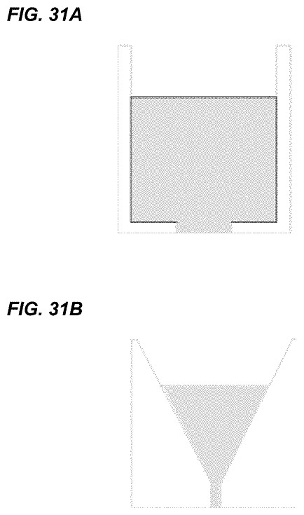

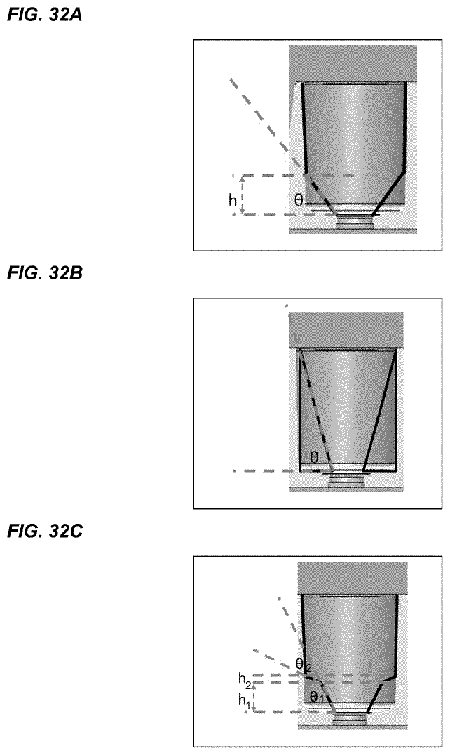

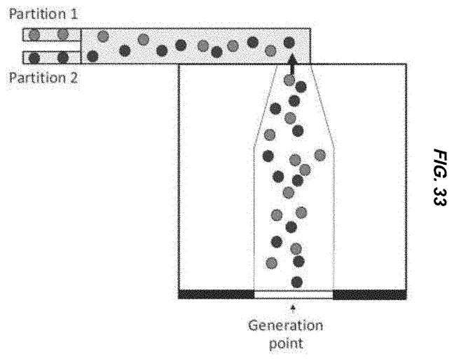

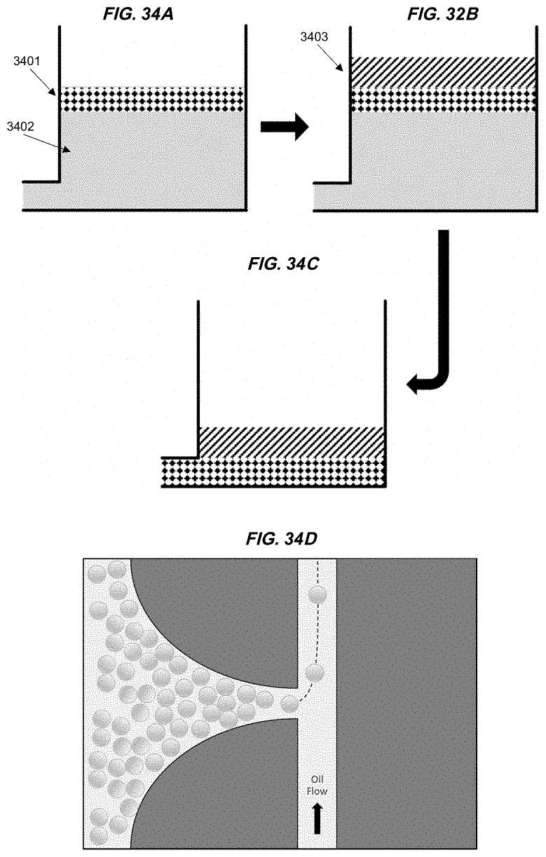

FIG. 31A shows a collection reservoir with a vertical side wall. FIGS. 31B and FIGS. 32A-32C show exemplary collection reservoirs including a canted side wall (e.g., side walls canted at angles between 89.5° and 4°, e.g., between 85° and 5°, e.g., 5<6585Q). The canted side walls may increase the collection efficiency of droplets by a collection device (e.g., a pipette tip) by up to about 20%.

### Example 29

FIG. 33 shows a general embodiment of a device according to the invention that includes reentrainment channels. The droplets are formed in the droplet source region (generation point) and move in a large reservoir. The droplets are then funneled into a narrower channel where the droplets line up in single file for further manipulation, e.g., holding, reaction, incubation, detection, or sorting.

### Example 30

FIGS. 34A-34D are schematic drawings of an embodiment of a device of the disclosure for reentrainment of droplets or particles. FIGS. 34A-34D are schematic drawings of an embodiment of a device of the disclosure for reentrainment of droplets. FIG. 34A shows an emulsion layer (3001) at the top of a partitioning oil (3002) within a reservoir. FIG. 34B shows a spacing liquid (e.g., mineral oil) (3003) added on top of the emulsion layer. FIG. 34C shows the emulsion layer reentrainment into a reentrainment channel. The spacing liquid allows for the emulsion layer to be reentrained without introducing air into the channel. FIG. 34D is a close-up view of droplets in a reentrainment channel including an oil flow to meter droplets and dilute concentrated droplets prior to detection.

### Example 31

FIG. 35 is a depiction of side view cross sections of exemplary reservoirs including canted sidewalls, an oblique circular cone shape, and a circular cone that tapers to a slot. The canted side walls, and/or oblique circular cone shape, and/or circular cone that tapers to a slot shapes may increase the collection efficiency of droplets by a collection device (e.g., a pipette tip).

### Example 32

FIG. 36 is a depiction of side view cross sections of exemplary reservoir including canted sidewalls and slots, and slots with protrusions. The canted side walls, and/or slot shapes with or without protrusions may increase the collection efficiency of droplets by a collection device (e.g., a pipette tip), while also reducing droplet coalescence during extraction. These designs may shape the bottom of the reservoir to guide a pipette tip to the bottom, prevent sealing the tip against the bottom-most surface, and/or introduce a gap between the tip and the bottom-most surface that does not induce coalescence of droplets through high shear during retrieval of the emulsion. These designs may also allow high efficiency collection of droplets without tilting the device.

### Example 33

FIG. 37 is a depiction of side view cross sections of exemplary reservoirs or inlets. The canted side walls may increase the collection efficiency of droplets, or introduction efficiency of samples or reagents, e.g., by up to about 20%.

### Example 34

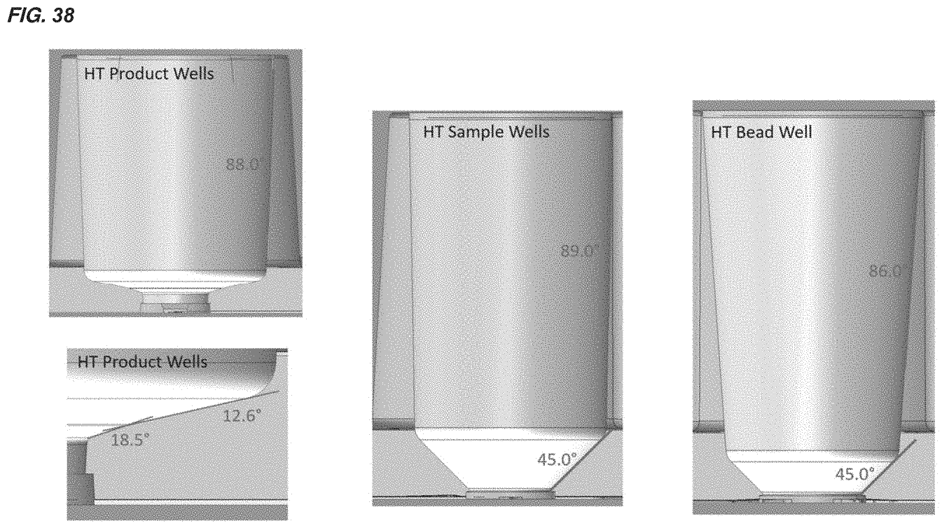

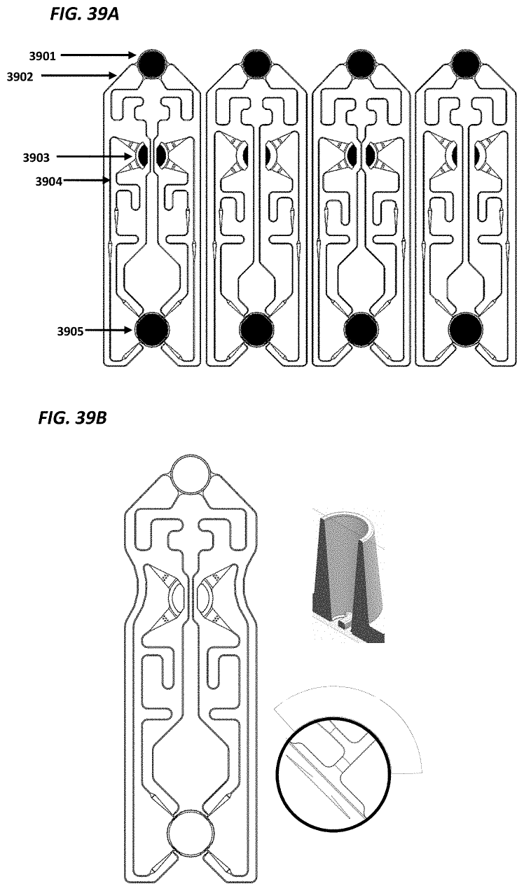

FIG. 38 is a depiction of side view cross sections of exemplary reservoirs or inlets. The canted side walls may increase the collection efficiency of droplets, or introduction efficiency of samples or reagents, e.g., by up to about 20%.

### Example 35

FIGS. 39A-39C and FIGS. 40A-40B are schematic drawings showing multiplexed flow paths with different inlet/reservoir designs. In these designs, small inlets are set close together, but separated by a space through which channels run. Such arrangements can help to maximize the number of droplet source regions in a flow path. In these flow paths, a single sample inlet 3901/4001 is connected to four sample channels 3902/4002. Two reagent inlets 3903/4003 are each connected to two reagent channels 3904/4004. Each sample channel intersects with a reagent channel. A droplet source region (not shown) is downstream of each intersection. Four sets of intersecting channels empty into a collection reservoir 3905/4005. In FIGS. 39A-39C each reagent inlet is fluidically connected to two reagent channels via two funnels. In FIGS. 40A-40B, each reagent inlet is fluidically connected to one reagent channel via a funnel, which then bifurcates into two reagent channels. As shown, two sample channels are disposed between two reagent inlets. As shown, the inlets and collection reservoirs may be in a substantially linear arrangement. Multiple multiplex flow paths may be included in a single device (e.g., as shown in FIG. 39C). The multiplexed flow paths may have rectifiers in the reagent channels, e.g., one rectifier in each reagent channel, e.g., in close proximity to the droplet source region, as shown in FIG. 39B. There may be two rectifiers in each reagent channel (e.g., as shown in FIG. 39A).

### Example 36

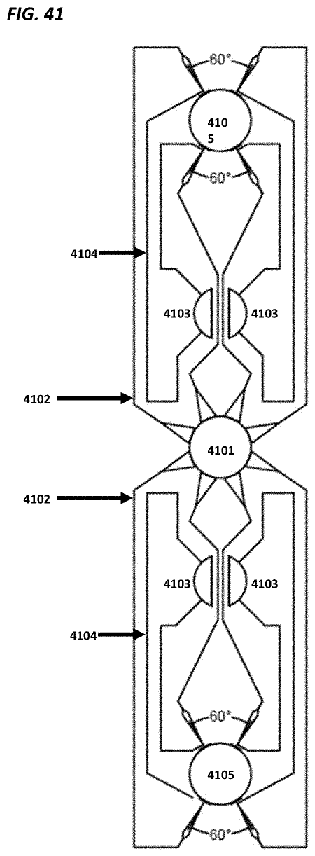

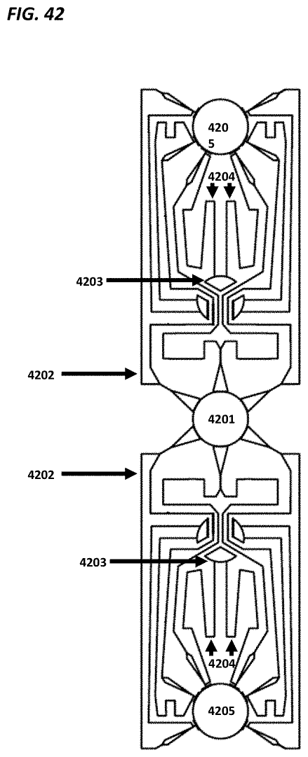

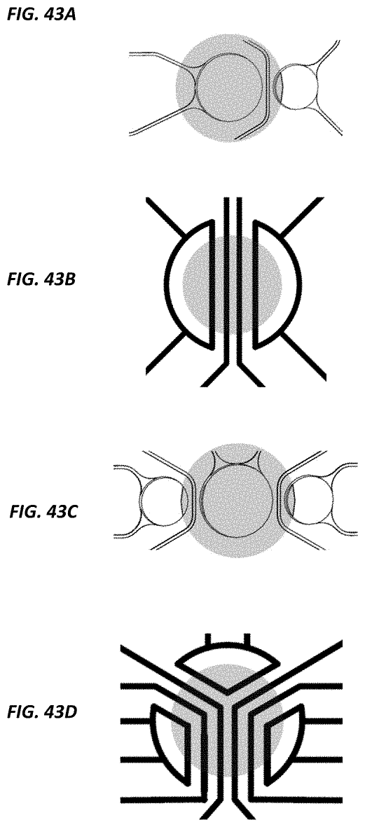

FIG. 41 is a schematic drawing showing a multiplexed flow path with eight droplet source regions. In these flow paths, a single reagent inlet 4101 is connected to eight reagent channels 4102. Four sample inlets 4103 are connected to two sample channels 4104 each. Each sample channel intersects with a reagent channel. A droplet source region (not shown) is downstream of each intersection. Four of the eight sets of intersecting channels empty into each of two collection reservoirs 4105. As shown, two reagent channels are disposed between two sample inlets. As shown, the inlets and collection reservoirs may be in a substantially linear arrangement. Multiple multiplex flow paths may be included in a single device.

### Example 37

FIG. 42 is a schematic drawing showing a multiplexed flow path with twelve droplet source regions. In these flow paths, a single reagent inlet 4201 is fluidically connected to twelve reagent channels 4202. Six sample inlets 4203 are connected to two sample channels 4204 each. Each sample channel intersects with a reagent channel. A droplet source region (not shown) is downstream of each intersection. Six of the twelve sets of intersecting channels empty into one each of two collection reservoirs 4205. As shown, two reagent channels are disposed between the sample inlets. As shown, the inlets and collection reservoirs may be in a substantially linear arrangement. Multiple multiplex flow paths may be included in a single device.

### Example 38

FIGS. 43A-43D are schematic drawings showing different sample and/or reagent inlets layouts. The grey circle represents the area of the opening of a pipette. A single pipette can thus be used to prime or fill two or three inlets at a time.

### Example 39

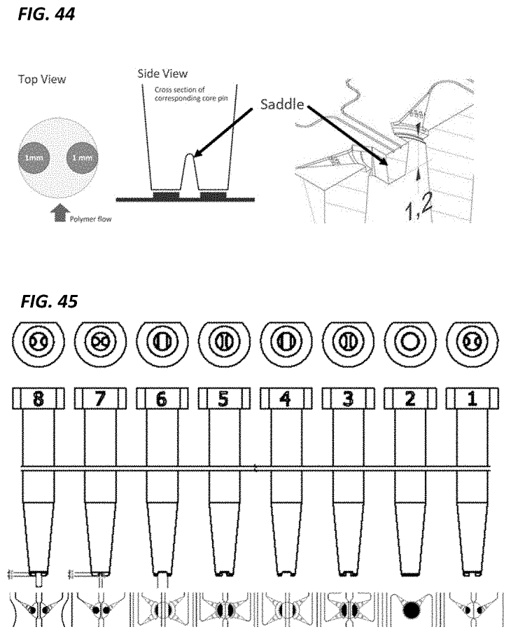

FIG. 44 is a schematic drawing showing a dividing wall (e.g., a saddle) between two inlets under which two channels run. Two inlets are separated by a saddle. Side and top views of a core pin to make the inlets while creating the saddle are also shown.

### Example 40

FIG. 45 is a schematic drawing showing core pins that can be used to produce inlets and the inlet shapes formed.

### Example 41

FIG. 46 is a graph of bead fill ratio in droplets and bead flow rate variability for low quality beads in single and double rectifier channel designs. Variability in bead quality can cause high variability in bead flow rate (measured by the bead frequency coefficient of variation or CV), which in turn can result in low bead fill ratio in droplets produced. The graph of FIG. 46 shows the result of adding a second rectifier in a reagent (bead) channel. Adding a second rectifier in the channel leads to a 9% increase in fill ratio (n=1) and a 9% decrease in bead frequency CV for low quality beads.

### Example 42

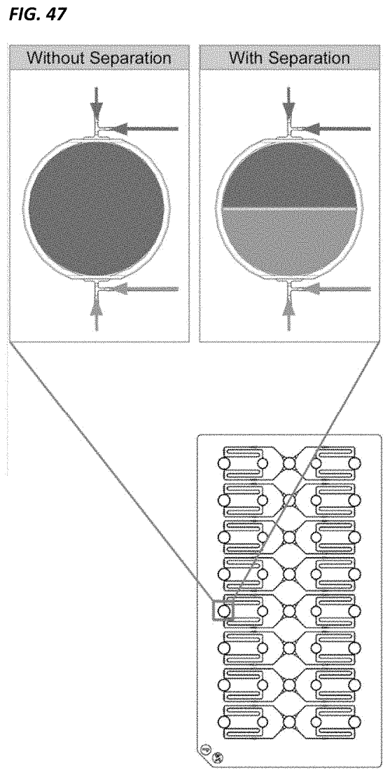

FIG. 47 shows a multiplexed device featuring a partitioning wall in the collection reservoirs. The partitioning wall fluidically separates droplets produced in the two droplet source regions fluidically connected to the collection reservoir. FIGS. 48A and 48B show top and side views of inserts for partitioning a reservoir. The inserts include a partitioning wall and an outer wall that fits tight against the inner wall of the reservoir. Such partitioning walls can be included in a reservoir during molding. FIG. 49 is shows core pins for making a collection reservoir with a partitioning wall by injection molding. FIG. 50 is a schematic drawing showing side and top views of a partitioning wall. The partitioning wall may be canted.

### Example 43

FIG. 51 shows inserts for priming. In FIG. 51 the insert includes a plurality of lumens which are disposed in two inlets of each column of inlets and/or reservoirs of the device. The lumens are conical and include vents to allow air to escape during priming. Such inlets help to guide a pipette tip into the proper location for priming, e.g., the center of the inlet. FIG. 52 shows a single insert lumen and a pipette tip in the steps of priming. After priming, the insert may be discarded.

### Example 44

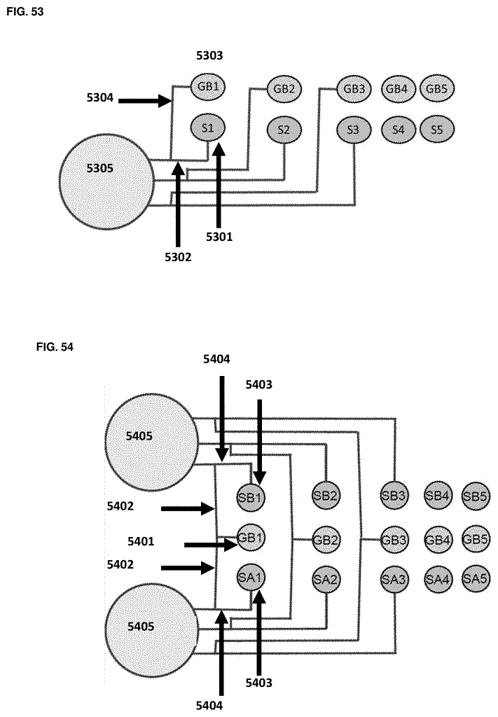

FIG. 53 shows a multiplexed flow path for high sample throughput. In this flow path, each sample inlet 5301 is fluidically connected to a sample channel 5302 and each reagent inlet 5303 is fluidically connected to a reagent channel 5304. Each sample channel intersects with a reagent channel. A droplet source region (not shown) is downstream of each intersection. Each set of intersecting channels empties into the collection reservoirs 5305. Each reagent inlet includes a uniquely tagged population of particles (GB1, GB2, etc.). Each sample inlet includes a different sample (S1, S2, etc.). Droplets formed may include a particle from the population and a sample, e.g., a single cell or a single nucleus. Reaction between the cell, nucleus, or a macromolecular constituent thereof, and reagents on the particle produce products that can be traced to the reagent inlet involved (by knowledge of the uniquely tagged population placed therein).

### Example 45

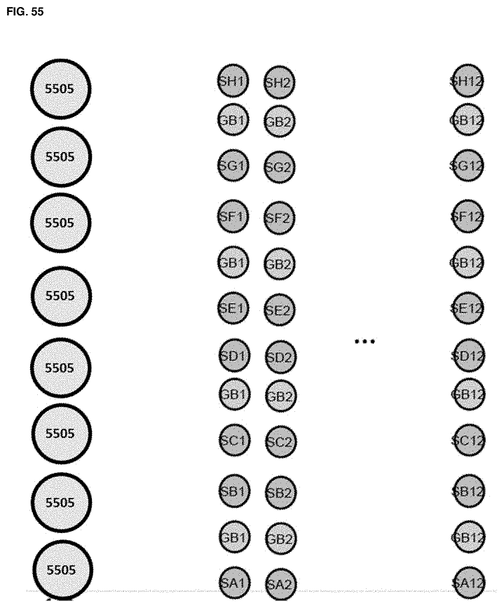

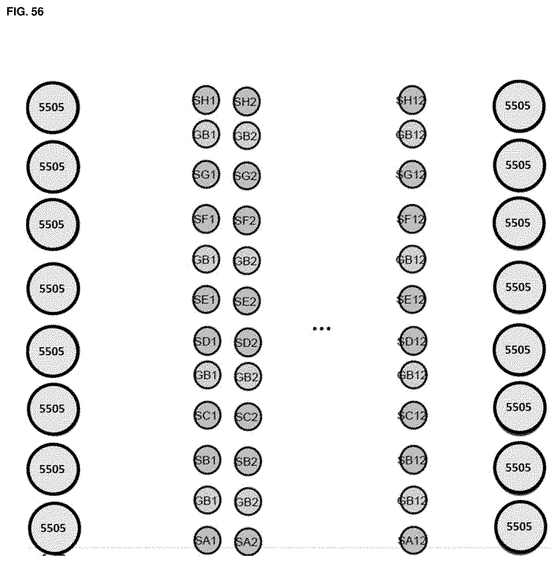

FIGS. 54-56 show multiplexed flow paths for high sample throughput. In FIG. 54, each reagent inlet 5401 is fluidically connected to two reagent channels 5402, and each sample inlet 5403 is fluidically connected to a sample channel 5404. Each sample channel intersects with a reagent channel. A droplet source region (not shown) is downstream of each intersection. Each reagent inlet is in fluid communication with both collection reservoirs and each sample inlet is in fluid communication with a single collection reservoir. Each set of intersecting channels empties into one of the two collection reservoirs 5405. Each reagent inlet includes a uniquely tagged population of particles (GB1, GB2, etc.). Each sample inlet includes a different sample (SA1, SB2, SA2, SB2, etc.). Droplets formed may include a particle from the population and a sample, e.g., a single cell, a single nucleus, or a particulate component thereof. Reaction between the cell, nucleus, or a macromolecular constituent thereof, and reagents on the particle produce products that can be traced to the reagent inlet involved (by knowledge of the uniquely tagged population placed therein and the collection reservoir from which the products were retrieved). Multiple multiplex flow paths may be included in a single device, as represented in FIGS. 55 and 56. In these figures, the uniquely tagged populations of particles are denoted GB1, GB2, etc. The samples that feed into a single collection reservoir (5505) are denoted SA1, SA2, SA3, etc.; SB1, SB2, SB3, etc.

### Other Embodiments

Various modifications and variations of the described invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

1. A microfluidic device, comprising:
a) a sample inlet;
b) one or more collection reservoirs;
c) first and second reagent inlets;
d) first and second sample channels in fluid communication with the sample inlet;
e) a first reagent channel in fluid communication with the first reagent inlet and a second reagent channel in fluid communication with the second reagent inlet;
f) first and second droplet source regions;
g) a reagent reservoir in fluid communication with the first and second reagent inlets;
wherein the first sample channel intersects with the first reagent channel at a first intersection, the second sample channel intersects with the second reagent channel at a second intersection, the first droplet source region is fluidically disposed between the first intersection and the one or more collection reservoirs, and the second droplet source region is fluidically disposed between the second intersection and the one or more collection reservoirs; and wherein the first sample channel and/or the second sample channel is disposed between the first and second reagent inlets.

2. The device of claim 1, further comprising:
a third reagent channel in fluid communication with the first reagent inlet;
a fourth reagent channel in fluid communication with the second reagent inlet;
third and fourth sample channels in fluid communication with the sample inlet; and
third and fourth droplet source regions;
wherein the third sample channel intersects with the third reagent channel at a third intersection, the fourth sample channel intersects with the fourth reagent channel at a fourth intersection, the third droplet source region is fluidically disposed between the third intersection and the one or more collection reservoirs and the fourth droplet source region is fluidically disposed between the fourth intersection and the one or more collection reservoirs.

3. The device of claim 2, wherein the third reagent channel is fluidically connected to the first reagent channel and the fourth reagent channel is fluidically connected to the second reagent channel.

4. The device of claim 1, wherein the first reagent channel comprises a first reagent funnel fluidically connected to the first reagent inlet and the second reagent channel comprises a second reagent funnel fluidically connected to the second reagent inlet.

5. (canceled)

6. The device of claim 1, wherein one or more of the first, second, third, and/or fourth sample and/or reagent channels comprise two or more rectifiers fluidically disposed between the sample inlet and/or the first and/or second reagent inlets and the one or more collection reservoirs.

7. The device of claim 1, wherein the first, second, third, and fourth reagent channels each comprise one of a first, second, third, or fourth rectifier fluidically disposed between the first and second reagent inlets and the one or more collection reservoirs.

8. (canceled)

9. (canceled)

10. The device of claim 1, further comprising:
third and fourth reagent inlets;
a fifth reagent channel in fluid communication with the third reagent inlet and a sixth reagent channel in fluid communication with the fourth reagent inlet;
fifth and sixth sample channels in fluid communication with the sample inlet; and
fifth and sixth droplet source regions;
wherein the fifth sample channel intersects with the fifth reagent channel at a fifth intersection, the sixth sample channel intersects with the sixth reagent channel at a sixth intersection, the fifth droplet source region is fluidically disposed between the fifth intersection and the one or more collection reservoirs and the sixth droplet source region is fluidically disposed between the sixth intersection and the one or more collection reservoirs; and wherein the fifth sample channel and/or the sixth sample channel is disposed between the second and third reagent inlets.

11. The device of claim 10, further comprising:
a seventh reagent channel in fluid communication with the third reagent inlet;
an eighth reagent channel in fluid communication with the fourth reagent inlet;
seventh and eighth sample channels in fluid communication with the sample inlet; and
seventh and eighth droplet source regions;
wherein the seventh sample channel intersects with the seventh reagent channel at a seventh intersection, the eighth sample channel intersects with the eighth reagent channel at an eighth intersection, the seventh droplet source region is fluidically disposed between the seventh intersection and the one or more collection reservoirs and the eighth droplet source region is fluidically disposed between the eighth intersection and the one or more collection reservoirs; and wherein the seventh sample channel and/or the eighth sample channel is disposed between the second and third reagent inlets.

12. (canceled)

13. The device of claim 11, wherein the first reagent channel comprises a first reagent funnel, the second reagent channel comprises a second reagent funnel, the third reagent channel comprises a third reagent funnel, the fourth reagent channel comprises a fourth reagent funnel, the fifth reagent channel comprises a fifth reagent funnel, and the sixth reagent channel comprises a sixth reagent funnel and/or the first sample channel comprises a first sample funnel, the second sample channel comprises a second sample funnel, the third sample channel comprises a third sample funnel, the fourth sample channel comprises a fourth sample funnel, the fifth sample channel comprises a fifth sample funnel, and the sixth sample channel comprises a sixth sample funnel.

14. (canceled)

15. The device of claim 1, further comprising:
a third reagent inlet;
a third reagent channel in fluid communication with the third reagent inlet;
a third sample channel in fluid communication with the sample inlet; and
a third droplet source region;
wherein the third sample channel intersects with the third reagent channel at a third intersection, and the third droplet source region is fluidically disposed between the third intersection and the one or more collection reservoirs; and wherein the third sample channel is disposed between the first and second reagent inlets and/or between the second and third reagent inlets.

16. The device of claim 15, further comprising:
a fourth reagent channel in fluid communication with the first reagent inlet;
a fifth reagent channel in fluid communication with the second reagent inlet;
a sixth reagent channel in fluid communication with the third reagent inlet;
fourth, fifth, and sixth sample channels in fluid communication with the sample inlet; and
fourth, fifth, and sixth droplet source regions;
wherein the fourth sample channel intersects with the fourth reagent channel at a fourth intersection, the fifth sample channel intersects with the fifth reagent channel at a fifth intersection, the sixth sample channel intersects with the sixth reagent channel at a sixth intersection, the fourth droplet source region is fluidically disposed between the fourth intersection and the one or more collection reservoirs, the fifth droplet source region is fluidically disposed between the fifth intersection and the one or more collection reservoirs, and the sixth droplet source region is fluidically disposed between the sixth intersection and the one or more collection reservoirs; and wherein one or more of the fourth, fifth, or sixth sample channels are disposed between the first and second inlets or between the second and third reagent inlets.

17. The device of claim 15 or 16, further comprising:
fourth, fifth, and sixth reagent inlets;
a seventh reagent channel in fluid communication with the fourth reagent inlet, an eighth reagent channel in fluid communication with the fifth reagent inlet, and a ninth reagent channel in fluid communication with the sixth reagent inlet;
seventh, eighth, and ninth sample channels in fluid communication with the sample inlet; and
fourth, fifth, and sixth droplet source regions;
wherein the seventh sample channel intersects with the seventh reagent channel at a seventh intersection, the eighth sample channel intersects with the eighth reagent channel at an eighth intersection, the ninth sample channel intersects with the ninth reagent channel at a ninth intersection, the seventh droplet source region is fluidically disposed between the seventh intersection and the one or more collection reservoirs, the eighth droplet source region is fluidically disposed between the eighth intersection and the one or more collection reservoirs, and the ninth droplet source region is fluidically disposed between the ninth intersection and the one or more collection reservoirs; and wherein one or more of the seventh, eighth, or ninth sample channels are disposed between the second and third reagent inlets or between the second and third reagent inlets.

18. The device of claim 17, further comprising:
a tenth reagent channel in fluid communication with the fourth reagent inlet;
an eleventh reagent channel in fluid communication with the fifth reagent inlet;
a twelfth reagent channel in fluid communication with the sixth reagent inlet;
tenth, eleventh, and twelfth sample channels in fluid communication with the sample inlet; and
tenth, eleventh, and twelfth droplet source regions;
wherein the tenth sample channel intersects with the tenth reagent channel at a tenth intersection, the eleventh sample channel intersects with the eleventh reagent channel at an eleventh intersection, the ninth sample channel intersects with the twelfth reagent channel at an twelfth intersection, the tenth droplet source region is fluidically disposed between the tenth intersection and the one or more collection reservoirs, the eleventh droplet source region is fluidically disposed between the eleventh intersection and the one or more collection reservoirs, and the twelfth droplet source region is fluidically disposed between the twelfth intersection and the one or more collection reservoirs; and wherein one or more of the tenth, eleventh, or twelfth sample channels are disposed between the second and third reagent inlets or between the second and third reagent inlets.

19. The device of claim 15, wherein the second reagent inlet is disposed between the first and third reagent inlets and/or the fifth reagent inlets is disposed between the fourth and sixth reagent inlets, and the second and/or fifth reagent inlets have a cross-sectional dimension of at least 0.5 mm.

20. The device of claim 15, wherein one or more of the first through twelfth sample channels comprises a sample funnel and/or wherein one or more of the first through twelfth reagent channels comprise a reagent funnel.

21. The device of claim 18, wherein the fourth sample channel is fluidically connected to the first sample channel, the fifth sample channel is fluidically connected to the second sample channel, and the sixth sample is fluidically connected to the third sample channel, the tenth sample channel is fluidically connected to the seventh sample channel, the eleventh sample channel is fluidically connected to the eighth sample channel, and the twelfth sample channel is fluidically connected to the ninth sample channel and/or wherein the fourth reagent channel is fluidically connected to the first reagent channel, the fifth reagent channel is fluidically connected to the second reagent channel, and the sixth reagent is fluidically connected to the third reagent channel, the tenth reagent channel is fluidically connected to the seventh reagent channel, the eleventh reagent channel is fluidically connected to the eighth reagent channel, and the twelfth reagent channel is fluidically connected to the ninth reagent channel.

22. The device of claim 1, wherein one or more of the first, second, third, fourth, fifth, sixth, seventh, eighth, ninth, tenth, eleventh, and/or twelfth sample and/or reagent channels comprise two or more rectifiers fluidically disposed between the sample inlet and/or the first, second, third, fourth, fifth, and/or sixth reagent inlets and the one or more collection reservoirs.

23. The device of claim 1, wherein at least one of the droplet source regions comprises a shelf that allows a liquid to expand in one dimension and a step that allows the liquid to expand in an orthogonal dimension.

24. A method of producing droplets, comprising:
a) providing a device comprising a flow path comprising:
i) a sample inlet;
ii) one or more collection reservoirs;
iii) first and second reagent inlets;
iv) first and second sample channels in fluid communication with the sample inlet;
v) a first reagent channel in fluid communication with the first reagent inlet and a second reagent channel in fluid communication with the second reagent inlet; and
vi) first and second droplet source regions comprising a second liquid;
wherein the first sample channel intersects with the first reagent channel at a first intersection, the second sample channel intersects with the second reagent channel at a second intersection, the first droplet source region is fluidically disposed between the first intersection and the one or more collection reservoirs, and the second droplet source region is fluidically disposed between the second intersection and the one or more collection reservoirs; and wherein the first sample channel and/or the second sample channel is disposed between the first and second reagent inlets; and
b) allowing a first liquid to flow from the sample inlet via the first and second sample channels to the first and second intersections, and allowing one or more third liquids to flow from the first and second reagent inlets via the first and second reagent channels to the one or more intersections, wherein the first liquid and one of the one or more third liquids combine at the one or more intersections and produce droplets in the second liquid at the first and second droplet source regions.

25-46. (canceled)

47. A system for producing droplets, comprising:
a) a device comprising a flow path comprising:
i) a sample inlet;
ii) one or more collection reservoirs;
iii) first and second reagent inlets;
iv) first and second sample channels in fluid communication with the sample inlet;
v) a first reagent channel in fluid communication with the first reagent inlet and a second reagent channel in fluid communication with the second reagent inlet; and
vi) first and second droplet source regions;
wherein the first sample channel intersects with the first reagent channel at a first intersection, the second sample channel intersects with the second reagent channel at a second intersection, the first droplet source region is fluidically disposed between the first intersection and the one or more collection reservoirs, and the second droplet source region is fluidically disposed between the second intersection and the one or more collection reservoirs; and wherein the first sample channel and/or the second sample channel is disposed between the first and second reagent inlets; and
b) particles in the sample inlet, first and/or second reagent inlet, and/or droplets in the one or more collection reservoirs.

48-136. (canceled)
